(19) United States
(12) Patent Application Publication
(10) Pub. No.: US 2025/0264945 A1
(43) Pub. Date: Aug. 21, 2025

(54) HANDHELD PERIPHERAL FOR TOUCH SCREEN DEVICES

(71) Applicant: Thomas L Gianfagna, Litchfield, CT (US)

(72) Inventor: Thomas L Gianfagna, Litchfield, CT (US)

(21) Appl. No.: 18/444,626

(22) Filed: Feb. 17, 2024

(51) Int. Cl. G06F 3/0354; G06F 3/038

(52) U.S. Cl. CPC G06F 3/03545; G06F 3/038

(57) ABSTRACT

Elements added to the prior art stylus adaptor allow physical, wireless and social connections. The stylus adaptor can hold itself and its attached writing instrument to a mobile device or similarly flat work surface. An attached or embedded RF antenna, module or tag allows for communication with a RF capable smart device. Some iterations have an extension from the side of the prior art the shape and size of which allows for one or more attachments or layers and provide additional physical, identification and RF functionalities. The ability for the stylus adaptor to hold itself directly to the device also improves ergonomics and provides a more seamless user experience. The position and size of the extension keeps the stylus adapted writing instrument from tilting even if the adaptor is made mostly with flexible material.

Unique identifiers assigned at time of product ordering allows for paired versions of the product to be sent to multiple users. These can provide a shared private space for the users allowing them to participate together in an interactive experience such as a digital coloring page while socializing in other ways such as texting, talking or video chatting with each other. Unique identifiers in combination with unique RF identifiers further secure privacy.

### BACKGROUND OF THE INVENTION

The titled invention relates to peripherals used to operate electronics having touch screens such as capacitive and pressure sensitive screens. It also relates to electronics having radio frequency communication technology such as NFC (Near Field Communication), RFID (Radio Frequency Identification) and BLE (Bluetooth Low Energy). In addition, it relates to the combined process and methods of the invention being ordered, made, packaged and distributed as well as displayed at retail.

Often, a device such as a mobile phone or touch screen tablet is used with a stylus. A unique example of this is shown in the prior art (U.S. Pat. No. 10,589,564 B2 to Thomas L. Gianfagna) which adapts a pen or pencil to become a touch screen stylus while allowing it to still work on paper. Because the stylus shown in the prior art can work on paper and screen, it is handy to have it be directly attachable to the user's work surface or the surface of their electronic device and without the need for a separate apparatus or attachment. Being able to attach or remove the stylus adapted pencil or pen with one motion of the hand and in similar position as when writing or drawing with the tool makes for an efficient and seamless user experience. The user experience can also be enhanced if the stylus can stay attached to the user's finger, so it does not need to be set down or adjusted in the user's hand when operating a touch screen. For example, when using two fingers in a pinching motion to zoom in and out. The same would be true if the user is operating multiple electronics at the same time or working with other materials on their work surface. For example, when a computer mouse needs to be moved, a piece of paper needs to be picked up or a page of a book needs to be turned. User experience is further broadened or enhanced when the stylus can be radio frequency detected by the device or another device. This communication would allow for directly accessing a digital activity and make itself known to be in use. Accordingly, it is desirable if the features could be combined for the most positive user experience and access can be private or privately shared with others using unique access alphanumeric codes, scannable codes such as QR codes and barcodes as well as pre-written or writable RF tags, modules or antennae.

### BRIEF SUMMARY OF THE INVENTION

The present invention provides a touchscreen computer stylus adaptor for writing instruments with one or more radio frequency communication components such as an NFC (Near Field Communication) tag, an RFID (Radio Frequency Identification) antenna, antenna with a transponder, a BLE (Bluetooth Low Energy) module or a microprocessor (such as an EMV payment card chip) placed on or embedded in a flat area of the stylus adaptor or an extension at the side and rear of said stylus. An attachment which could be comprised of adhesive, nano tape, micro suction or magnetic strip(s) applied to side of said stylus adaptor or said extension at or near the balance point of the said attached writing utensil. A uniquely identifiable alphanumeric or scannable code such as barcode or QR code or a combination is printed, or laser marked on said extension. The present invention provides the processes of order placing and receiving, custom manufacturing and distribution of said stylus adaptor.

An object of the present invention is to provide RF capabilities so it can be detected by RF readable and writable devices.

Another object is to provide a seamless user experience when putting down and picking up the stylus adaptor fitted writing utensil.

A further object of the invention is to provide direct attachment of both the stylus adaptor and its attached writing utensil to another device or surface.

Still another object is to provide coded access to privacy-secured cloud-based digital activities or software applications on the user's device or access to the device itself.

An additional object is to provide said stylus adaptor with NFC or RFID payment capabilities.

Another additional object is to provide stylus adaptor with NFC payment capabilities with simultaneous hand-written signature or unique drawing to serve as security “passcode”.

A still further object of the present invention is to provide a stylus-centric platform for social gathering that begins with the use of said stylus adaptor or one of its tab extension attachments having RF capabilities.

Another object is to suspend said stylus adaptor and the attached writing utensil extended above a worksurface for even easier accessibility as well as to keep it above and away from a dirty or wet work surface.

A still further object is to provide said stylus adaptor with an encapsulated or attached microchip or flexible printed circuit board for wireless communication with a user's RF enabled electronic device or another external RF readable/writable device or an external device physically or wirelessly connected to a computer.

Another objective is to provide said stylus adaptor additional coefficient of drag when said stylus adaptor makes connect with the surface of the touchscreen device to mimic the “feel” or coefficient of drag when pencil or pen marks paper.

Another objective is to provide accuracy of the digital marks of said stylus adaptor.

A still further object of the present invention is the provision of a writing utensil attached stylus adaptor that will remain attached to the user's finger when user needs to operate a touchscreen device using only fingers.

Another object is to provide a stylus adaptor having a removable layer or cover over the opening where the point of attached writing utensil passes to mark paper the purpose of which is to protect a capacitive touchscreen surface that is more delicate because of its softness or flexibility.

Still another object is to provide a visible area on said stylus adaptor for branding or decorating in a position that is not blocked by the user's hand while in use or when attached to a device or similarly flat work surface.

Another object is to provide a means for the stylus adaptor to hold itself and an attached writing utensil to a device and at the same time hold a flat, thin piece of material such as a note card or piece of paper.

Another object is to prevent the use of the stylus adaptor fitted writing utensil from operating a touchscreen device unless the user's handholding position is in a specific location on said stylus adaptor in order to train the user on how to properly hold a pencil or pen when writing.

Another object is to allow the user to operate a touchscreen device while holding the stylus adaptor fitted writing utensil completely perpendicular to the device surface in order to mimic the handholding position when using a calligraphic pen or brush.

Another object is to provide the present invention with anti-counterfeiting and anti-tampering elements or layers.

Still another object is to provide said anti-counterfeiting element such as a hologram on a substrate which can also serve as the conductive layer that operates a touchscreen device.

Another object is to provide the ability of keeping the point of the attached pencil from getting worn dull by allowing the pencil point to be kept in a consistent position causing it to wear evenly thus creating sharpened edges which then can be used when the user removes the stylus adaptor and repositions it on the pencil to allow one of the said sharpened edges to be exposed through the opening.

Another object is to provide a protective barrier around the pencil point in such a way as to protect the tip of said pencil from being broken when dropped.

### BRIEF DESCRIPTION OF THE DRAWINGS

Other objects and advantages of the invention will become apparent from a study of the following specification when viewed in the light of the accompanying drawing, in which:

FIG. 1 shows a bottom view of the adaptor according to a preferred embodiment of the invention unattached to a writing instrument;

FIG. 2 shows a bottom view of the adaptor in attached condition to a writing instrument;

FIG. 3 is a top view of the adaptor in attached condition to a writing instrument;

FIG. 4 is a side view of the adaptor in attached condition to a writing instrument;

FIG. 5 shows the same view as in FIG. 4 and used in connection with a mobile device;

FIGS. 6-8 show bottom, top and side plan views of the adaptor;

FIG. 9 shows a side view of the adaptor in a condition as if attached to a writing instrument;

FIG. 10-11 shows a side view of the adaptor with a writing instrument in unattached and attached conditions, respectively;

FIGS. 12-13 show bottom and top views of the adaptor with a writing instrument in attached condition;

FIG. 14 is a side plan view of the adaptor of FIG. 1;

FIGS. 15-16 show bottom views of the adaptor attached to a writing instrument and in relation to a mobile device as to be detected by said device's Near Field Communication (NFC) technology;

FIG. 17-25 show bottom views of alternate types of Radio Frequency (RF) antennae, tags, modules, microchips;

FIG. 26 shows a side view of the adaptor as shown in FIG. 4 and a writing instrument in attached condition and shows an attachment strip comprising an adhesive, micro-suction or nano tape 22-A;

FIG. 27 is a bottom view of FIG. 26

FIG. 28 shows the adaptor and a writing instrument 3 in attached position as seen in FIG. 26 and attached to the side of a touchscreen device 2 by means of the attachment strip 22-A;

FIG. 29 shows the adaptor and a writing instrument 3 in attached position as seen in FIG. 26 and attached to the side of a work surface 34 by means of the attachment strip 22-A;

FIG. 30 shows the adaptor having an extension tab 21-A and a writing instrument 3 in unattached position

FIG. 31 shows a top view of FIG. 30;

FIG. 32 shows a side view of FIG. 30;

FIG. 33 is a bottom view of the adaptor having an extension tab 21-A and a writing instrument 3 in an attached position;

FIG. 34 is a top view of FIG. 33;

FIG. 35 is a side view of FIG. 33;

FIGS. 36 and 37 are bottom and side views respectively of the adaptor having an extension tab 21-A;

FIG. 38(a)-(e) are front views showing the sequence of steps, respectively, for connecting the adaptor to a writing instrument;

FIG. 39 shows a side view of the adaptor as seen in FIG. 35 and attached to a touchscreen device

FIG. 40 shows the opposite side view of FIG. 35:

FIG. 41 shows a side view of a touchscreen device and front view of the adaptor as seen in FIG. 38(d) attached to a touchscreen device;

FIG. 42 shows an alternative position of the tab extension of the adaptor as seen in FIG. 38(a) and a sideview of the touchscreen device;

FIG. 43-46 are views similar to FIGS. 30-35 showing the adaptor attached to a writing instrument but in a writing position and comprising a NFC tag;

FIG. 47 is a side view showing the adaptor shown in FIGS. 43-46 pressed against a capacitive touch screen

FIG. 48 is a top view of FIG. 47 showing the adaptor pressed against the capacitive touch screen device;

FIG. 49(a)-(b) show top and side views, respectively, of the touch screen device and the sequence of the user's hand positions when removing and then using the adaptor with the extension tab when attached to a writing instrument;

FIG. 50(a)-(b) show top views of FIG. 49(b) and demonstrate the extension tab of the adaptor enabling said adaptor to stay attached to the user's finger when it is necessary to free other fingers and thumb in order to operate the touch screen device with two fingers;

FIGS. 50(c)-(d) show side views of FIGS. 50(a)-(b);

FIGS. 51-52 show bottom and top views, respectively, of adaptor with extension tab having kiss-cuts, scores or bends;

FIGS. 53-58 show the same view as FIG. 52 but with the addition of one or more adhesive, micro-suction or nano tape pads;

FIGS. 59-60 are views similar to FIGS. 51-52 but additionally show the NFC tag position on bottom and top sides, respectively, of two different embodiments of the adaptor;

FIG. 61 is a top view of FIG. 59 but having an adhesive, micro-suction or nano tape pad on the extensive of the adaptor;

FIGS. 62-66 show varying embodiments of the adaptor with alternative combinations of adhesive, micro-suction or nano tape pad or pads with RF antenna, antennae, tags, microchips, or modules;

FIG. 67 shows another embodiment of the adaptor having an RFID antenna positioned on the extension tab;

FIG. 68 shows a similar view of FIG. 67 but having an adhesive, micro-suction or nano tape pad attached to the extension tab of the adaptor;

FIGS. 70-74 show varying embodiments of the adaptor with alternative combinations of adhesive, micro-suction or nano tape pad or pads with RF antenna, antennae, tags, microchips, or modules as well as alpha-numeric codes or scannable codes;

FIGS. 75-82 show additional varying embodiments of the adaptor with alternative combinations of adhesive, micro-suction or nano tape pad or pads with RF antenna, antennae, tags, microchips, or modules as well as numeric, alpha-numeric or scannable codes;

FIGS. 83(a)-(b) show the sequence of an embodiment of the adaptor with NFC tag being positioned by the user's hand behind the touch screen device in order for said device to scan said NFC tag;

FIG. 84 is a flow chart showing the process of using a RF enabled adaptor fitted writing utensil to perform a digital activity;

FIG. 85-90 show varying side, top and front views of adaptor in attached and unattached condition to the writing utensil and touch screen device;

FIG. 91 shows a top view of a touch screen device having a protective case with an embodiment of the adaptor fitted writing utensil attached to the touch screen device;

FIG. 92 shows the opposite side of the adaptor fitted writing utensil shown in FIG. 91 with the extension tab of said adaptor having an adhesive, micro-suction or nano tape pad;

FIG. 93 is a front view of the adaptor shown in FIG. 91 and FIG. 92;

FIG. 94 is a front view of FIG. 91;

FIG. 95 shows a front view of an alternative position of the extension tab of the adaptor attached to a writing utensil;

FIG. 96 is a front view of FIG. 91 showing the alternative position of the extension tab of the adaptor attached to a writing utensil as shown in FIG. 95;

FIG. 97 is a bottom view of an embodiment of adaptor extension tab having a bendable extension off its side in an unattached condition to a writing utensil;

FIG. 98 shows the attached condition to the writing utensil of the adaptor shown in FIG. 97;

FIG. 99 is a bottom view of the adaptor shown in FIGS. 97-98 in an attached condition to the writing utensil;

FIGS. 100-101 shows top views of the adaptor shown in FIGS. 97-99 with the additional extension to the extension tab in straight and bent positions, respectively, with the bent position showing an alternative embodiment of the adaptor having adhesive, micro-suction or nano tape pads on the extension tab;

FIG. 102 is the opposite side view of the adaptor shown in FIG. 98 but with the embodiment shown in FIG. 101 and a scannable code on the extension tab;

FIGS. 103-106 show varying views of the adaptor having an additional extension tab as well as a BLE (Bluetooth Low Energy) module and adhesive, micro-suction or nano tape pad;

FIGS. 107-110 show side, bottom and top views, respectively, of one embodiment of the adaptor having a NFC tag as well as two extension tabs or clips in an attached condition to the writing utensil;

FIGS. 111-114 are similar views of FIGS. 107-110 but having two additional extension tabs;

FIGS. 115-118 are similar views of FIGS. 107-110 but having thinner and longer extension tabs or clips;

FIG. 119 shows a desktop computer and its monitor displaying a digital activity (i.e. web browser page) as well as a touch screen device set on the same work surface as said computer and also a RF reader attached to said computer by means of a USB-C connector and having an adaptor fitted writing utensil attached to its side;

FIG. 120 shows a front view of said RF reader with adaptor fitted writing utensils laid on top and attached to its side;

FIG. 121 is a top view of FIG. 120 and shows the USB-C connector cable;

FIG. 122 is a top view of a user's hand holding the adaptor fitted writing utensil, a touch screen device displaying a digital activity or screen grab of a digital activity, a digital mark made by said adaptor fitted to a writing utensil;

FIG. 123 is a back view of said RF reader showing the port for the USB-C connector;

FIG. 124 is a flow chart of the process of the RF enabled adaptor communicating with the RF reader, desktop computer and touch screen device for marking-up a screen grab which was originally displayed on a device different from the touch screen device;

FIG. 125 shows a side view of a RF reader in the shape of a cup which holds multiple RF enabled adaptors in attached condition on writing utensils;

FIG. 126 is similar to FIG. 125 but shows a user's hand removing one of the writing utensils having a RF enabled adaptor attached;

FIG. 127 is an overhead view of a touch screen device displaying a digital activity which is being interacted with by the user held RF enabled adaptor in attached condition on a writing utensil as seen in FIGS. 125-126;

FIG. 128 is a flowchart of a touch screen device-based application or shortcut which works in tandem with a RF reader or reader and writer (i.e. as shown in FIGS. 125-127);

FIGS. 129-130 show top views of two different iterations of RF readers as shown in FIGS. 125-126;

FIG. 131 shows a side view of RF reader as shown in FIG. 129;

FIG. 132 shows a side view of RF reader shown in FIG. 130 and having multiple writing utensils attached with RF enabled adaptors in a removable cup or container and a base for said cup or container which also is the RF reader;

FIG. 133 shows a RF enabled adaptor in attached condition to a writing utensil and attached to a touch screen computer such as a desktop, laptop or point-of-sale device;

FIG. 134 shows a touch screen computer such as a laptop or desktop which is attached to a till and a RF reader and it also shows two writing utensils with RF enabled adaptors attached;

FIG. 135 shows a side view of FIG. 133 and an attached RF reader or reader and writer;

FIG. 136 shows a touch screen device with a USB-C port, a digital activity displayed on the touch screen and, attached to it, a RF enabled adaptor in attached condition to a writing utensil;

FIG. 137(a) shows a variation of the adaptor having an extension tab and in an attached condition to a writing instrument;

FIG. 137(b) shows a different variation of the adaptor having an extension tab and raised sides for adhering or clipping to a writing utensil;

FIG. 138(a) shows a front view of FIG. 137(a);

FIG. 138(b) shows a front view of FIG. 137(b);

FIGS. 138(c)-(d) show front views of different variations of the adaptor with tab extension in attached condition to a writing utensil;

FIGS. 139(a)-(b) are similar to FIGS. 137(a)-(b) but with the adaptor having sides that are raised more in attached and unattached conditions, respectively;

FIGS. 140(a)-(b) show front views of FIGS. 139(b) and 139(a), respectively;

FIG. 140(c) is similar to FIG. 140(b) but shows an extended side on top reaching toward the extension tab;

FIG. 141(a)-(b) are side views of an embodiment of the adaptor having an extension tab;

FIG. 142(a)-(c) show front views of FIGS. 141(a)-(b) in unattached and attached conditions to a writing utensil, respectively;

FIG. 143 is a side view similar to FIG. 137(a) in an attached condition to the writing instrument but slid further down said writing instrument;

FIGS. 144(a)-(b) are bottom and top views of the adaptor with extension tab in unattached condition to a writing instrument such as the shown carpenter's pencil;

FIGS. 144(c)-(e) show side views as well as a top view of the adaptor with extension tab in attached condition to the writing utensil;

FIGS. 145(a)-(b) show bottom and top views, respectively, of an embodiment of the adaptor with extension tab and additional extensions in unattached condition to a writing utensil;

FIGS. 145(c)-(e) show side and top plan views, respectively, of FIGS. 145(a)-(b) when in an attached condition to a writing utensil;

FIG. 146 is a flow chart of the ordering, customization and fulfillment processes for adaptors according to the invention;

FIGS. 147(a)-(b) show plan bottom views of the adaptors according to the invention showing the extension tab having customized printed messages or images thereon, respectively;

FIG. 148(a)-(b) show representations of webpage and mobile app, respectively, for ordering custom adaptors according to the invention;

FIG. 149 shows multiple adaptors according to the invention attached to a card suitable for mailing or displaying at retail;

FIG. 150 shows the opposite side of FIG. 149 if used for mailing to customer;

FIGS. 151-156 show variations of side views of the adaptor according to the invention and having an additional extension tab which has openings for retail display and show the adaptor or adaptors in unattached and attached conditions to a writing instrument or instruments;

FIGS. 157-159 show bottom views of the adaptor with extension tab and variations of textured areas around the opening at end;

FIGS. 160-162 show bottom views of the adaptor without extension tab but having variations of textured areas around opening at end;

FIGS. 163-165 show similar views of FIGS. 157-159 but with the adaptor also having a NFC tag;

FIGS. 166-168 show similar views of FIGS. 160-162 but with the various adaptors also having a NFC tag;

FIG. 169(a) shows an overhead view of a touch screen device displaying a digital activity and a side view of the adaptor according to the invention in an attached condition to a writing utensil and attached to said touch screen;

FIG. 169(b) shows a similar view as in FIG. 169(a) but with a user's hand holding an adaptor according to the invention and using it to make a digital mark on the digital activity displayed on said touch screen;

FIG. 170(a) is an overhead view of a touch screen device displaying a digital activity for use in voting or other activity which requires choosing answers from a selection of options and having an adaptor according to the invention attached to said touch screen;

FIG. 170(b) is a printed card displaying the same information as seen in FIG. 170(a) and sized to fit on top of a touch screen so as to be in alignment with the identical digitally displayed layout;

FIG. 170(c) shows the card in FIG. 170(b) in position over the touch screen device and its displayed layout as well as marks made by a writing utensil fitted with an adaptor according to invention in one variation as seen in FIG. 170(a);

FIG. 170(d) shows the marked-up card as seen in FIG. 170(c) and the touch screen display showing the digital markings in the same position as seen on said card;

FIG. 171 is a flow chart of the voting process when using the adaptor according to the invention;

FIGS. 172(a)-(c) is a sequence of overhead views showing a user scanning a code on the adaptor according to the invention using the camera of the touch screen device with said device being directed to a digital activity for use with said adaptor;

FIG. 172(d) shows an alternative adaptor in attached condition to a writing utensil with the extension tab having multiple micro QR codes;

FIG. 173 is a flow chart of the process of scanning a printed code on the adaptor according to the invention and the activation of a digital activity on the touch screen device used to scan said code;

FIG. 174(a)-(d) shows similar views as in FIGS. 172(a)-(c) but with an additional digital activity being a login screen that requires a signature before user is given access to main digital activity;

FIG. 175 is a flow chart of the process of using an adaptor according to the invention for use in first registering a signature for access to a digital activity and then using said signature upon future visits to gain access again to said digital activity;

FIGS. 176(a)-(e) show a set of overhead views similar to FIGS. 170(a)-(d) but with the printed activity card having a dedicated area for a signature or other unique hand-drawn or hand-written identifier (i.e., a signature) which said card and its printed information align with identical information on a similarly sized touch screen device so when user uses an adaptor according to invention in an attached condition to a writing utensil, will leave marks on both the card and the digital activity displayed on the touch screen device;

FIGS. 177-184 show top, side and front views of variations of the card shown in FIGS. 176(a)-(e) but having a bent edge as well as another variation of the printed information indicating a space for a unique identifier to be drawn by the user when laid on top of a similarly size touch screen device;

FIG. 185 is a top view of an adaptor in attached condition to a writing instrument and having a semi-circular cut through all layers of materials making up said stylus and near the opening at its end;

FIG. 186 shows the end of said adaptor seen in FIG. 185 when it is pressed against the surface of a touch screen device;

FIG. 187 shows the side view of FIG. 186;

FIG. 188 shows the opposite side view to FIG. 186;

FIG. 189 shows a front view of adaptor shown in FIG. 185;

FIG. 190 shows a transparent front view of adaptor shown in FIG. 190 so as to see the position of an attached writing utensil;

FIG. 191 is a similar view to FIG. 190 but with opaque material blocking the view of the attached writing utensil and having an extension tab;

FIG. 192 shows a side view of the adaptor and writing utensil seen in FIG. 191;

FIG. 193 is similar to FIG. 192 but with an extended strip past the extension tab;

FIG. 194 is a bottom plan view of the adaptor in unattached condition to a writing utensil;

FIG. 195 is a bottom plan view of the adaptor shown in FIG. 192 but in unattached condition;

FIG. 196 is a bottom plan view of the adaptor shown in FIG. 193 but in unattached condition;

FIGS. 197-208 show various enlarged front views of different embodiments of adaptors according to invention in attached condition to a writing utensil as well as in attached condition to a touch screen device;

FIGS. 209-218 show more variations of adaptors according to the invention as shown in FIGS. 197-208;

FIG. 219 shows a side view of one embodiment of the adaptor according to the invention with a user's hand grabbing the extension tab area of said adaptor, an adhesive, micro-suction or nano tape pad and a flat work surface;

FIG. 220-222 show side and front views, respectively, of an adaptor having a tab extension with a bend at the end on which an adhesive, micro-suction or nano tape pad is attached with said bend and pad enabling the adaptor in attached condition to a writing utensil to raise the combined adaptor and utensil above a work surface or similar flat surface;

FIGS. 223-224 are similar to FIG. 220 and FIG. 222 but suspended under a work surface;

FIGS. 225-227 show other examples of adaptors according to invention having extension tabs of varying shapes and combinations of adhesive, micro-suction or nano tape pads as well as a work surface to which said pad attaches;

FIGS. 228-232 show side views of varying adaptors having extension tabs and in attached condition to a writing instrument as well as adhesive, micro-suction or nano tape pad and a work surface;

FIGS. 233-237 are front views of FIGS. 228-232, respectively;

FIG. 238(a)-(c) show a sequence of material layers being laminated together and then die-cut, laser-cut or kiss-cut as examples of possible manufacturing of the adaptor according to the invention;

FIGS. 239(a)-(c) show similar sequence as shown in FIGS. 238(a)-(c) but with the kiss-cuts, die-cuts or laser-cuts in a different final orientation;

FIGS. 240(a)-(c) show alternative variations as shown in FIGS. 238(a)-(c);

FIGS. 241(a)-(c) show alternative variations as shown in FIGS. 239(a)-(c);

FIGS. 242(a)-(c) show top views of material layers in sequence for combining to form a laminated unit to be die-cut, laser-cut or kiss-cut as well as the attachment of a RF antenna, tag, module or microchip and ferrite layer in between said RF antenna, tag, module or microchip;

FIGS. 243(a)-(c) show another sequence of top views of material layers and attachments as shown in FIGS. 242(a)-(c);

FIGS. 244(a)-(c) show another sequence of top views of material layers and attachments as shown in FIGS. 242(a)-(c) as one means of manufacturing an adaptor according to the invention and having a scannable code, RF antenna, tag, module or microchip as well as an adhesive, micro-suction or nano tape pad;

FIGS. 245(a)-(c) show more examples similar to those shown in FIGS. 244(a)-(c);

FIGS. 246(a)-(c) show more examples similar to those shown in FIGS. 244(a)-(c) but with the addition of a conductive strip added to the first substrate;

FIGS. 247(a)-(c) show more examples similar to those shown in FIGS. 245(a)-(c);

FIGS. 248(a)-(c) show more examples similar to those shown in FIGS. 246(a)-(b) but with an area void of the material of the conductive strip;

FIGS. 249(a)-(c) show another sequence similar to FIGS. 248(a)-(c) but having a different orientation;

FIG. 250(a) a front view of hexagonal tube stock;

FIG. 250(b) is a front view of the hexagonal tube stock shown in FIG. 250(a) but in a partially compressed state;

FIG. 250(c) is a front view of the hexagonal tube stock shown in FIG. 250(a) but in a fully compressed condition;

FIG. 250(d) is a top view of the compressed tube stock shown in FIG. 250(c);

FIG. 250(e) is a front view of the compressed stock as shown in FIG. 250(c) with a section along its top side removed;

FIGS. 250(f)-(g) show semi-compressed and fully-compressed front views, respectively, as seen in FIGS. 250(b)-(c) but with a strip along the top side removed;

FIGS. 251(a)-(g) show similar views as 250(a)-(g) and having an adhesive strip running through the center of the hexagonal tubing which adheres to the underside of the strip along the top side that is removed;

FIGS. 252(a)-(b) show front and top views of the strip of the hexagonal tube with adhesive attached that was removed as shown in FIG. 251(e)s;

FIG. 252(c) shows the same front view as seen in FIG. 252(a);

FIG. 252(d) shows the same front view as seen in FIG. 252(c) but rotated so attached adhesive strip is on top;

FIG. 252(e) shows the same front view as seen in FIG. 252(d) but with the uncovered areas of the strip cut from the hexagonal tube less compressed and no longer flat;

FIG. 252(f) shows the same view as in FIG. 252(e) but with the sides no longer compressed but in their original bent angles as when still part of the hexagonal tubing;

FIGS. 253(a)-(g) show similar views as in FIGS. 251(a)-(g) but with a different shaped strip cut front the length of the top part of the hexagonal tubing;

FIG. 254(a) shows the top piece cut from the hexagonal tubing removed;

FIG. 254(b) shows a front edge view of FIG. 254(a);

FIGS. 254(c)-(d) show the same top piece which was removed in conditions less compressed and fully returned to the original bends of the hexagonal tubing, respectively;

FIGS. 255-256 show side views of the two separate pieces made from the cut of the hexagonal tube as seen in FIG. 253(d);

FIGS. 257(a)-260 show similar views as seen in FIGS. 253(a)-256 but having different shapes;

FIGS. 261(a)-265 show similar views as seen in FIGS. 257(a)-260 but having different shapes as well as in attached condition to a writing instrument;

FIG. 266(a) shows a side view as seen in FIG. 265 of the top piece of the cut hexagonal tube in attached condition to a writing instrument;

FIG. 266(b) shows an overhead view of the top piece of the cut hexagonal tubing in compressed condition as seen in the front view shown in FIG.;

FIG. 266(c) shows a top plan view of the adaptor according to the invention having the extension tab;

FIG. 266(d) shows the removed piece from the hexagonal tubing as seen in FIGS. 266(a)-(b) placed on top of the adaptor as seen in FIG. 266(c);

FIGS. 267(a)-(i) is similar to FIGS. 266(a)-(i) but with the other piece made from the cuts to the hexagonal tubing;

FIGS. 268(a)-(b) show side views and top, front and bottom views, respectively, of an adaptor in attached position to a writing utensil;

FIG. 268(f) shows an adaptor in unattached condition from a top view;

FIGS. 268(g)-(h) shows a top view of the adaptor as shown in FIGS. 268(a)-(e) but in semi-attached and fully attached condition, respectively, to the adaptor shown in FIG. 268(f);

FIGS. 268(i)-(j) show top and side views, respectively, of the adaptors in attached condition to each other as well as the adaptor shown in FIG. 268(c) in attached condition to the writing utensil;

FIG. 268(k) shows a side view similar to FIG. 268(j) but has an extension tab attachment as shown in FIGS. 268(l)-(n);

FIG. 268(l) shows an edge view of the extension tab attachment as seen in FIG. 268(k) and FIGS. 268(m)-(o) and shows the position of the open area to receive a raised area on the adaptor as seen in FIG. 268(p);

FIG. 268(m) is the same view as FIG. 268(l) but illustrates an area having an adhesive, micro-suction or nano tape pad or strip;

FIG. 268(n) shows a side view of one embodiment of an extension tab as seen in FIG. 268(k)-(m) and having an opening to receive a raised area on the adaptor as shown in FIG. 268(p)-(r);

FIG. 268(o) shows a side view of FIG. 268(m) and a view similar to FIG. 268(n) but without a raised area but rather an area having an adhesive, micro-suction or nano tape pad or strip;

FIG. 268(p) shows a front view of the attachments shown in FIG. 268(j) but having a raised area for mating with the opening in the extension tab shown in FIG. 268(n) when positioned between the adaptor and the writing utensil;

FIG. 268(q) shows a front view of the attachments shown in FIG. 268(j) and FIG. 268(p) as well as the extension tab shown in FIG. 268(l) in attached condition;

FIG. 268(r) is the same view as shown in FIG. 268(q) but in attached condition to a writing utensil;

FIG. 268(s) shows a front view of the attachment shown in FIGS. 268(a)-(e) but with one of the clips extended higher past the height of the top plane of the writing utensil so as to aid in its removal;

FIGS. 269(a)-(i) show similar views as illustrated in FIGS. 268(a)-(i) but having different adaptors connecting to each other and with the adaptor which is shown in FIGS. 269(a)-(b) in attached condition to the writing utensil;

FIG. 270(a) show a transparent adaptor in attached condition to a writing instrument;

FIG. 270(b) shows a transparent adaptor in unattached condition to a writing instrument;

FIG. 270(c) shows the two adaptors as seen in FIG. 270(a) and FIG. 270(b), respectively, in an attached condition to a writing utensil;

FIG. 271(a) is the same as FIG. 270(a);

FIG. 271(b) is similar to the adaptor in FIG. 270(b) but is only transparent near the end that has the opening and opaque elsewhere;

FIG. 271(c) is a side view of the adaptors in FIGS. 271(a)-(b) combined and in attached condition to a writing utensil;

FIG. 272(a) is a bottom view of one embodiment of the adaptor having a transparent end and opaque body and two addition openings;

FIG. 272(b) is a similar view of FIG. 272(a) but also showing the position of RF antenna, module, tag or microchip;

FIG. 272(c) shows a side view of an adaptor similar to an adaptor as shown in FIGS. 115-118 but having two raised areas that fit inside the openings as shown in FIGS. 272(a)-(b) and in attached condition to a writing utensil;

FIG. 272(d) shows a side view of the adaptors shown in FIG. 272(b)-(c) combined and in attached condition to a writing utensil;

FIG. 273 is an overhead view of the adaptor in attached condition to a writing utensil as shown in FIG. 272(d) and being held by a user's hand and said writing utensil making a mark on a piece of paper which can be seen through the transparent end of said adaptor and part of another mark having been made by said writing utensil unable to be seen because of the opaque part of said adaptor;

FIG. 274 shows cross sections of various material substrates used to make the adaptor according to the invention;

FIG. 275(a)-(d) shows various cross sections as seen in FIG. 274 but as laminated layers and having an open area which penetrates all layers;

FIG. 276 shows an overhead view of a touch screen device which has an attached cover and an adaptor in attached condition to a writing utensil with said adaptor attached to said touch screen device;

FIG. 277 shows an enlarged front view of the adaptor as seen in FIG. 276 having a extension tab perpendicularly to the bottom plane of a writing instrument attached to said adaptor;

FIG. 278 shows a front view of the adaptor as seen in FIG. 277 in attached condition to a touch screen device with said adaptor's extension tab in between the cover of said touch screen device and said device;

FIGS. 279-280 are similar to views seen in FIGS. 277-278 but with the position of the extension tab of the adaptor bent in a different orientation to a writing utensil and having an adhesive, micro-suction or nano tape pad attached to said extension tab and in attached condition to a touch screen device and underneath the cover of said device;

FIG. 281 shows a cover over a touch screen device and having a different variation of an opening near the side of one end;

FIG. 282 shows a side view of an adaptor in attached condition to a writing utensil as seen in FIG. 77 and having an adhesive, micro-suction or nano tape pad or strip of a shape that fits inside the opening as seen in FIG. 281;

FIG. 283 shows the opposite side view of the adaptor as seen in FIG. 282;

FIG. 284 shows a front view of the adaptor as seen in FIGS. 282-283 in attached condition to a touch screen device which has a cover over it and held closed by said attached stylus having an adhesive, micro-suction, nano tape pad which goes through the opening in said touch screen cover as seen in FIG. 281;

FIG. 285 shows a front view of said touch screen cover and its three sides and the position of the opening shown in FIG. 281;

FIG. 286-287 show similar views to FIGS. 284-285 but with the touch screen cover only having two sides;

FIG. 288-294 show similar views to FIGS. 281-287 but with the cover of the touch screen having a transparent upper part which allows the touch screen below its surface to still operate when using the adaptor according to the invention and it also has an opaque lower part that has an insulator coating or substrate and a surface that will accept marks made from a writing instrument but will not allow operation of the touch screen below it;

FIG. 295 shows an overhead view of a touch screen device cover as seen in FIG. 281 and an adaptor according to the invention in attached condition to a writing instrument;

FIG. 296 shows an overhead view of a touch screen device cover as seen in FIG. 281 and FIG. 295 but with the adaptor according to the invention in attached condition to a writing utensil, a user's hand holding said adaptor in attached condition to a writing instrument and said writing instrument making a mark on said touch screen cover;

FIG. 297 shows an overhead view of the touch screen cover as in FIG. 295 and FIG. 296 but in an open condition and a touch screen device having an identical but digital marking made by the adaptor seen in FIG. 296;

FIG. 298 shows a front view of a touch screen cover in unattached condition;

FIG. 299 shows a front view of the touch screen cover shown in FIG. 298 but in attached condition to a touch screen device and having an adaptor according to the invention in attached condition to a writing utensil and a touch screen device;

FIG. 300 shows the opposite view of FIG. 298;

FIGS. 301(a)-(c) show a sequence of front views of the touch screen cover shown in FIGS. 295-297 in different open positions;

FIG. 301(d) shows a side view of the device cover in attached condition to a touch screen device as seen in FIGS. 301(a)-(c) and shows an opening in the side to allow access to said device's buttons;

FIG. 302(a) shows an edge view of the touch screen device with a top cover positioned on top and extending past the edge of said device;

FIG. 302(b) shows an edge view of the touch screen device with a bottom cover positioned underneath;

FIG. 302(c) shows the top cover as seen in FIG. 302(a) but with a bend at one end enabling the edge of said cover to lay flat against an edge of a touch screen device and it shows a bottom cover extending past the edge of said device as shown in FIG. 302(b);

FIG. 302(d) show a similar view as shown in FIG. 302(c) but with the end of the bottom cover having a bend so as to allow the trapping of the edge of the top cover between itself and the edge of the touch screen device;

FIGS. 303-304 show similar views as seen in FIGS. 298-299 but having an additional material and a fold as seen in the enlarged view of FIG. 305;

FIG. 305 is an enlarged front view of the device cover as seen in FIGS. 303-304;

FIGS. 306(a)-(d) show the cover in varying open conditions;

FIG. 306(e) show a front view of the cover in attached condition to the touch screen device as seen in FIGS. 306(a)-(d) but in a fully open condition and folded under said touch screen device;

FIGS. 307(a)-(c) show side back and front views, respectively, of an attachment with the same size and shape of the adaptor extension tab as seen in FIGS. 307(d)-(e) and having multiple peel-off sticky-notes;

FIGS. 307(d)-(e) show front and side views, respectively, of the adaptor in attached position to a writing utensil and having the attachment shown in FIGS. 307(a)-(d) in attached condition to said adaptor extension tab;

FIGS. 308(a)-(e) show similar views as in FIGS. 307(a)-(e) but with attachment made of printed peel-off calendars;

FIGS. 309(a)-(e) show similar views as in FIGS. 307(a)-(e) but with attachment made of multiple sets of transparent sticky-notes with each set having areas at top with different colors;

FIGS. 310(a)-(e) are similar views seen in FIGS. 307(a)-(e) but with attachment to the extension tab of the adaptor made of multiple peel-off layers each showing a conjugated verb;

FIGS. 311(a)-(e) are similar views as seen in FIGS. 308(a)-(e) but with the attachment to the extension tab of the adaptor made of multiple peel-off layers each showing a word and its pronunciation and definition;

FIGS. 312(a)-(e) are similar views as seen in FIGS. 307(a)-(e) but with the attachment to the extension tab of the adaptor made of one or more writable layers;

FIG. 313(a) shows a bottom view of an adaptor having a layer toward the end near the opening and having an additional kiss-cut allowing a part of the outermost layer to be peeled away;

FIGS. 313(b)-(f) show a sequence of side views of the adaptor shown in FIG. 313(a) as a part of the outermost layer at the end is removed;

FIG. 313(g) shows a similar view as shown in FIG. 313(a) but with the part of the outermost layer completely removed and exposing the opening near the end;

FIGS. 314-318 show bottom views of different iterations of the adaptor shown in FIG. 313(a);

FIG. 319 shows an adaptor similar to FIG. 318 but having multiple peel-away layers;

FIGS. 320-321 show front and back views, respectively, of an attachment of same size and shape of the extension tab of the adaptor according to the invention with the back view showing an adhesive, micro-suction, nano tape pad for attaching to a touch screen device or similarly flat surface;

FIG. 322 shows a front view of an attachment similar to FIG. 320 and FIG. 321 but having a NFC tag or other RF antenna, tag, module or microchip, a ferrite layer, scannable code as well as an adhesive, micro-suction or nano tape pad;

FIG. 323 shows the attachment as shown in FIG. 323 but attached to a protective backer;

FIGS. 324(a)-(c) show an attachment having a bend at one end and is of a material capable of magnifying a view;

FIGS. 324(d)-(e) show side views of the attachment shown in FIGS. 324(a)-(c) in attached condition to an adaptor in attached condition to a writing utensil;

FIG. 325 shows a side view of an iteration of an adaptor according to the invention in attached condition to a writing utensil;

FIG. 326 shows the same view as shown in FIG. 325 but having an attachment as seen in FIGS. 343-345;

FIG. 327 shows a similar view as shown in FIG. 326 but with a different shaped writing utensil as seen in FIG. 328 and FIG. 330 and having an attachment as seen in FIGS. 329-333;

FIG. 328 is a front view of an adaptor in attached condition to a writing instrument;

FIG. 329 is a front view of an attachment as seen in FIG. 330-333;

FIG. 334 is a front view of an adaptor in attached condition to a writing utensil and as seen in FIG. 325;

FIG. 335 is a front view of an attachment as seen in FIG. 337-339;

FIG. 336 is the attachment in FIG. 335 in attached condition to the adaptor shown in FIG. 334;

FIG. 337 is the same view as shown in FIG. 335;

FIG. 338-339 are front and back views, respectively, of the attachment shown in FIG. 337;

FIG. 340 is a front view of the adaptor in attached condition to a writing utensil as seen in FIG. 325;

FIG. 341 is a front view of an attachment as seen in FIG. 344-345;

FIG. 342 is a front view of the attachment as seen in FIG. 341 but in attached condition to the adaptor as seen in FIG. 340;

FIG. 343 is a rotated view of the attachment shown in FIG. 341;

FIGS. 344-345 are front and back views, respectively, of the attachment as seen in FIG. 326 and FIGS. 341-343;

FIG. 346 is a repeat of FIG. 334 and FIG. 346;

FIG. 347 is a front view of an attachment as seen in FIGS. 349-351;

FIG. 348 is a front view of the attachment shown in FIG. 347 and FIGS. 349-351 but in attached condition to an adaptor as seen in FIG. 346;

FIG. 349 is a repeat of FIG. 347;

FIGS. 350-351 are front and back views respectively of the attachment shown in FIGS. 347-349;

FIG. 352 shows an overhead view of a touch screen device with a piece of paper being held to said device by an adaptor according to the invention which is in attached condition to a writing instrument;

FIG. 353 shows the opposite view of said adaptor with said piece of paper in attached condition to the adaptor;

FIG. 354 shows a front view of an adaptor in attached condition to a writing utensil;

FIG. 355 shows a side view of an attachment having two bent ends and an adhesive, micro-suction, nano tape pad;

FIG. 356 shows the attachment in FIG. 355 in attached condition to the adaptor shown in FIG. 354;

FIG. 357 shows the same view as FIG. 356 and a piece of paper and a flat vertical surface such as a wall;

FIG. 358 show an attachment similar to the one shown in FIG. 355 but with a more extreme lower bend;

FIG. 359 shows the attachment in FIG. 358 but in attached condition to an adaptor that is in attached condition to a writing utensil and a side view of a piece of paper and a flat vertical surface such as a wall;

FIGS. 360-361 are front and back views of the attachment shown in FIG. 355;

FIG. 362 is a side view of an attachment similar to that shown in FIG. 355 and FIG. 358 but with only one bend and a larger adhesive, micro-suction or nano tape pad;

FIG. 363 is a side view of the adaptor shown in FIGS. 360-361 but in attached condition to an adaptor which is in attached condition to a writing utensil;

FIG. 364 shows the opposite side view of FIG. 363 but with a piece of paper in attached condition to the attachment shown in FIG. 360-361;

FIG. 365 shows the opposite side view of FIG. 364;

FIGS. 366-377 show similar views to FIGS. 354-365 but with an additional adhesive, micro-suction, nano tape strip or pad;

FIGS. 378-389 show similar views to FIGS. 366-377 but with different sized adhesive, micro-suction, nano tape pads or strips;

FIG. 390 shows a bottom plan view of an adaptor according to the invention and having a transparent end and a coating or layer that is an insulator and an area near the middle of said insulator that is of the same conductive material as at the adaptor end and along its length;

FIG. 391 shows a side view of the adaptor shown in FIG. 390 but in the formed shape as if attached to a writing utensil;

FIG. 392 shows the adaptor as seen in FIGS. 390-391 but in attached condition to a writing utensil;

FIG. 393 show a bottom plan view of an adaptor as seen in FIG. 390 but without the extension tab and with a NFC tag, ferrite layer and an adhesive, micro-suction, or nano tape pad or strip;

FIG. 394 is a side view of the adaptor shown in FIG. 393 but in attached condition to a writing utensil;

FIG. 395-403 are similar views as shown in FIG. 6-14 but with the addition of an adhesive, micro-suction or nano tape pad or strip;

FIGS. 404-411 are similar views as seen in FIGS. 354-365 but having a larger adhesive, micro-suction or nano tape pad or strip and with an attachment in attached condition to the exposed outer side of an adaptor instead of between said adaptor and an attached writing utensil;

FIG. 412 is a flow chart of the process of ordering, customizing and fulfilling an order for an adaptor according to the invention;

FIGS. 413-419 show various side, top and bottom views of different adaptors according to the invention and having a bent end at or near the opening at one end of the adaptor;

FIGS. 420-425 show a work surface or other hard flat surface and an adaptor as seen in FIG. 413 in an attached condition to a writing utensil with the bent end of the adaptor protecting the point of said writing utensil from accidentally hitting a hard surface (i.e., when dropped);

FIGS. 426-428 show enlarged views of a pencil point in different conditions of wear when said pencil is rotated after being worn when used on paper;

FIGS. 430-432 show an enlarged view of an adaptor in attached condition to a pencil and the different conditions of wear of the point of said pencil as shown in FIGS. 426-428 and when said pencil is rotated in said adaptor;

FIG. 433 shows an overhead view of an adaptor as shown in FIGS. 429(a)-(b) and FIGS. 430-432 with a user's hands holding said adaptor so as to rotate the attached pencil in said adaptor to expose a more sharp edge of the pencil point of said pencil;

FIG. 434 shows a front view of an adaptor in attached condition to a writing utensil and having an attachment as seen in FIG. 435;

FIG. 435 shows a front view of an attachment having two bent ends, an adhesive, micro-suction or nano tape pad or strip, at least one other area having an adhesive, micro-suction or nano tape pad or strip, and a NFC tag or other type of RF antenna, module, tag or microchip;

FIG. 436 shows a similar view as seen in FIG. 435 but with said adhesive, micro-suction or nano tape pad or strip in a different position as well as the NFC tag or other type of RF antenna, module, tag or microchip in a different position;

FIG. 437 shows a front view similar to the one shown in FIG. 436 but with the material above the top bend extended to a longer length;

FIG. 438 shows an attachment as seen in FIG. 437 with a piece of paper in attached condition to said attachment and said attachment in attached condition to a wall or other flat surface;

FIG. 439 shows a side view of the attachment shown in FIGS. 437-438 and a note cord in attached condition to said attachment;

FIG. 440 shows the opposite side view of the attachment shown in FIG. 439 in unattached condition to a piece of paper or note card and showing a position of a NFC tag or other type of RF antenna, tag, module or microchip, an adhesive, micro-suction, nano tape pad or strip as well as another adhesive, micro-suction, nano tape pad or strip;

FIG. 441 shows a similar view as seen in FIG. 438;

FIG. 442 shows the opposite view as shown in FIG. 439;

FIG. 443 is a similar view as shown in FIG. 439;

FIG. 444 is a similar view as shown in FIG. 440;

FIG. 445 is a similar view as shown in FIG. 437;

FIG. 446 show the side view of a touch screen device having RF capabilities and in position to detect a NFC tag or other RF tag, module, antenna or microchip that is on an attachment shown in FIG. 445 and in attached condition to a piece of paper and a smooth vertical surface such as a wall;

FIG. 447 shows a front view of what is shown in FIG. 446 with a user's hand holding the touch screen device up to the RF enabled attachment which is in attached condition to a piece of paper and a digital activity displayed on the touch screen device;

FIGS. 448-451 are similar views as shown in FIGS. 443-447 but with the attachment shown in FIG. 449 having an adhesive, micro-suction, nano tape pad or strip area divided into multiple said strips or pads;

FIG. 452 shows a view similar to that shown in FIG. 446 but with a user's hand holding the touch screen device and activating said the wireless RF capability of said device to detect a RF antenna, tag, module or microchip on the attachment having said RF antenna, tag, module or microchip;

FIG. 453 shows a similar view as shown in FIG. 448 with the adaptor in attached condition to a piece of paper and said attachment having one bend and at least one scannable code printed, etched, stuck or stamped on it;

FIG. 454 shows the opposite side of FIG. 453 and having two areas of adhesive, micro-suction, nano tape pads or strips;

FIG. 455 is a side view of FIG. 455;

FIG. 456 is a front view of a touch screen device having a capability of scanning codes such as a QR code or barcode and being held by a user's hand and in a position to scan said code on an attachment which is in attached condition to a piece of paper;

FIG. 457 shows a side view of FIG. 456 with the attachment in attached condition to both a piece of paper and a wall;

FIGS. 458(a)-(b) show front and back views, respectively, of an attachment as shown in FIGS. 443-444;

FIGS. 459(a)-(b) show similar views as seen in FIGS. 458(a)-(b) but with the adhesive, micro-suction or nano tape pad or strip in position over a bend in the attachment;

FIG. 459(c) is a side view of the attachment shown in FIGS. 459(a)-(b);

FIG. 460 shows a front view of a retail package holding several attachments as seen in FIGS. 458(a)-(b);

FIG. 461 shows a side view of FIG. 460;

FIG. 462(a)-(b) show the same view as in FIG. 458(a)-(b);

FIGS. 463(a)-(b) show front and back views as shown in FIGS. 462(a)-(b) but with the back of the attachment having multiple adhesive, micro-suction or nano tape strips or pads below the top bend and another below said pads or strips;

FIG. 463(c) is a side view of the adaptor shown in FIGS. 463(a)-(b);

FIG. 464 is the opposite side view as shown in FIG. 460 which shows multiple attachments as shown in FIGS. 462(a)-(b);

FIG. 465 shows a side view of FIG. 464 but only one column of attachments as seen in FIG. 463(c) and with the top attachment in a partly peeled away condition to the surrounding material holding it and the other attachments in place;

FIGS. 466(a)-(b) show front and side views as seen in FIG. 460 and FIG. 461, respectfully, but with one attachment removed from its original position on the sheet and instead in attached condition at the top of a sheet which is holding the remaining attachments and in attached condition to a smooth surface such as a countertop edge;

FIG. 467(a) shows one variation of the back view of the attachment seen at the top of FIG. 466;

FIG. 467(b) shows another variation of the back side of the attachment as seen in FIG. 466 but with one of the adhesive, micro-suction or nano tape pads overlapping the bend at the top and also shows two additional adhesive, micro-suction or nano tape pads as well as an adhesive, micro-suction, nano tape pad or strip below the bend near the bottom of said attachment;

FIG. 467(c) shows another variation of the back of the attachment seen in FIG. 466 but having multiple adhesive, micro-suction or nano tape pads or strips as well as an adhesive, micro-suction, nano tape pad or strip near the bottom edge;

FIG. 468 shows a side view of FIG. 467 and in attached condition to a flat surface such as a wall or edge of a countertop or work surface and also in attached condition to the top edge of a piece of paper as well as being in attached condition to the bottom edge of said paper by means of an adhesive, micro-suction or nano tape strip or pad on the angled part of the attachment;

FIG. 469 shows a front view of a retail package holding three attachments as shown in FIG. 462(a) or FIG. 467;

FIG. 470 shows a side view of FIG. 469;

FIG. 471 shows a front view of a retail package holding one attachment as shown in FIG. 473(a)-(b);

FIG. 473(a)-(b) show front and back views, respectively, of an attachment similar to one shown in FIG. 382 but with a NFC tag or other RF antenna, module, tag or microchip positioned above the top bend in said attachment;

FIG. 474 shows a front view of a retail package having an opening for a receiving a retail display hook or peg and holding three attachments as shown in FIG. 473(a) as well as an adaptor and a note card sized to fit the surface of a touch screen device;

FIG. 475(a) shows a front view of an adaptor in attached condition to a writing utensil and having an adaptor as shown in FIG. 473(a)-(b) and in a rotated condition as seen in FIG. 475(b);

FIG. 475(b) shows a user's hand holding the adaptor in attached condition to a writing utensil and attachment as shown in FIG. 475(a) and a side view of a touch screen device resting on a flat work surface and the NFC tag of said attachment positioned under said touch screen device in a area of said device that can detect said tag or other type of RF antenna, module, tag or microchip;

FIG. 476(a)-(d) shows side, top, bottom and front views, respectively, of one embodiment of a pre-formed adaptor having a clip-on attachment for attachment to a writing utensil;

FIG. 477(a) shows a side view of an alternative embodiment of a pre-formed adaptor;

FIG. 477(b) shows a bottom view of an alternative embodiment of an adaptor before it has been formed when attached to a writing utensil;

FIG. 478(a) shows the adaptor as seen in FIGS. 476(a)-(d) in attached condition to a writing utensil;

FIG. 478(b) shows a top view of an adaptor having an extension tab;

FIG. 478(c) shows a top view of the adaptor in attached condition to a writing utensil as seen in FIG. 478(a) positioned on top of the adaptor as seen in FIG. 478(b);

FIG. 478(d) shows a similar view as seen in FIG. 478(c) but in semi-attached condition to a writing utensil;

FIG. 478(e) shows a similar view as seen in FIGS. 478(c)-(d) but with both adaptors in fully attached condition to the writing instrument;

FIG. 479 shows another embodiment of the adaptor seen in FIG. 478(b) having been pre-formed in its final shape for attachment over an adaptor as seen in FIGS. 477(a)-(b) and a writing utensil;

FIG. 480 is a front view of the adaptor shown in FIGS. 477(a)-(b) when in attached condition to a writing utensil;

FIG. 481 shows a similar view as shown in FIG. 480 but also having an adaptor as shown in FIG. 478(b) in attached condition to a writing utensil;

FIG. 482 shows a front view of FIGS. 478(e)-(f) but with the extension tab perpendicular to the top plane of the attached writing instrument;

FIG. 483 is a similar view to FIG. 482 but with the extension tab in a different final position and is also a front view of FIG. 479 when the adaptors are attached condition to a writing utensil;

FIG. 484(a) is a similar view as FIG. 476(a) but shows an adaptor having a RF antenna, tag, module or microchip;

FIG. 484(b) is a similar view to FIG. 476(b) and is a top view to FIG. 484(a);

FIG. 484(c) is similar to the view shown in FIG. 476(c) but also has a RF antenna, tag, module or microchip;

FIG. 484(d) shows the front view of FIGS. 484(a)-(c) but in attached condition to a writing utensil;

FIG. 485(a) is the same view as shown in FIG. 477(a);

FIG. 485(b) shows the front view of FIG. 485(a) but in attached condition to a writing utensil;

FIGS. 486(a)-(f) are similar views seen in FIGS. 478(a)-(f) but show one embodiment of the extension tab of the adaptor having a scannable code, RF antenna, tag, module or microchip under an adhesive, micro-suction or nano tape pad or strip;

FIG. 487 through FIG. 489 show front views similar to those shown in FIGS. 481-483 but having an adhesive, micro-suction or nano tape pad or strip as well as a RF antenna, tag, module or microchip;

### DETAILED DESCRIPTION OF THE DRAWINGS

Other objects and advantages of the invention will become apparent from a study of the following specification when viewed in the light of the accompanying drawing, in which:

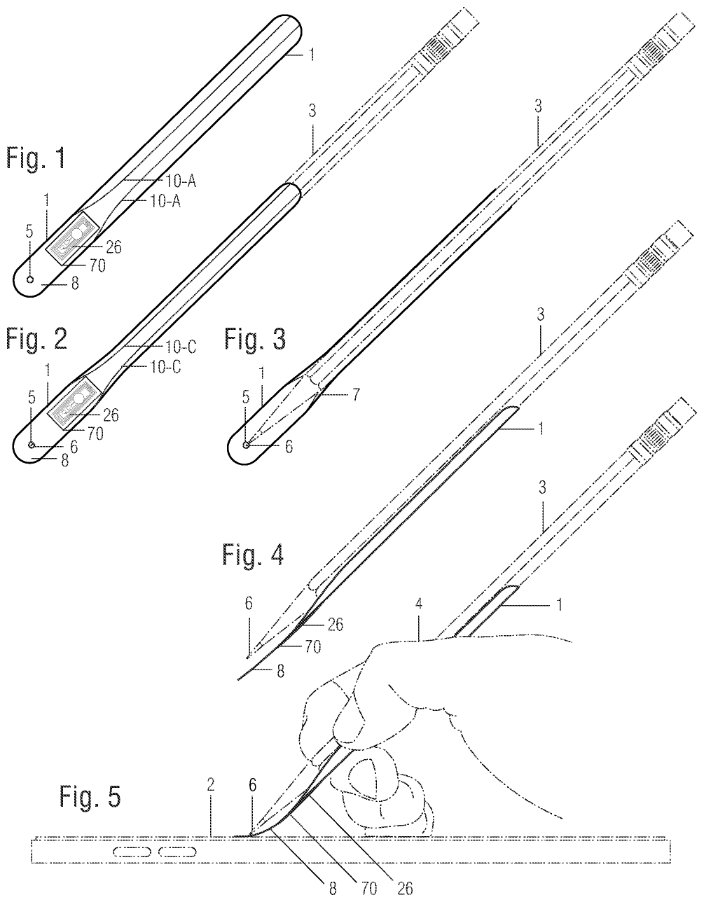

FIG. 1 shows a bottom view of the adaptor according to a preferred embodiment of the invention unattached to a writing instrument;

FIG. 2 shows a bottom view of the adaptor in attached condition to a writing instrument;

FIG. 3 is a top view of the adaptor in attached condition to a writing instrument;

FIG. 4 is a side view of the adaptor in attached condition to a writing instrument;

FIG. 5 shows the same view as in FIG. 4 and used in connection with a mobile device;

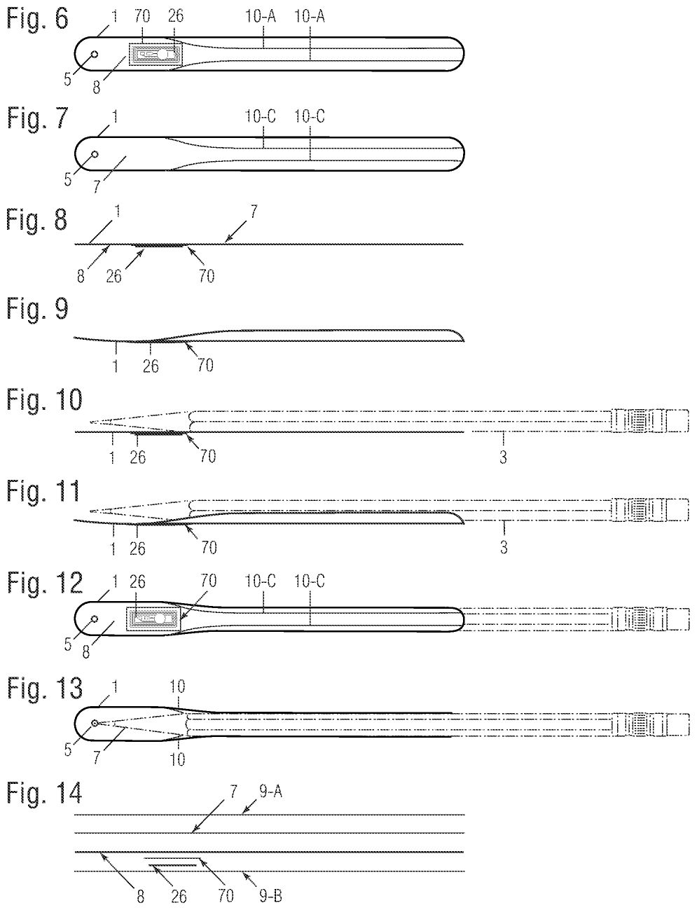

FIGS. 6-8 show bottom, top and side plan views of the adaptor;

FIG. 9 shows a side view of the adaptor in a condition as if attached to a writing instrument;

FIG. 10-11 shows a side view of the adaptor with a writing instrument in unattached and attached conditions, respectively;

FIGS. 12-13 show bottom and top views of the adaptor with a writing instrument in attached condition;

FIG. 14 is a side plan view of the adaptor of FIG. 1;

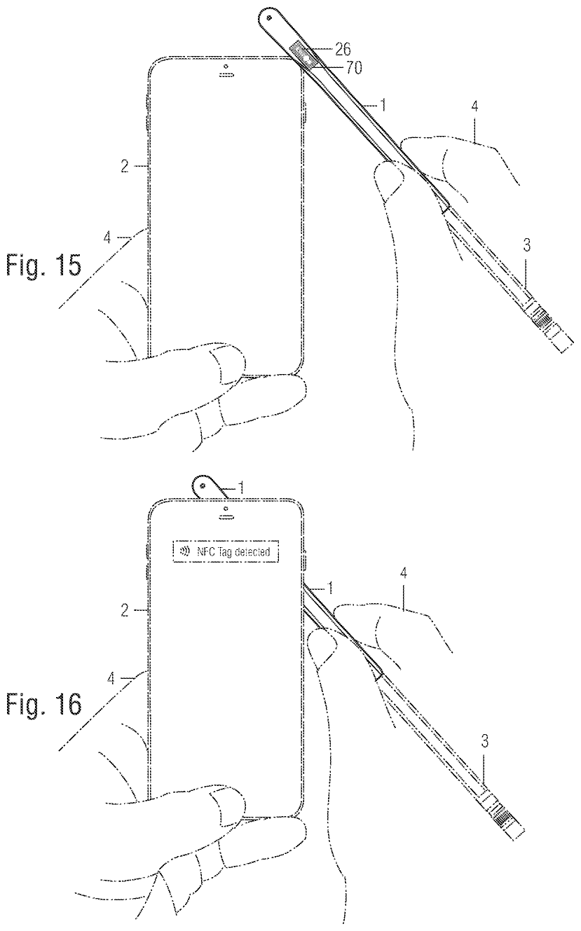

FIGS. 15-16 show bottom views of the adaptor attached to a writing instrument and in relation to a mobile device as to be detected by said device's Near Field Communication (NFC) technology;

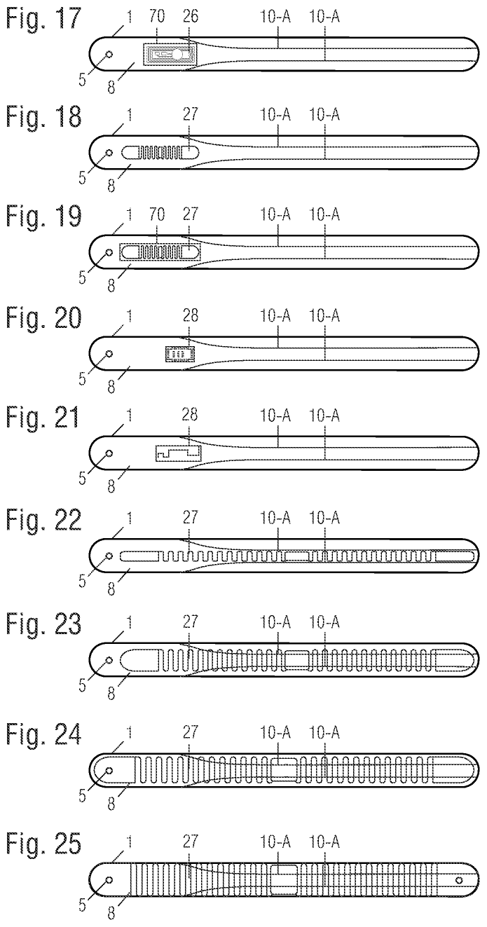

FIG. 17-25 show bottom views of alternate types of Radio Frequency (RF) antennae, tags, modules, microchips;

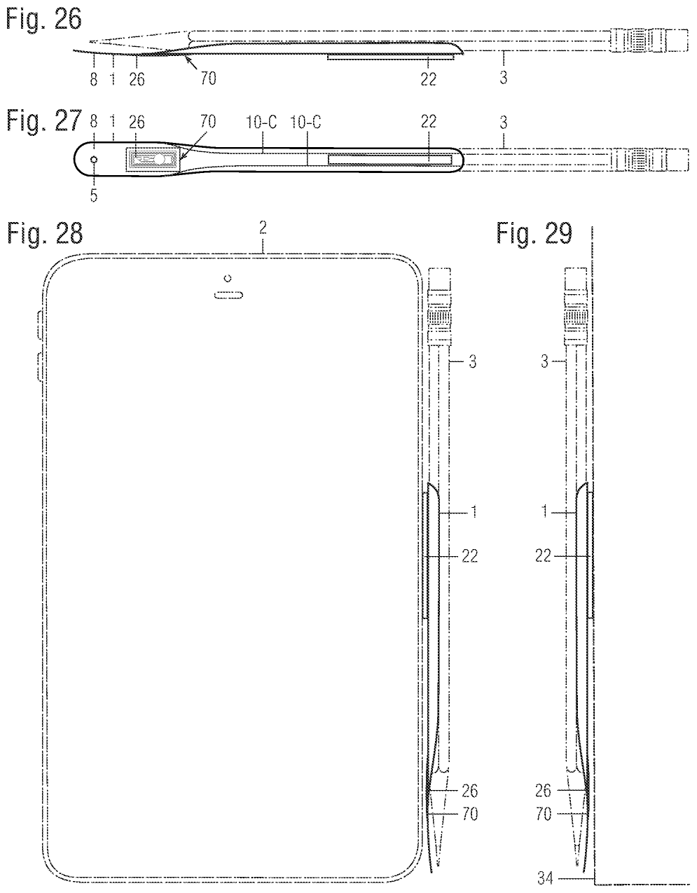

FIG. 26 shows a side view of the adaptor as shown in FIG. 4 and a writing instrument in attached condition and shows an attachment strip comprising an adhesive, micro-suction or nano tape 22-A;

FIG. 27 is a bottom view of FIG. 26

FIG. 28 shows the adaptor and a writing instrument 3 in attached position as seen in FIG. 26 and attached to the side of a touchscreen device 2 by means of the attachment strip 22-A;

FIG. 29 shows the adaptor and a writing instrument 3 in attached position as seen in FIG. 26 and attached to the side of a work surface 34 by means of the attachment strip 22-A;

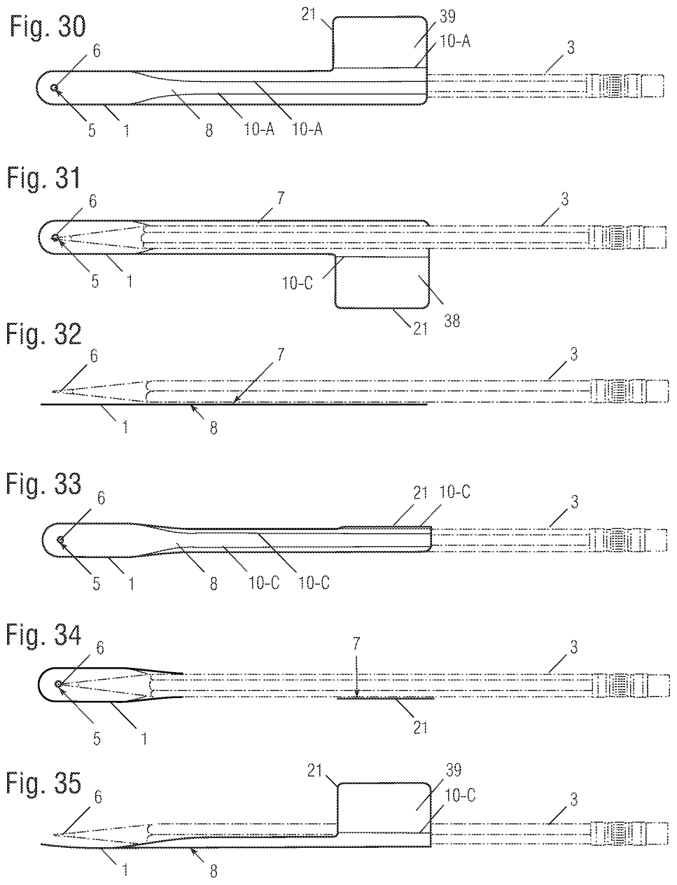

FIG. 30 shows the adaptor having an extension tab 21-A and a writing instrument 3 in unattached position FIG. 31 shows a top view of FIG. 30;

FIG. 32 shows a side view of FIG. 30;

FIG. 33 is a bottom view of the adaptor having an extension tab 21-A and a writing instrument 3 in an attached position;

FIG. 34 is a top view of FIG. 33;

FIG. 35 is a side view of FIG. 33;

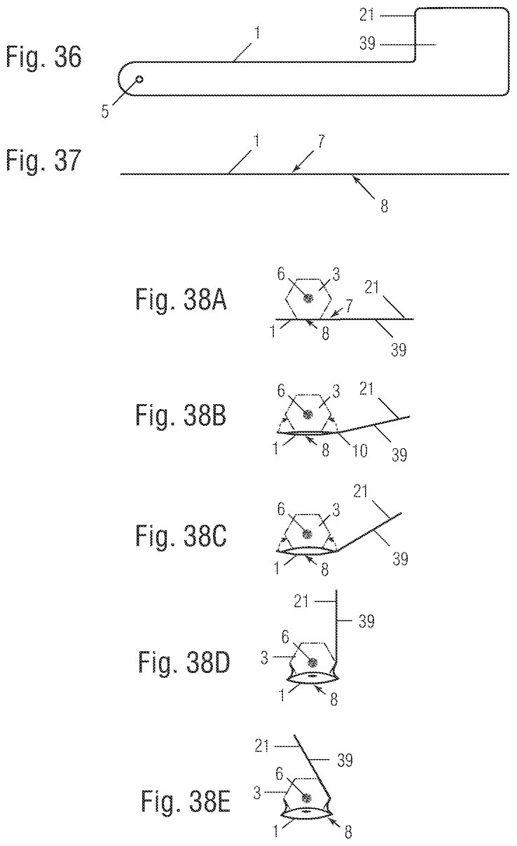

FIGS. 36 and 37 are bottom and side views respectively of the adaptor having an extension tab 21-A;

FIG. 38(a)-(e) are front views showing the sequence of steps, respectively, for connecting the adaptor to a writing instrument;

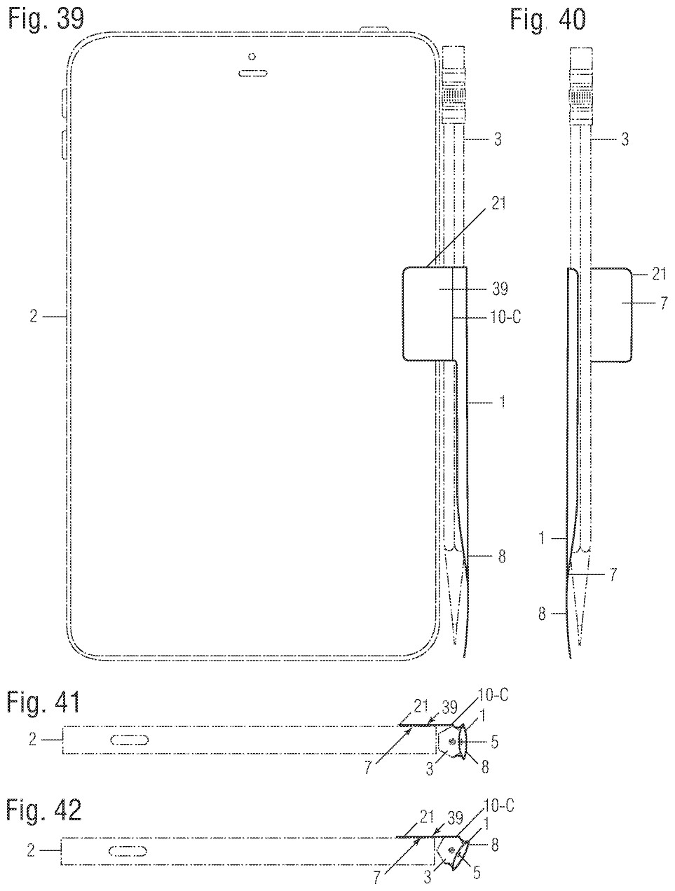

FIG. 39 shows a side view of the adaptor as seen in FIG. 35 and attached to a touchscreen device

FIG. 40 shows the opposite side view of FIG. 35:

FIG. 41 shows a side view of a touchscreen device and front view of the adaptor as seen in FIG. 38(d) attached to a touchscreen device;

FIG. 42 shows an alternative position of the tab extension of the adaptor as seen in FIG. 38(a) and a sideview of the touchscreen device;

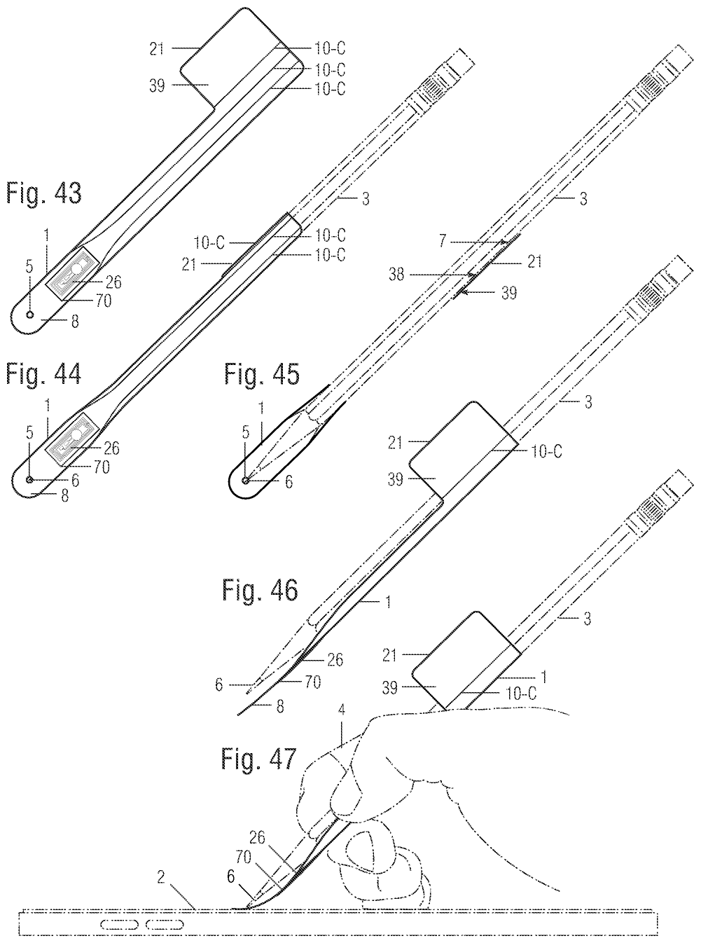

FIG. 43-46 are views similar to FIGS. 30-35 showing the adaptor attached to a writing instrument but in a writing position and comprising a NFC tag;

FIG. 47 is a side view showing the adaptor shown in FIGS. 43-46 pressed against a capacitive touch screen

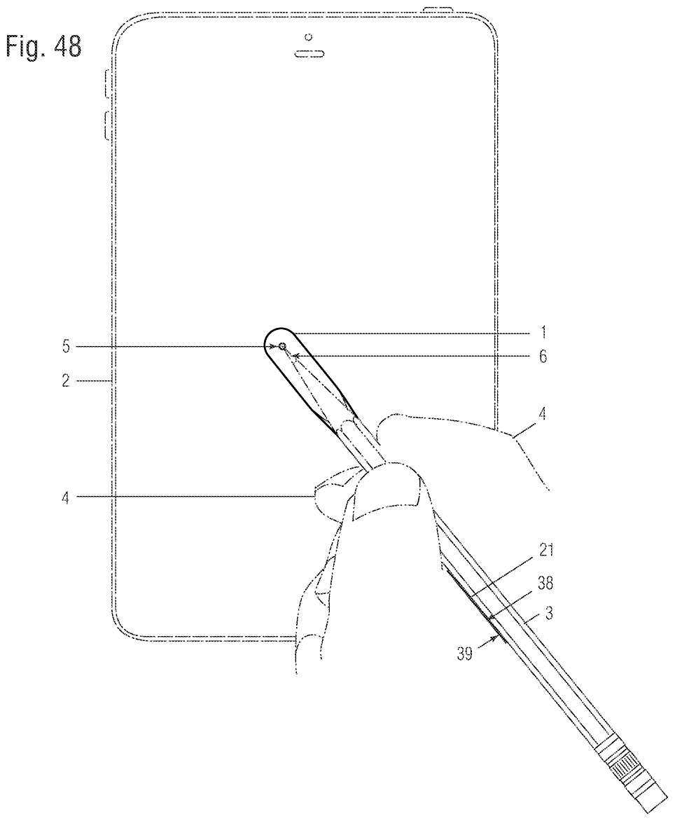

FIG. 48 is a top view of FIG. 47 showing the adaptor pressed against the capacitive touch screen device;

FIG. 49(a)-(b) show top and side views, respectively, of the touch screen device and the sequence of the user's hand positions when removing and then using the adaptor with the extension tab when attached to a writing instrument;

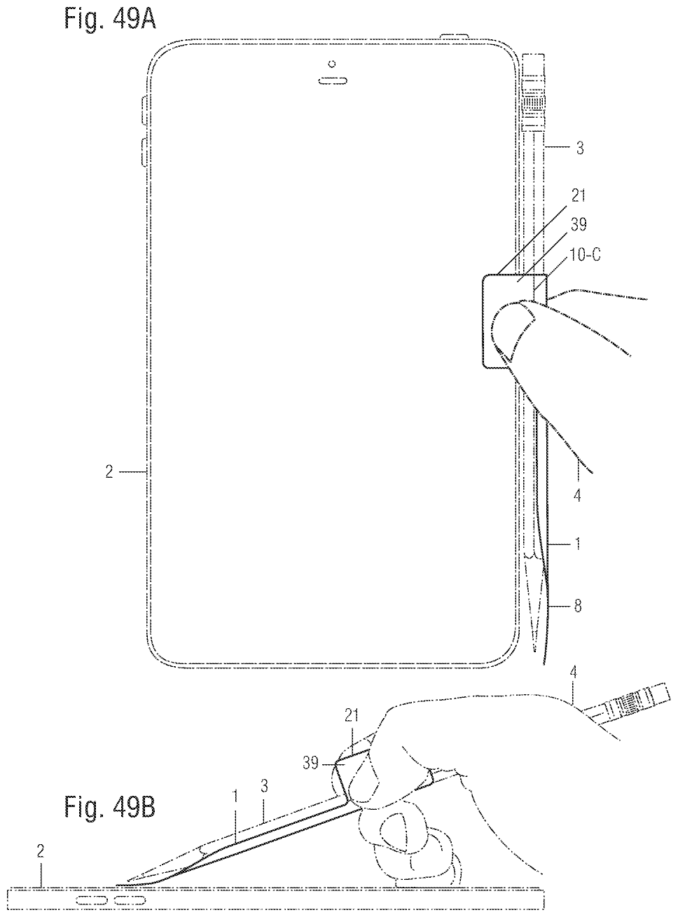

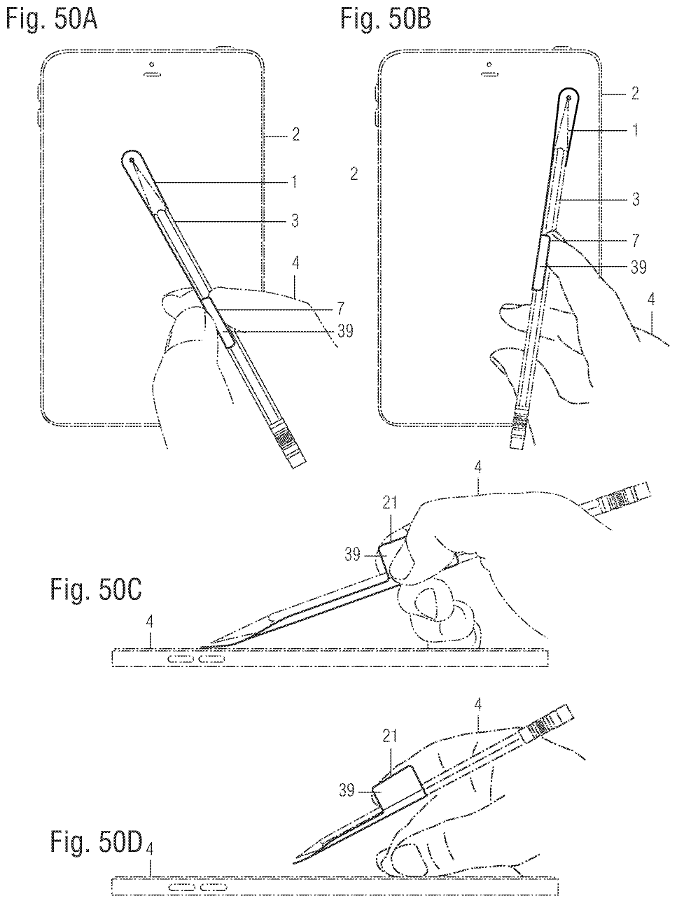

FIG. 50(a)-(b) show top views of FIG. 49(b) and demonstrate the extension tab of the adaptor enabling said adaptor to stay attached to the user's finger when it is necessary to free other fingers and thumb in order to operate the touch screen device with two fingers;

FIGS. 50(c)-(d) show side views of FIGS. 50(a)-(b);

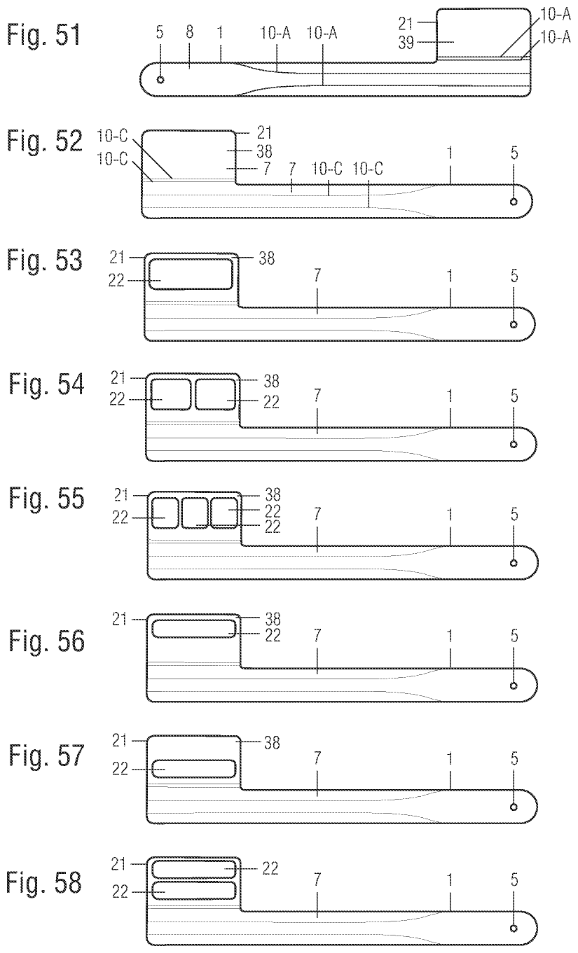

FIGS. 51-52 show bottom and top views, respectively, of adaptor with extension tab having kiss-cuts, scores or bends;

FIGS. 53-58 show the same view as FIG. 52 but with the addition of one or more adhesive, micro-suction or nano tape pads;

FIGS. 59-60 are views similar to FIGS. 51-52 but additionally show the NFC tag position on bottom and top sides, respectively, of two different embodiments of the adaptor;

FIG. 61 is a top view of FIG. 59 but having an adhesive, micro-suction or nano tape pad on the extensive of the adaptor;

FIGS. 62-66 show varying embodiments of the adaptor with alternative combinations of adhesive, micro-suction or nano tape pad or pads with RF antenna, antennae, tags, microchips, or modules;

FIG. 67 shows another embodiment of the adaptor having an RFID antenna positioned on the extension tab;

FIG. 68 shows a similar view of FIG. 67 but having an adhesive, micro-suction or nano tape pad attached to the extension tab of the adaptor;

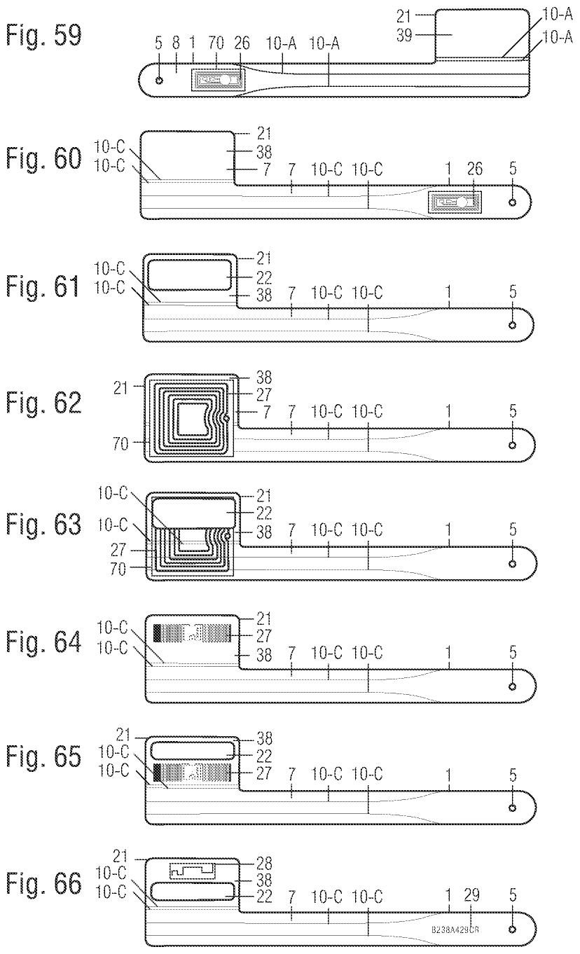

FIGS. 70-74 show varying embodiments of the adaptor with alternative combinations of adhesive, micro-suction or nano tape pad or pads with RF antenna, antennae, tags, microchips, or modules as well as alpha-numeric codes or scannable codes;

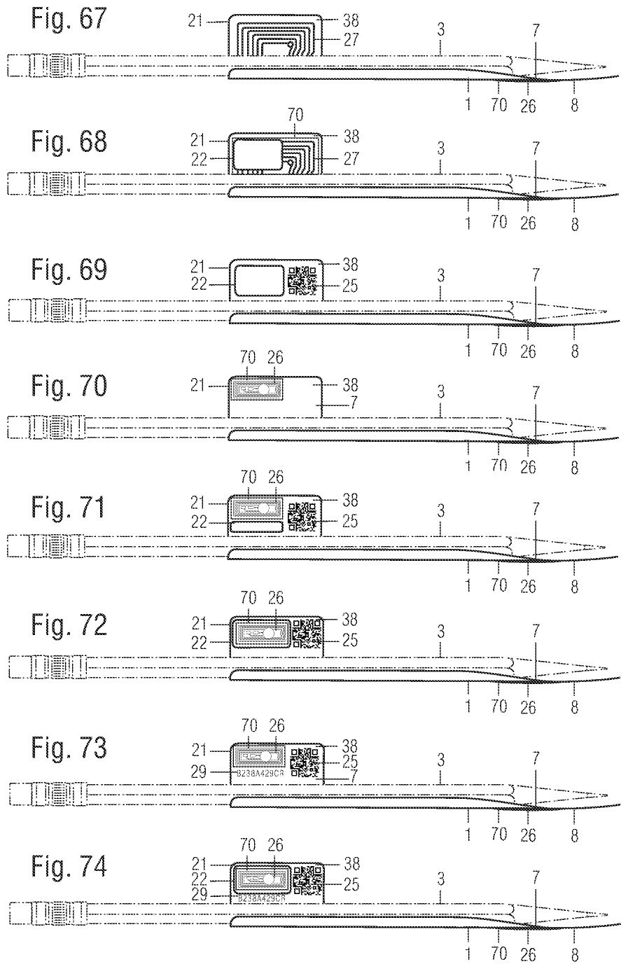

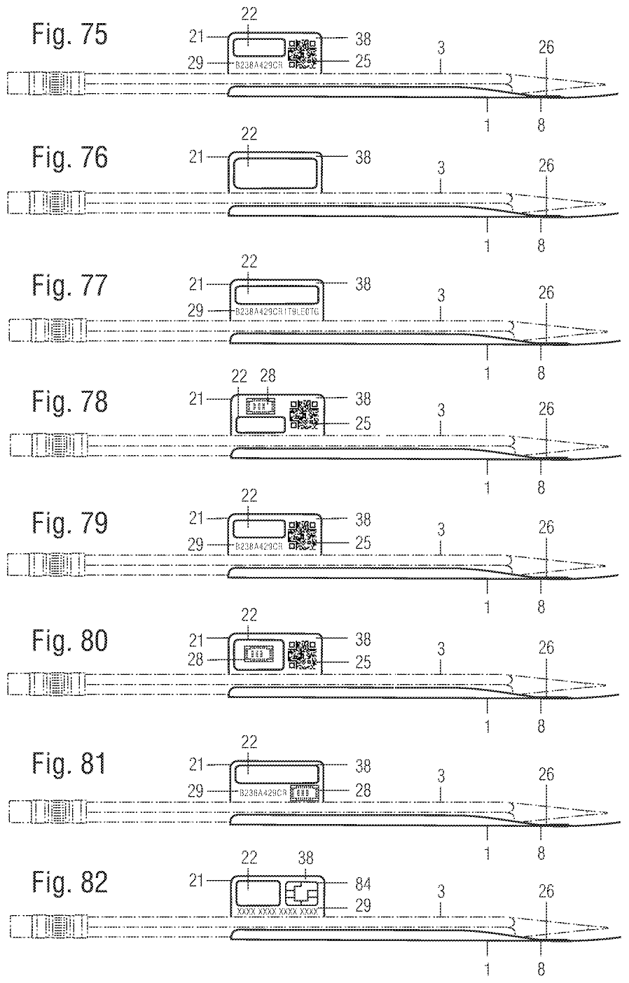

FIGS. 75-82 show additional varying embodiments of the adaptor with alternative combinations of adhesive, micro-suction or nano tape pad or pads with RF antenna, antennae, tags, microchips, or modules as well as numeric, alpha-numeric or scannable codes;

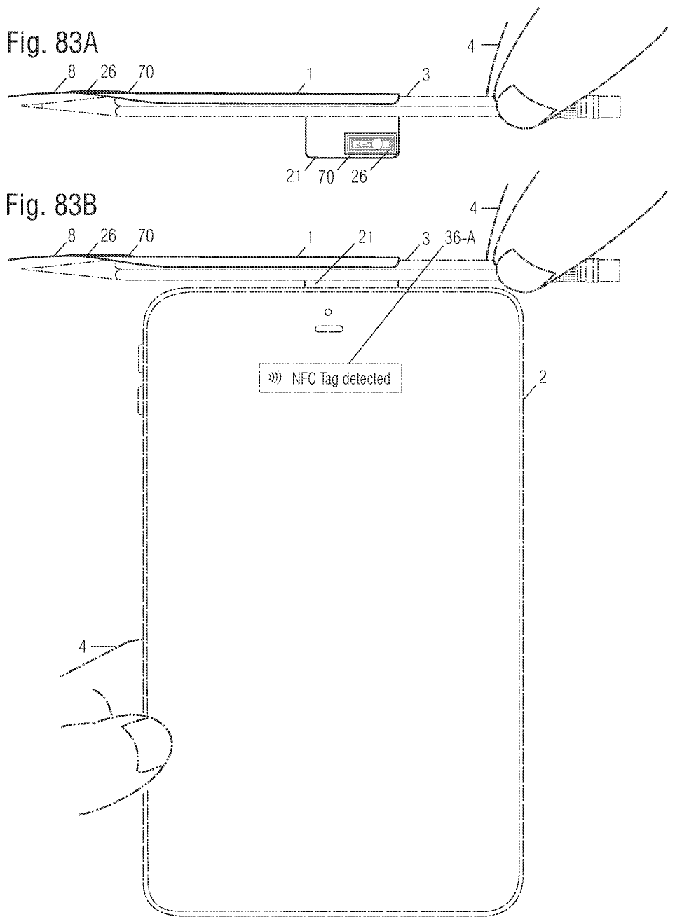

FIGS. 83(a)-(b) show the sequence of an embodiment of the adaptor with NFC tag being positioned by the user's hand behind the touch screen device in order for said device to scan said NFC tag;

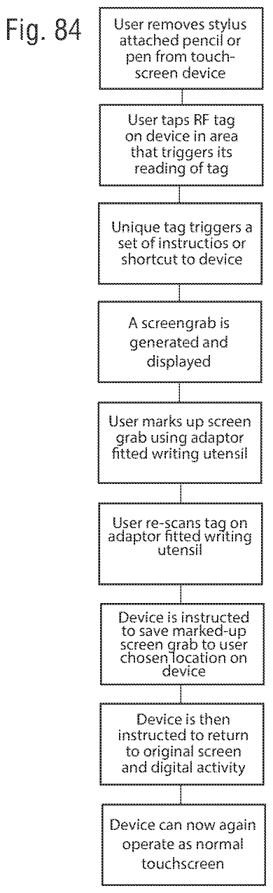

FIG. 84 is a flow chart showing the process of using a RF enabled adaptor fitted writing utensil to perform a digital activity;

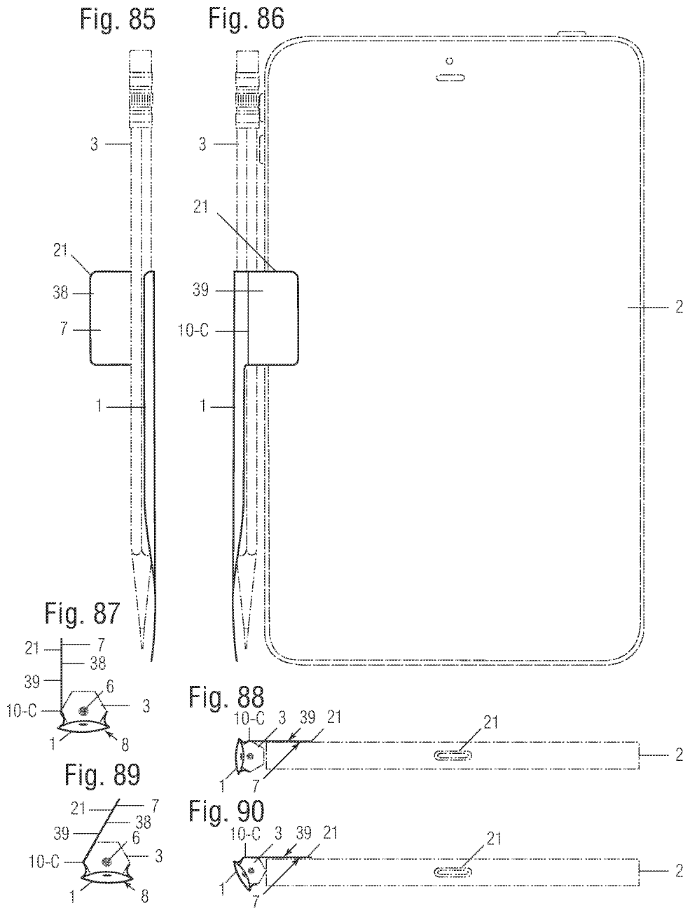

FIG. 85-90 show varying side, top and front views of adaptor in attached and unattached condition to the writing utensil and touch screen device;

FIG. 91 shows a top view of a touch screen device having a protective case with an embodiment of the adaptor fitted writing utensil attached to the touch screen device;

FIG. 92 shows the opposite side of the adaptor fitted writing utensil shown in FIG. 91 with the extension tab of said adaptor having an adhesive, micro-suction or nano tape pad;

FIG. 93 is a front view of the adaptor shown in FIG. 91 and FIG. 92;

FIG. 94 is a front view of FIG. 91;

FIG. 95 shows a front view of an alternative position of the extension tab of the adaptor attached to a writing utensil;

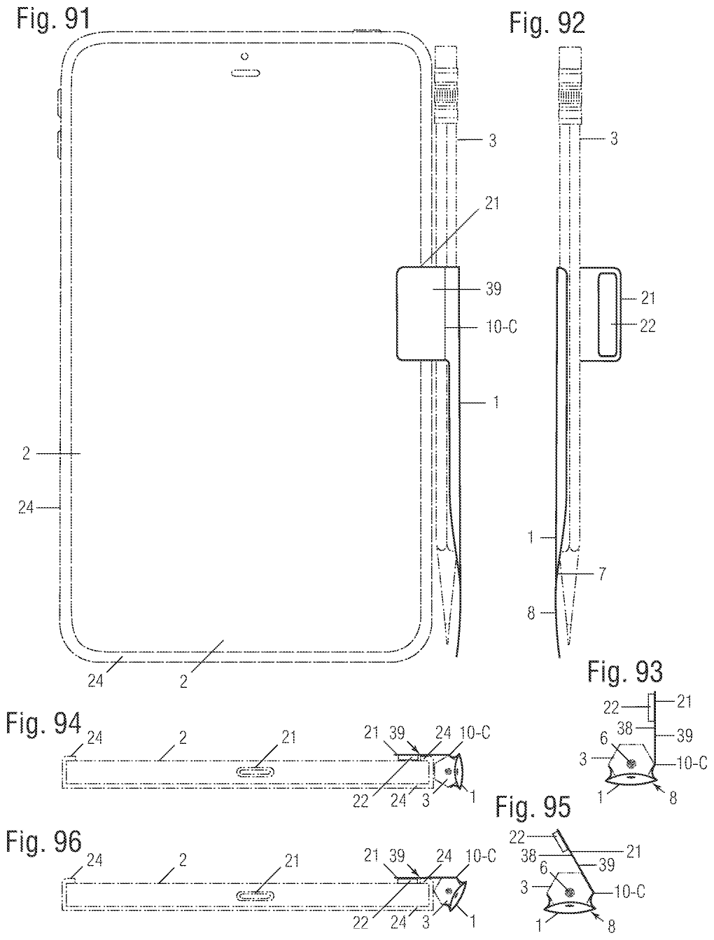

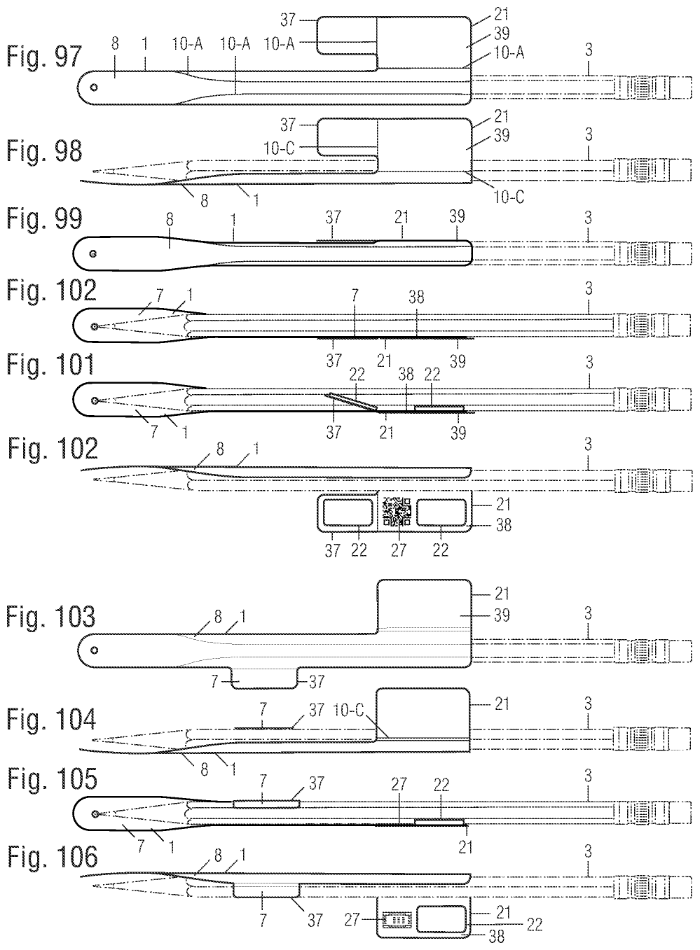

FIG. 96 is a front view of FIG. 91 showing the alternative position of the extension tab of the adaptor attached to a writing utensil as shown in FIG. 95; FIG. 97 is a bottom view of an embodiment of adaptor extension tab having a bendable extension off its side in an unattached condition to a writing utensil;

FIG. 98 shows the attached condition to the writing utensil of the adaptor shown in FIG. 97;

FIG. 99 is a bottom view of the adaptor shown in FIGS. 97-98 in an attached condition to the writing utensil;

FIGS. 100-101 shows top views of the adaptor shown in FIGS. 97-99 with the additional extension to the extension tab in straight and bent positions, respectively, with the bent position showing an alternative embodiment of the adaptor having adhesive, micro-suction or nano tape pads on the extension tab;

FIG. 102 is the opposite side view of the adaptor shown in FIG. 98 but with the embodiment shown in FIG. 101 and a scannable code on the extension tab;

FIGS. 103-106 show varying views of the adaptor having an additional extension tab as well as a BLE (Bluetooth Low Energy) module and adhesive, micro-suction or nano tape pad;

FIGS. 107-110 show side, bottom and top views, respectively, of one embodiment of the adaptor having a NFC tag as well as two extension tabs or clips in an attached condition to the writing utensil;

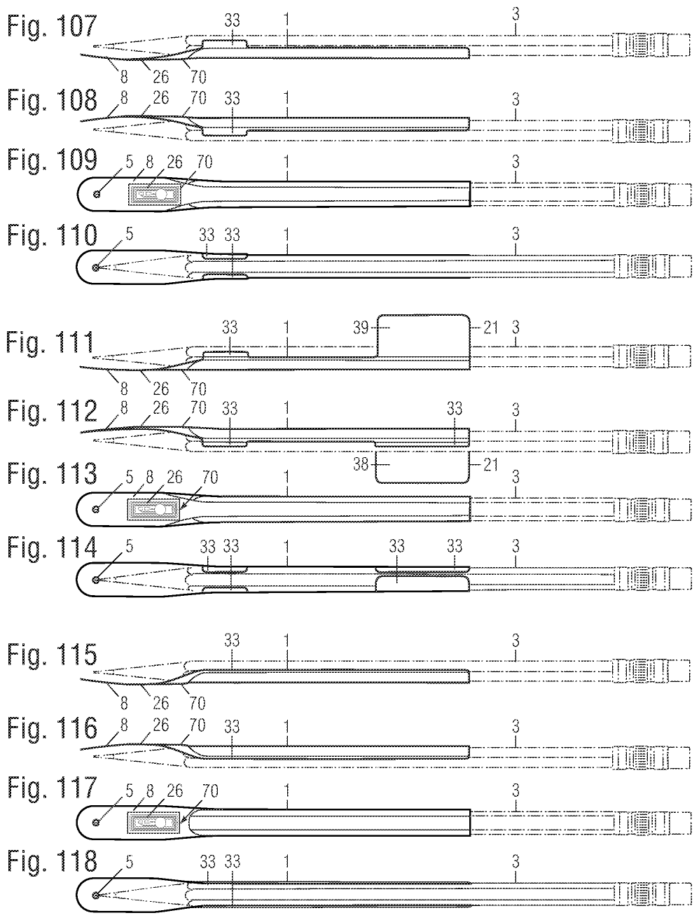

FIGS. 111-114 are similar views of FIGS. 107-110 but having two additional extension tabs;

FIGS. 115-118 are similar views of FIGS. 107-110 but having thinner and longer extension tabs or clips;

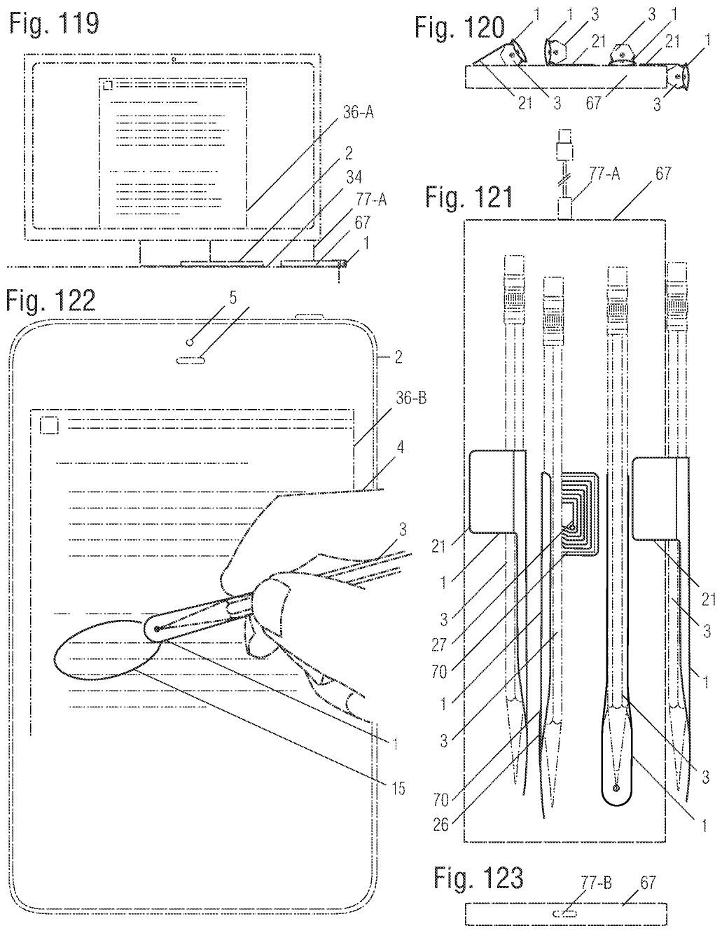

FIG. 119 shows a desktop computer and its monitor displaying a digital activity (i.e. web browser page) as well as a touch screen device set on the same work surface as said computer and also a RF reader attached to said computer by means of a USB-C connector and having an adaptor fitted writing utensil attached to its side;

FIG. 120 shows a front view of said RF reader with adaptor fitted writing utensils laid on top and attached to its side;

FIG. 121 is a top view of FIG. 120 and shows the USB-C connector cable;

FIG. 122 is a top view of a user's hand holding the adaptor fitted writing utensil, a touch screen device displaying a digital activity or screen grab of a digital activity, a digital mark made by said adaptor fitted to a writing utensil;

FIG. 123 is a back view of said RF reader showing the port for the USB-C connector;

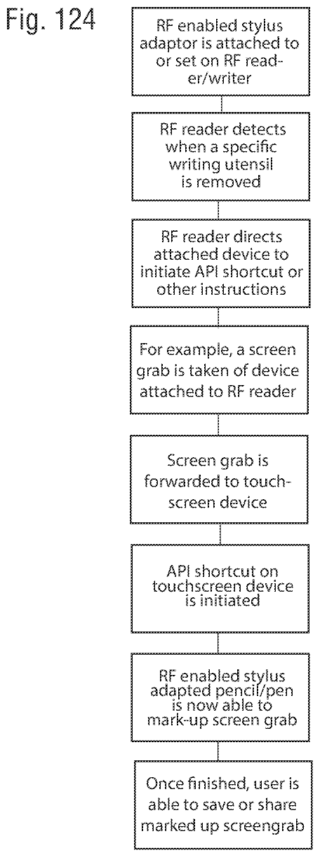

FIG. 124 is a flow chart of the process of the RF enabled adaptor communicating with the RF reader, desktop computer and touch screen device for marking-up a screen grab which was originally displayed on a device different from the touch screen device;

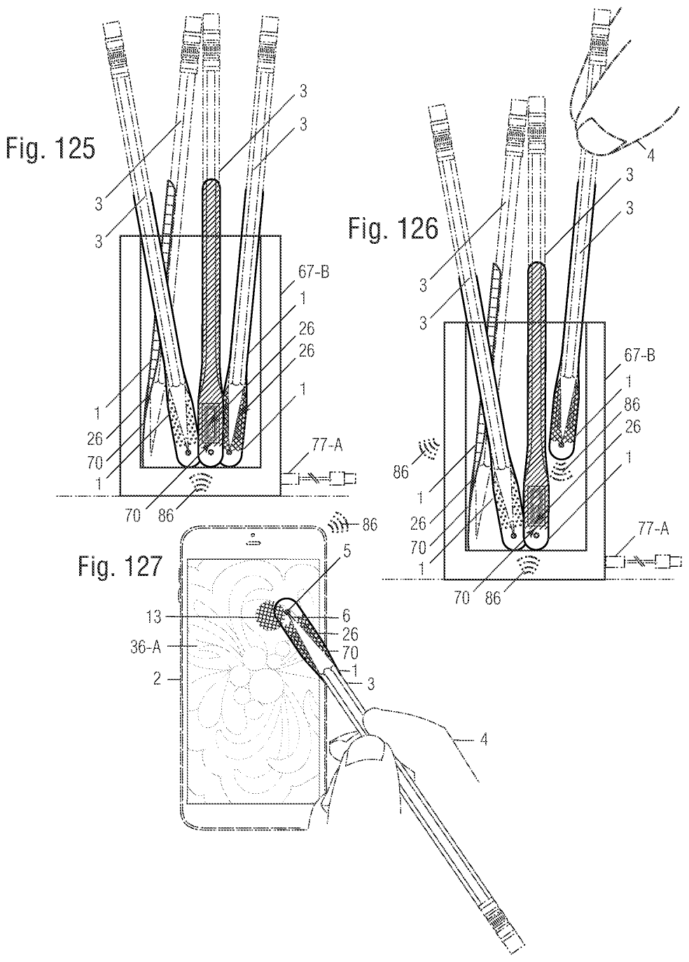

FIG. 125 shows a side view of a RF reader in the shape of a cup which holds multiple RF enabled adaptors in attached condition on writing utensils;

FIG. 126 is similar to FIG. 125 but shows a user's hand removing one of the writing utensils having a RF enabled adaptor attached;

FIG. 127 is an overhead view of a touch screen device displaying a digital activity which is being interacted with by the user held RF enabled adaptor in attached condition on a writing utensil as seen in FIGS. 125-126;

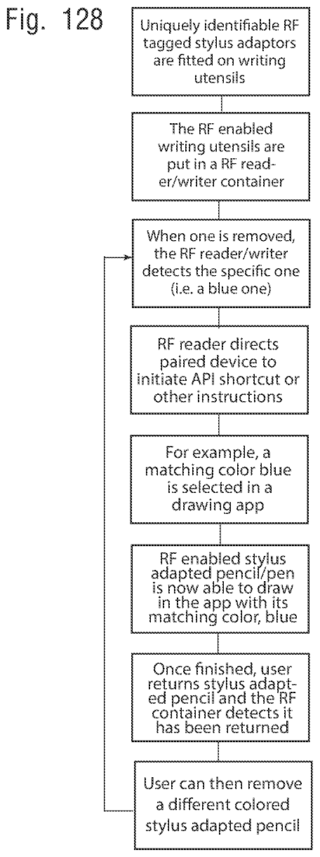

FIG. 128 is a flowchart of a touch screen device-based application or shortcut which works in tandem with a RF reader or reader and writer (i.e. as shown in FIGS. 125-127);

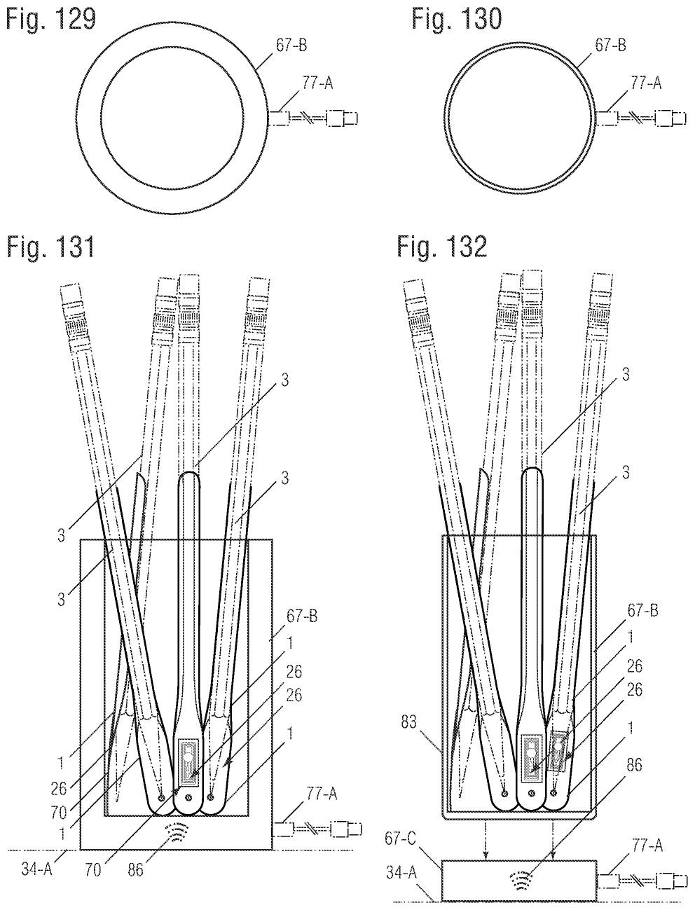

FIGS. 129-130 show top views of two different iterations of RF readers as shown in FIGS. 125-126;

FIG. 131 shows a side view of RF reader as shown in FIG. 129;

FIG. 132 shows a side view of RF reader shown in FIG. 130 and having multiple writing utensils attached with RF enabled adaptors in a removable cup or container and a base for said cup or container which also is the RF reader;

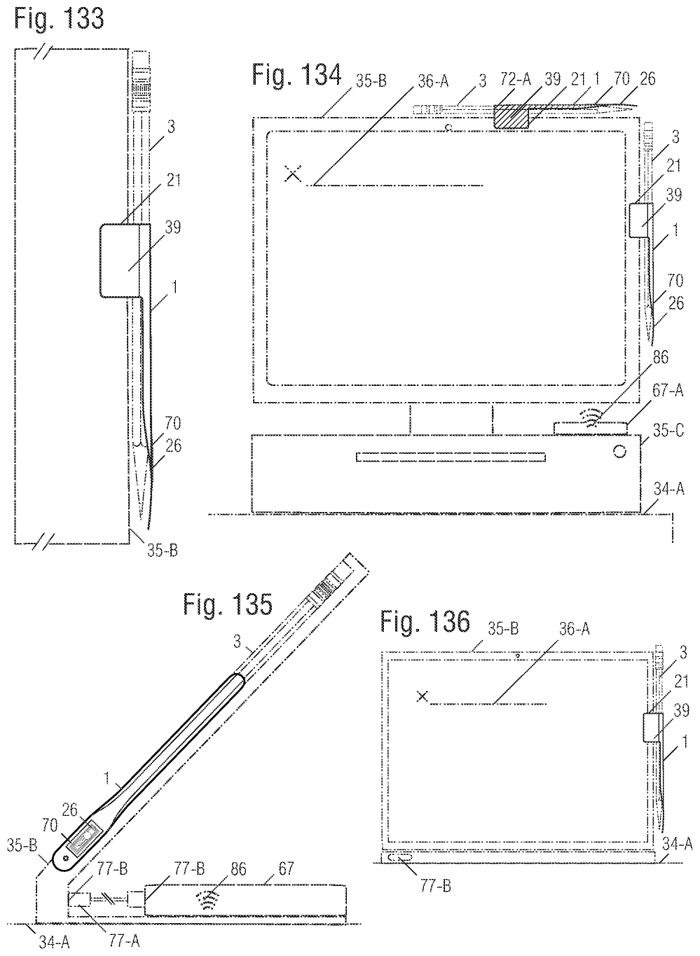

FIG. 133 shows a RF enabled adaptor in attached condition to a writing utensil and attached to a touch screen computer such as a desktop, laptop or point-of-sale device;

FIG. 134 shows a touch screen computer such as a laptop or desktop which is attached to a till and a RF reader and it also shows two writing utensils with RF enabled adaptors attached;

FIG. 135 shows a side view of FIG. 133 and an attached RF reader or reader and writer;

FIG. 136 shows a touch screen device with a USB-C port, a digital activity displayed on the touch screen and, attached to it, a RF enabled adaptor in attached condition to a writing utensil;

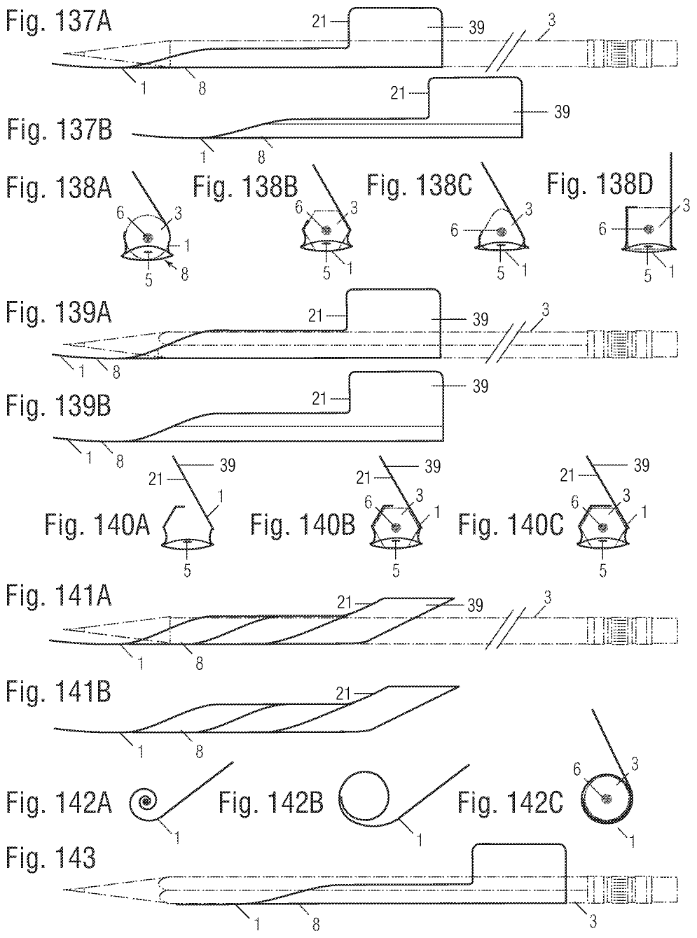

FIG. 137(a) shows a variation of the adaptor having an extension tab and in an attached condition to a writing instrument;

FIG. 137(b) shows a different variation of the adaptor having an extension tab and raised sides for adhering or clipping to a writing utensil;

FIG. 138(a) shows a front view of FIG. 137(a);

FIG. 138(b) shows a front view of FIG. 137(b);

FIGS. 138(c)-(d) show front views of different variations of the adaptor with tab extension in attached condition to a writing utensil;

FIGS. 139(a)-(b) are similar to FIGS. 137(a)-(b) but with the adaptor having sides that are raised more in attached and unattached conditions, respectively;

FIGS. 140(a)-(b) show front views of FIGS. 139(b) and 139(a), respectively;

FIG. 140(c) is similar to FIG. 140(b) but shows an extended side on top reaching toward the extension tab;

FIG. 141(a)-(b) are side views of an embodiment of the adaptor having an extension tab;

FIG. 142(a)-(c) show front views of FIGS. 141(a)-(b) in unattached and attached conditions to a writing utensil, respectively;

FIG. 143 is a side view similar to FIG. 137(a) in an attached condition to the writing instrument but slid further down said writing instrument;

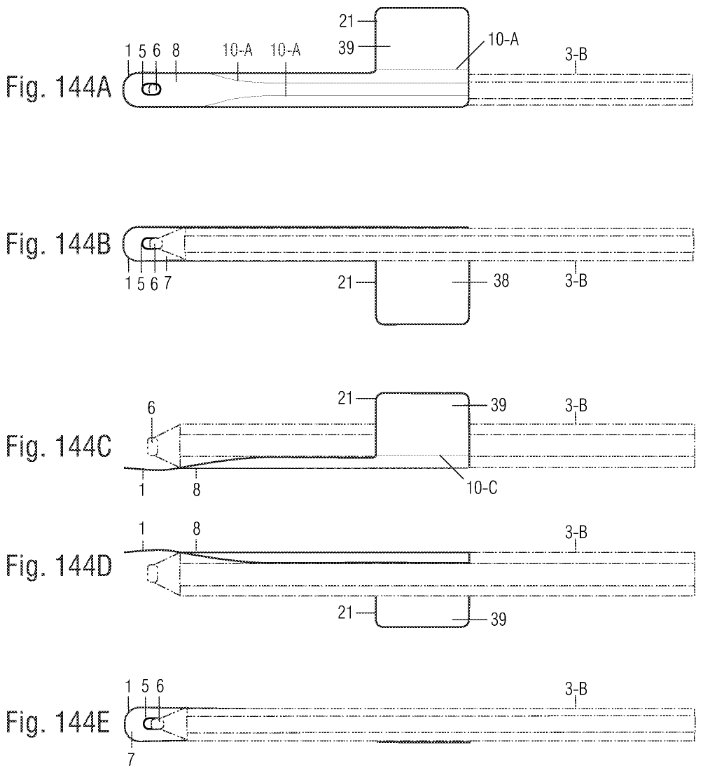

FIGS. 144(a)-(b) are bottom and top views of the adaptor with extension tab in unattached condition to a writing instrument such as the shown carpenter's pencil;

FIGS. 144(c)-(e) show side views as well as a top view of the adaptor with extension tab in attached condition to the writing utensil;

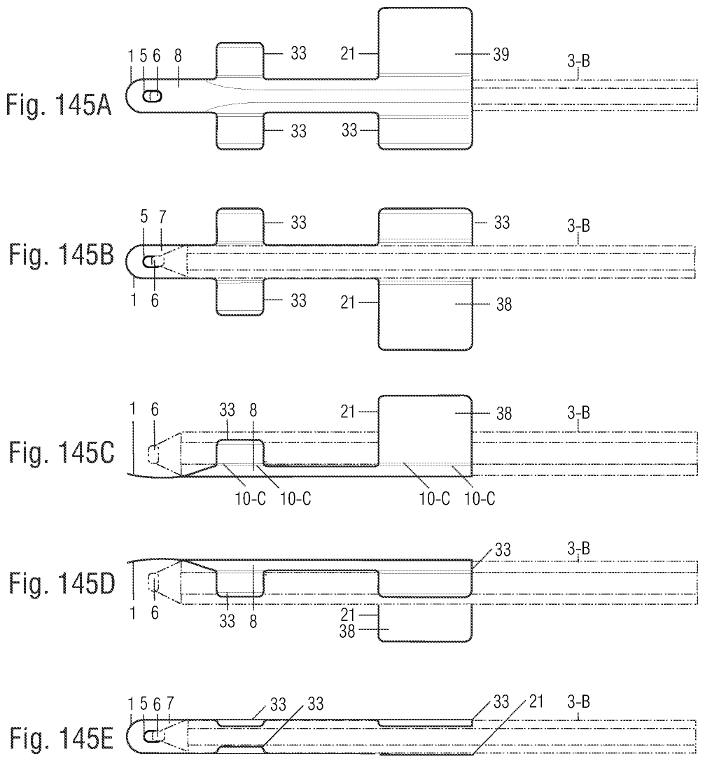

FIGS. 145(a)-(b) show bottom and top views, respectively, of an embodiment of the adaptor with extension tab and additional extensions in unattached condition to a writing utensil;

FIGS. 145(c)-(e) show side and top plan views, respectively, of FIGS. 145(a)-(b) when in an attached condition to a writing utensil;

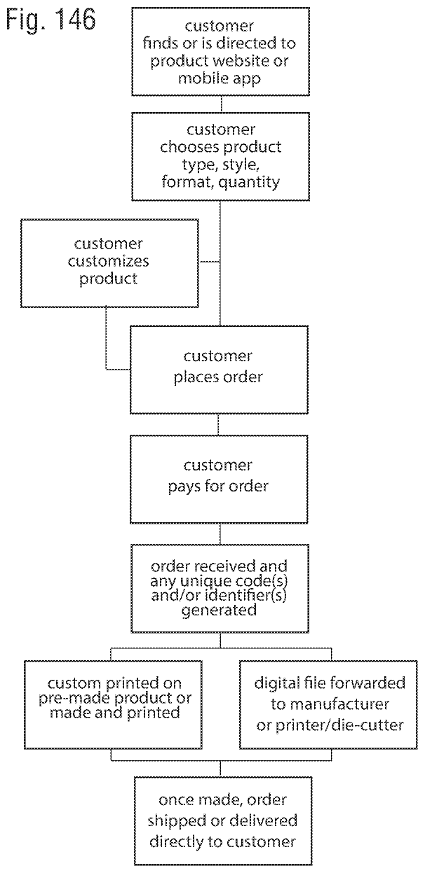

FIG. 146 is a flow chart of the ordering, customization and fulfillment processes for adaptors according to the invention;

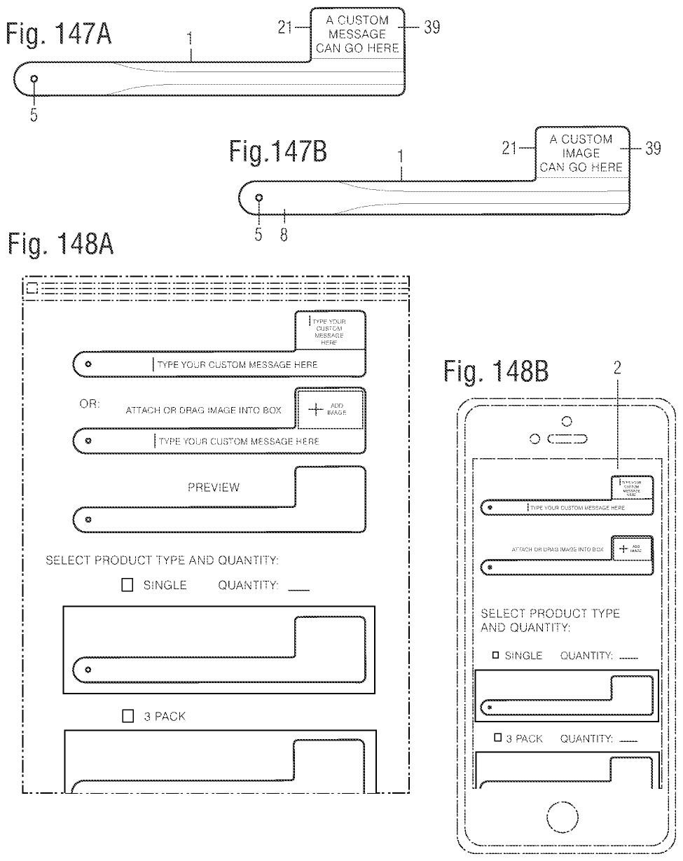

FIGS. 147(a)-(b) show plan bottom views of the adaptors according to the invention showing the extension tab having customized printed messages or images thereon, respectively;

FIG. 148(a)-(b) show representations of webpage and mobile app, respectively, for ordering custom adaptors according to the invention;

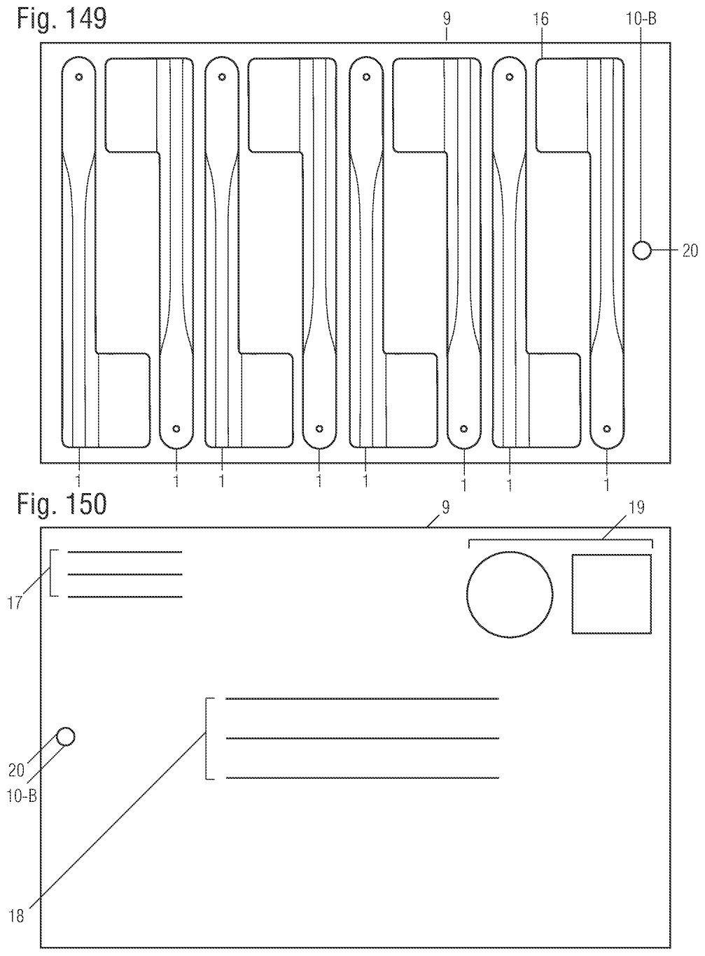

FIG. 149 shows multiple adaptors according to the invention attached to a card suitable for mailing or displaying at retail;

FIG. 150 shows the opposite side of FIG. 149 if used for mailing to customer;

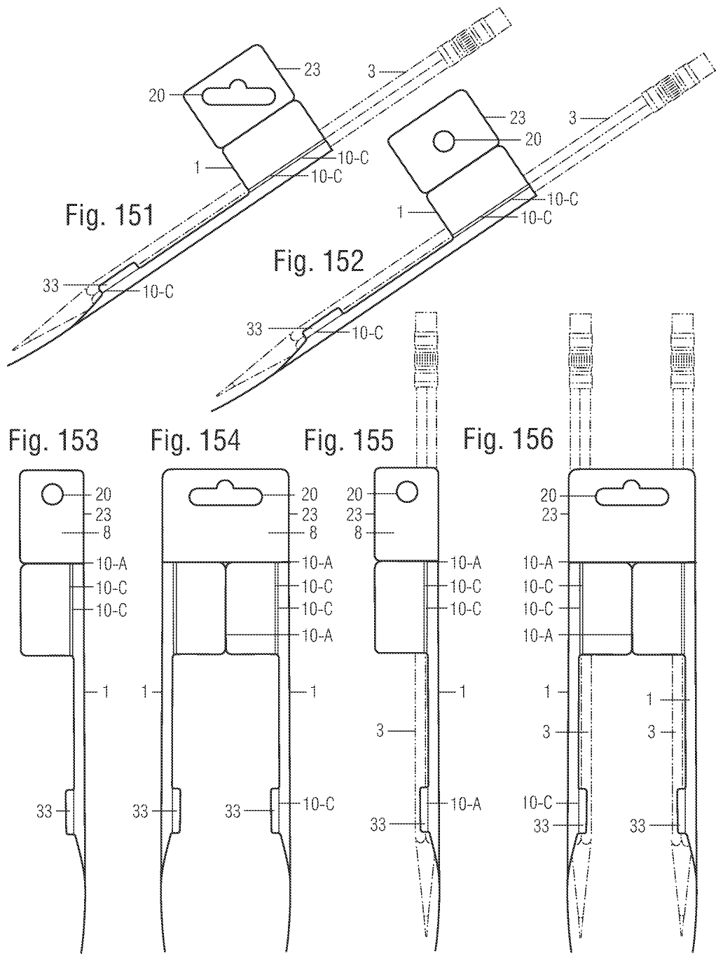

FIGS. 151-156 show variations of side views of the adaptor according to the invention and having an additional extension tab which has openings for retail display and show the adaptor or adaptors in unattached and attached conditions to a writing instrument or instruments;

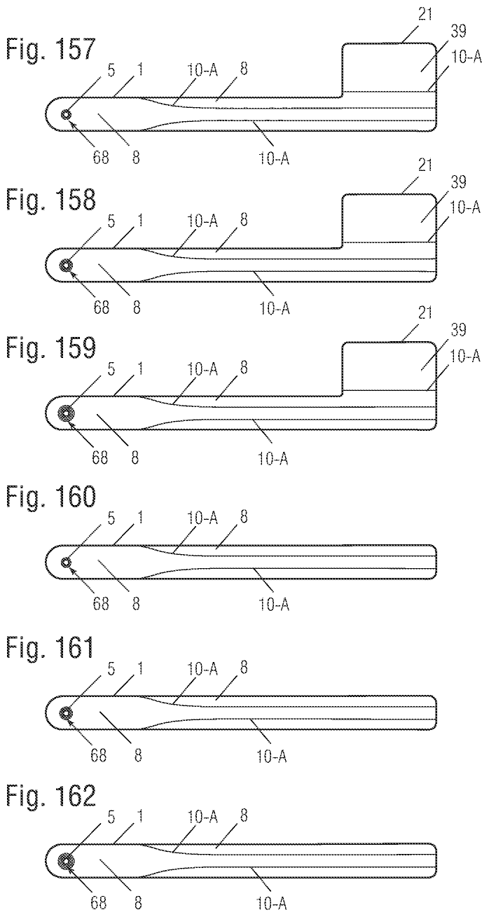

FIGS. 157-159 show bottom views of the adaptor with extension tab and variations of textured areas around the opening at end;

FIGS. 160-162 show bottom views of the adaptor without extension tab but having variations of textured areas around opening at end;

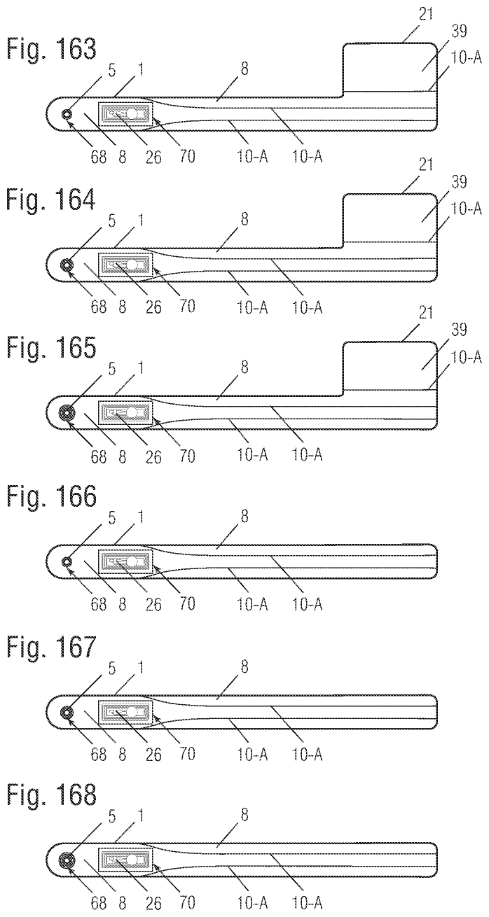

FIGS. 163-165 show similar views of FIGS. 157-159 but with the adaptor also having a NFC tag;

FIGS. 166-168 show similar views of FIGS. 160-162 but with the various adaptors also having a NFC tag;

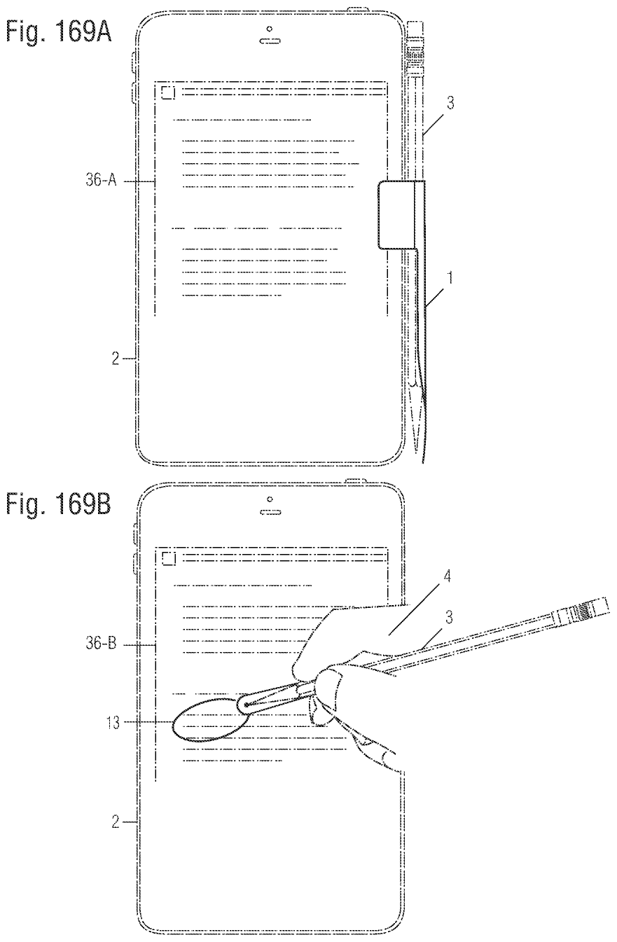

FIG. 169(a) shows an overhead view of a touch screen device displaying a digital activity and a side view of the adaptor according to the invention in an attached condition to a writing utensil and attached to said touch screen;

FIG. 169(b) shows a similar view as in FIG. 169(a) but with a user's hand holding an adaptor according to the invention and using it to make a digital mark on the digital activity displayed on said touch screen;

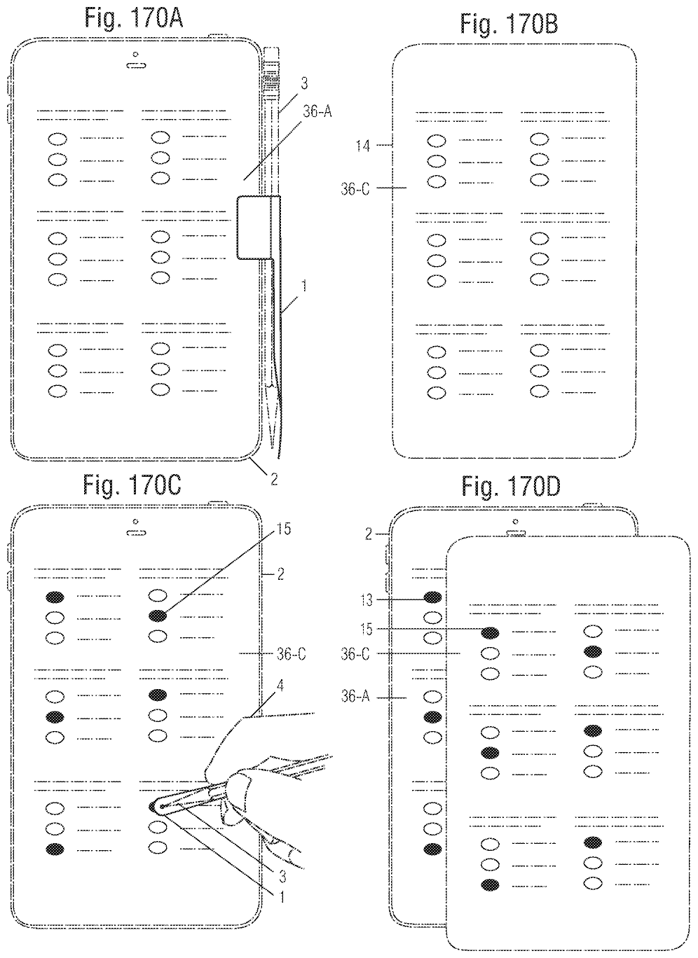

FIG. 170(a) is an overhead view of a touch screen device displaying a digital activity for use in voting or other activity which requires choosing answers from a selection of options and having an adaptor according to the invention attached to said touch screen;

FIG. 170(b) is a printed card displaying the same information as seen in FIG. 170(a) and sized to fit on top of a touch screen so as to be in alignment with the identical digitally displayed layout;

FIG. 170(c) shows the card in FIG. 170(b) in position over the touch screen device and its displayed layout as well as marks made by a writing utensil fitted with an adaptor according to invention in one variation as seen in FIG. 170(a);

FIG. 170(d) shows the marked-up card as seen in FIG. 170(c) and the touch screen display showing the digital markings in the same position as seen on said card;

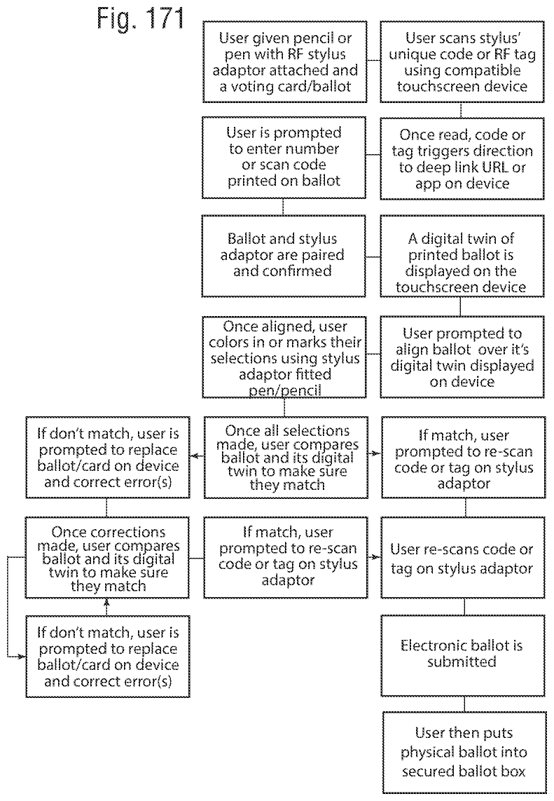

FIG. 171 is a flow chart of the voting process when using the adaptor according to the invention;

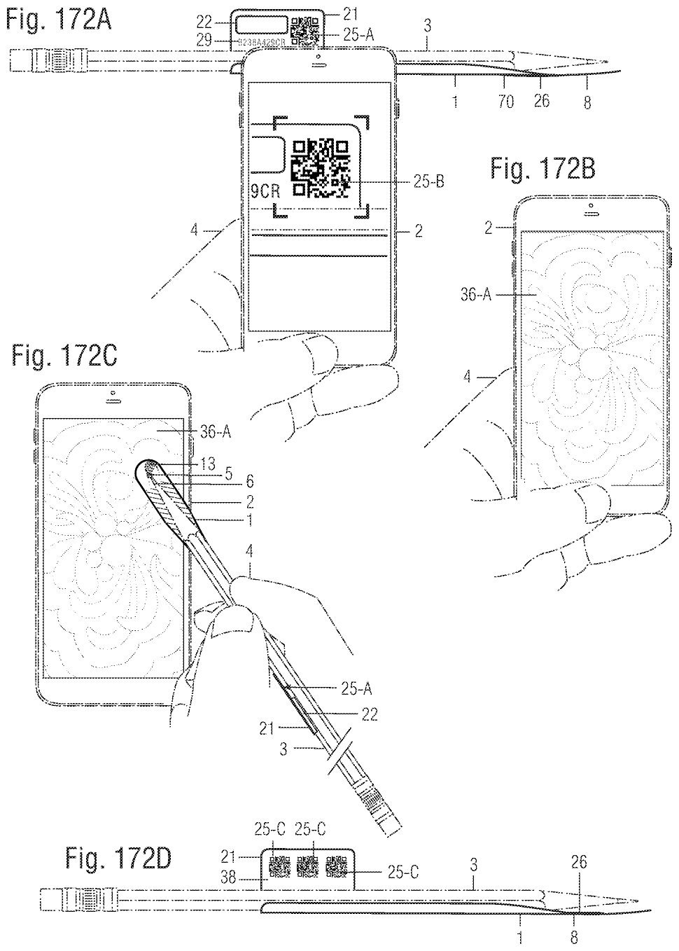

FIGS. 172(a)-(c) is a sequence of overhead views showing a user scanning a code on the adaptor according to the invention using the camera of the touch screen device with said device being directed to a digital activity for use with said adaptor;

FIG. 172(d) shows an alternative adaptor in attached condition to a writing utensil with the extension tab having multiple micro QR codes;

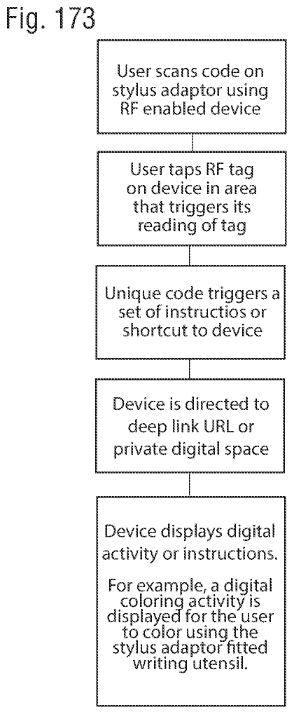

FIG. 173 is a flow chart of the process of scanning a printed code on the adaptor according to the invention and the activation of a digital activity on the touch screen device used to scan said code;

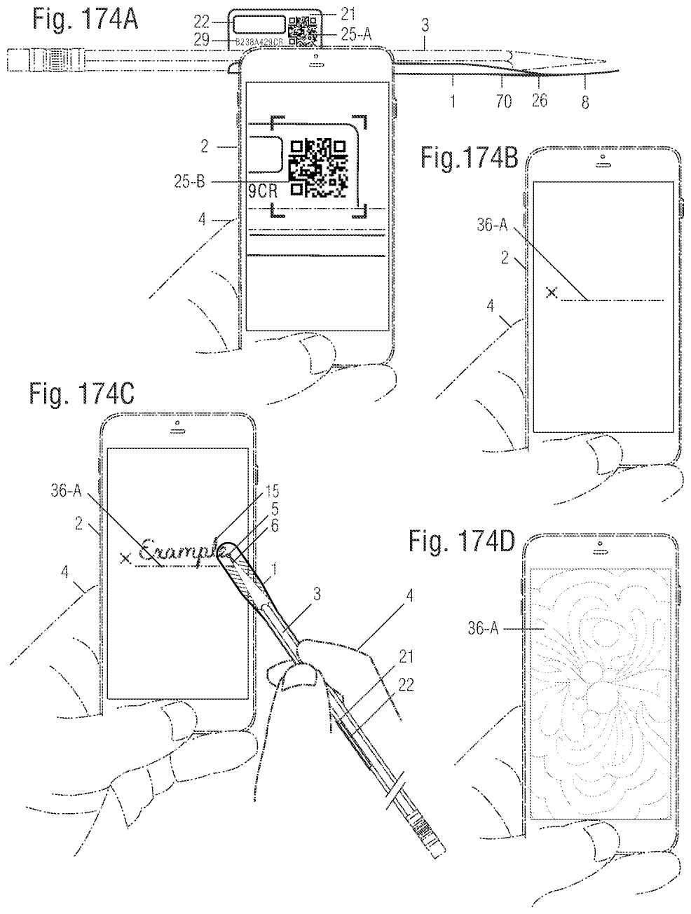

FIG. 174(a)-(d) shows similar views as in FIGS. 172(a)-(c) but with an additional digital activity being a login screen that requires a signature before user is given access to main digital activity;

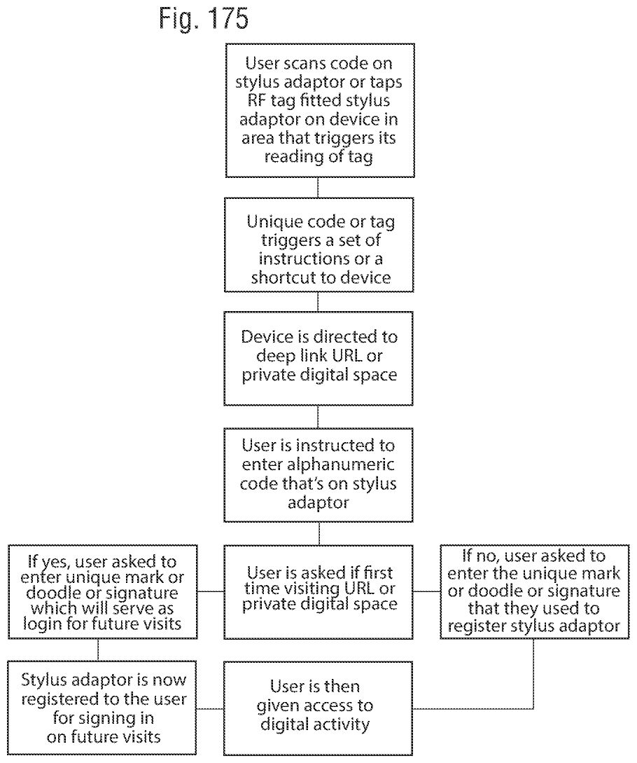

FIG. 175 is a flow chart of the process of using an adaptor according to the invention for use in first registering a signature for access to a digital activity and then using said signature upon future visits to gain access again to said digital activity;

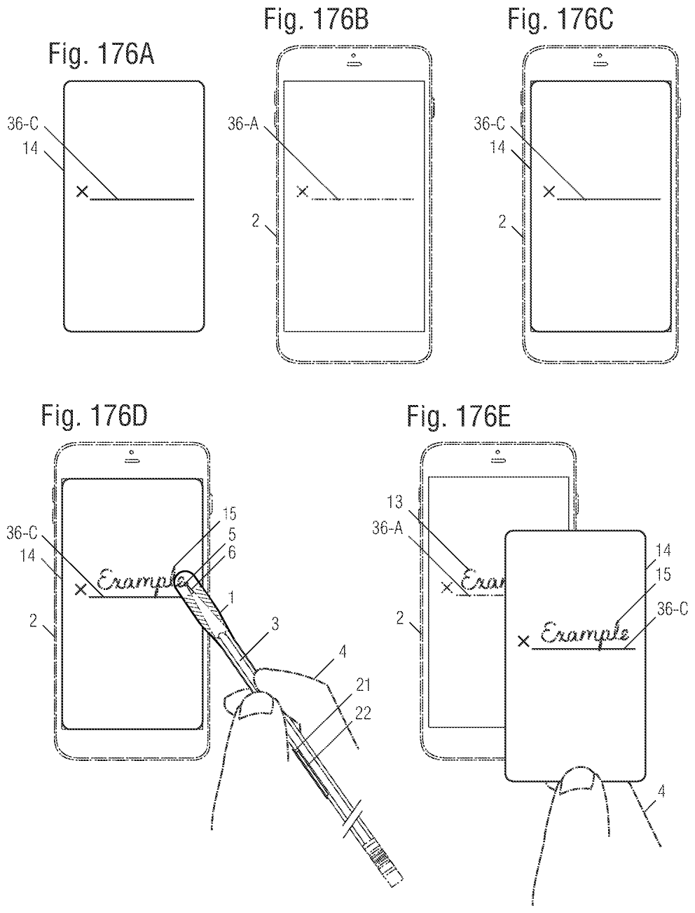

FIGS. 176(a)-(e) show a set of overhead views similar to FIGS. 170(a)-(d) but with the printed activity card having a dedicated area for a signature or other unique hand-drawn or hand-written identifier (i.e., a signature) which said card and its printed information align with identical information on a similarly sized touch screen device so when user uses an adaptor according to invention in an attached condition to a writing utensil, will leave marks on both the card and the digital activity displayed on the touch screen device;

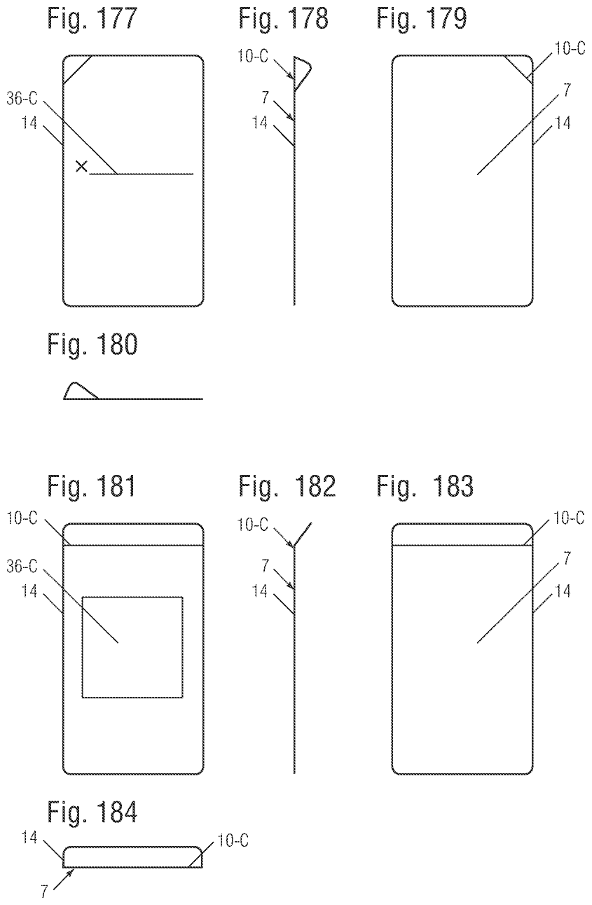

FIGS. 177-184 show top, side and front views of variations of the card shown in FIGS. 176(a)-(e) but having a bent edge as well as another variation of the printed information indicating a space for a unique identifier to be drawn by the user when laid on top of a similarly size touch screen device;

FIG. 185 is a top view of an adaptor in attached condition to a writing instrument and having a semi-circular cut through all layers of materials making up said stylus and near the opening at its end;

FIG. 186 shows the end of said adaptor seen in FIG. 185 when it is pressed against the surface of a touch screen device;

FIG. 187 shows the side view of FIG. 186;

FIG. 188 shows the opposite side view to FIG. 186;

FIG. 189 shows a front view of adaptor shown in FIG. 185;

FIG. 190 shows a transparent front view of adaptor shown in FIG. 190 so as to see the position of an attached writing utensil;

FIG. 191 is a similar view to FIG. 190 but with opaque material blocking the view of the attached writing utensil and having an extension tab;

FIG. 192 shows a side view of the adaptor and writing utensil seen in FIG. 191;

FIG. 193 is similar to FIG. 192 but with an extended strip past the extension tab;

FIG. 194 is a bottom plan view of the adaptor in unattached condition to a writing utensil;

FIG. 195 is a bottom plan view of the adaptor shown in FIG. 192 but in unattached condition;

FIG. 196 is a bottom plan view of the adaptor shown in FIG. 193 but in unattached condition;

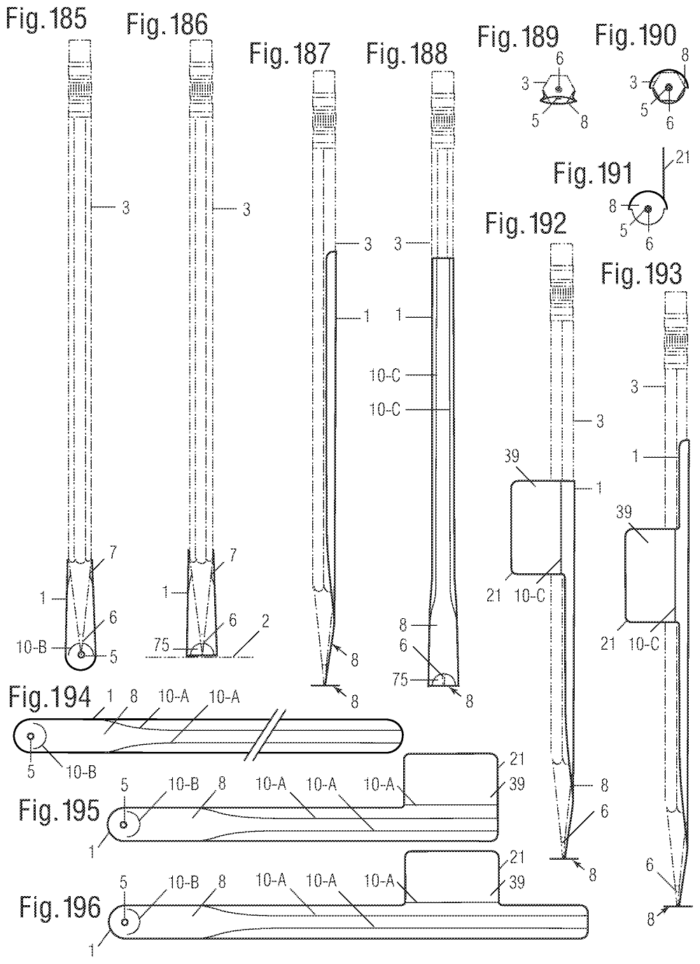

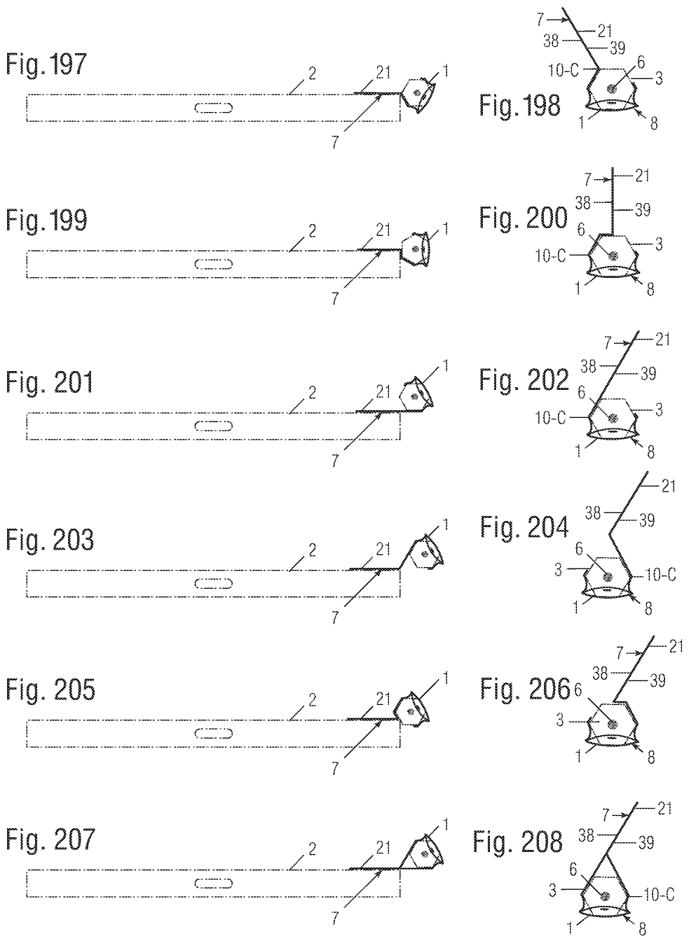

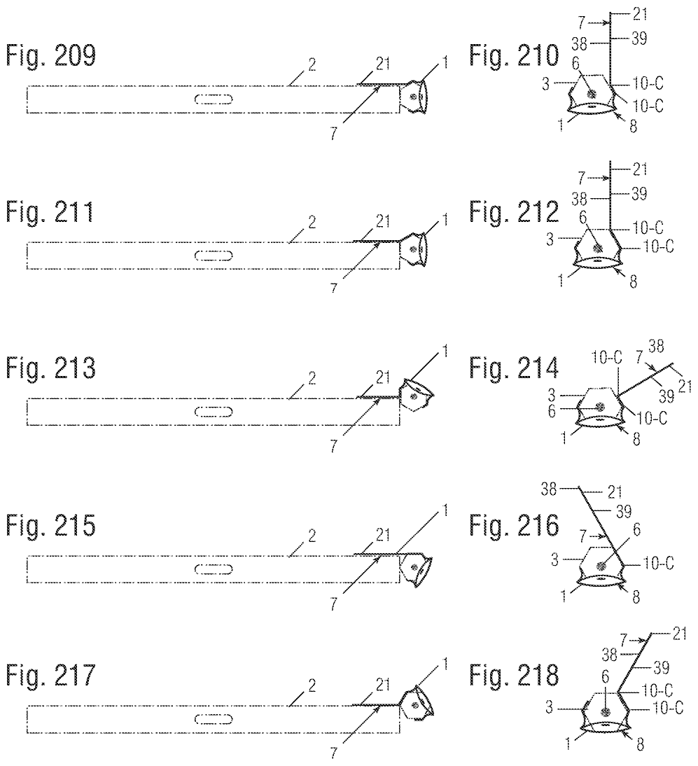

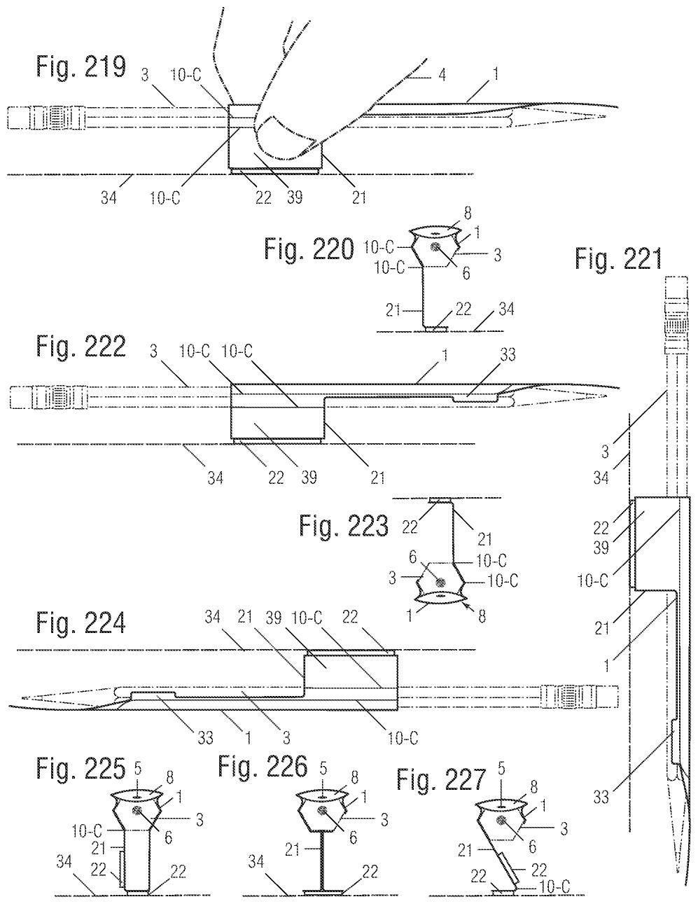

FIGS. 197-208 show various enlarged front views of different embodiments of adaptors according to invention in attached condition to a writing utensil as well as in attached condition to a touch screen device;

FIGS. 209-218 show more variations of adaptors according to the invention as shown in FIGS. 197-208;

FIG. 219 shows a side view of one embodiment of the adaptor according to the invention with a user's hand grabbing the extension tab area of said adaptor, an adhesive, micro-suction or nano tape pad and a flat work surface;

FIG. 220-222 show side and front views, respectively, of an adaptor having a tab extension with a bend at the end on which an adhesive, micro-suction or nano tape pad is attached with said bend and pad enabling the adaptor in attached condition to a writing utensil to raise the combined adaptor and utensil above a work surface or similar flat surface;

FIGS. 223-224 are similar to FIG. 220 and FIG. 222 but suspended under a work surface;

FIGS. 225-227 show other examples of adaptors according to invention having extension tabs of varying shapes and combinations of adhesive, micro-suction or nano tape pads as well as a work surface to which said pad attaches;

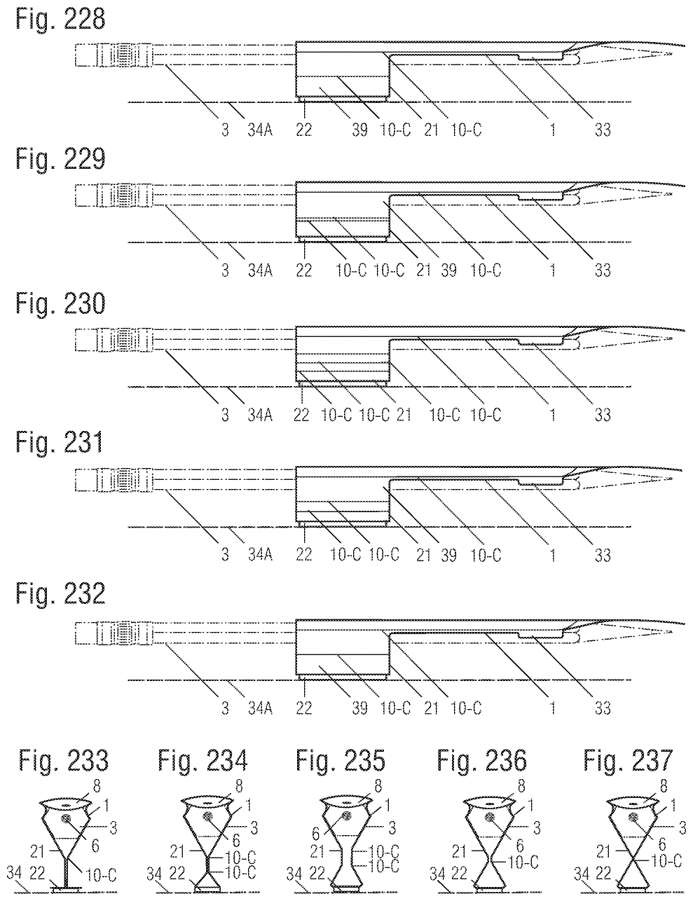

FIGS. 228-232 show side views of varying adaptors having extension tabs and in attached condition to a writing instrument as well as adhesive, micro-suction or nano tape pad and a work surface;

FIGS. 233-237 are front views of FIGS. 228-232, respectively;

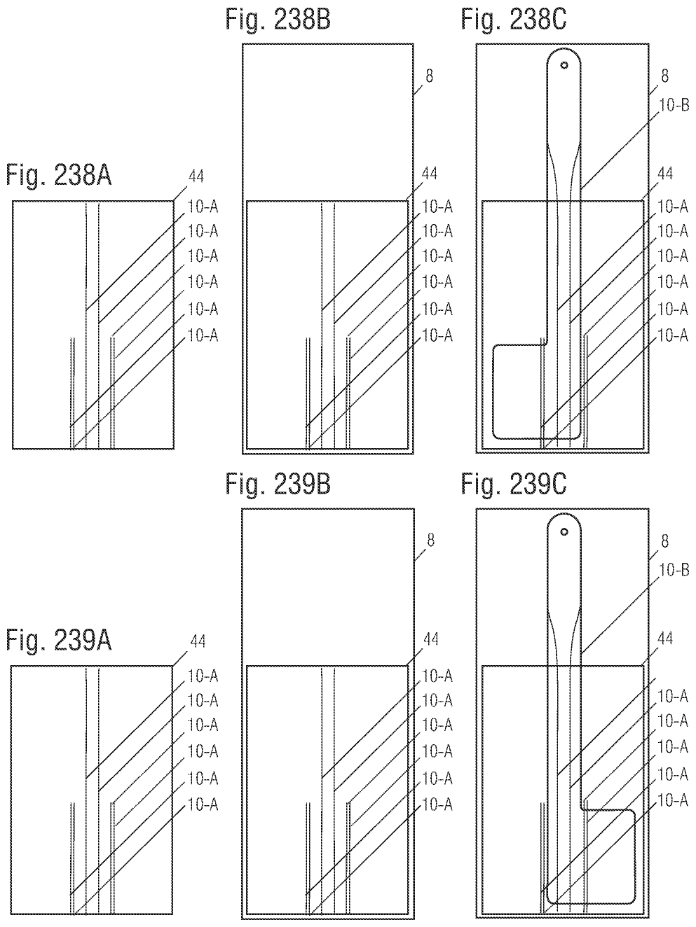

FIG. 238(a)-(c) show a sequence of material layers being laminated together and then die-cut, laser-cut or kiss-cut as examples of possible manufacturing of the adaptor according to the invention;

FIGS. 239(a)-(c) show similar sequence as shown in FIGS. 238(a)-(c) but with the kiss-cuts, die-cuts or laser-cuts in a different final orientation;

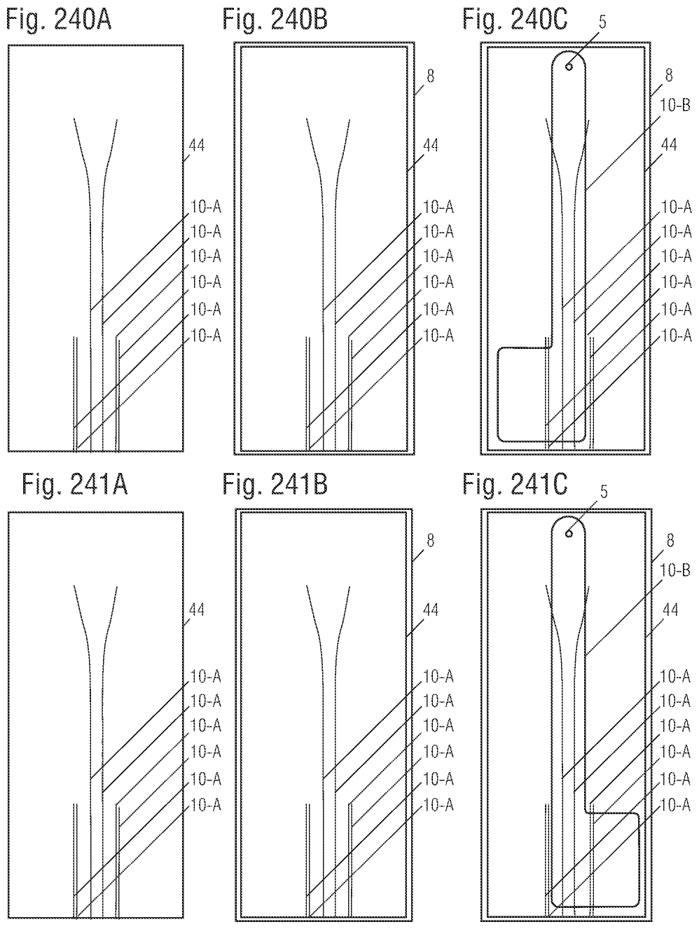

FIGS. 240(a)-(c) show alternative variations as shown in FIGS. 238(a)-(c);

FIGS. 241(a)-(c) show alternative variations as shown in FIGS. 239(a)-(c);

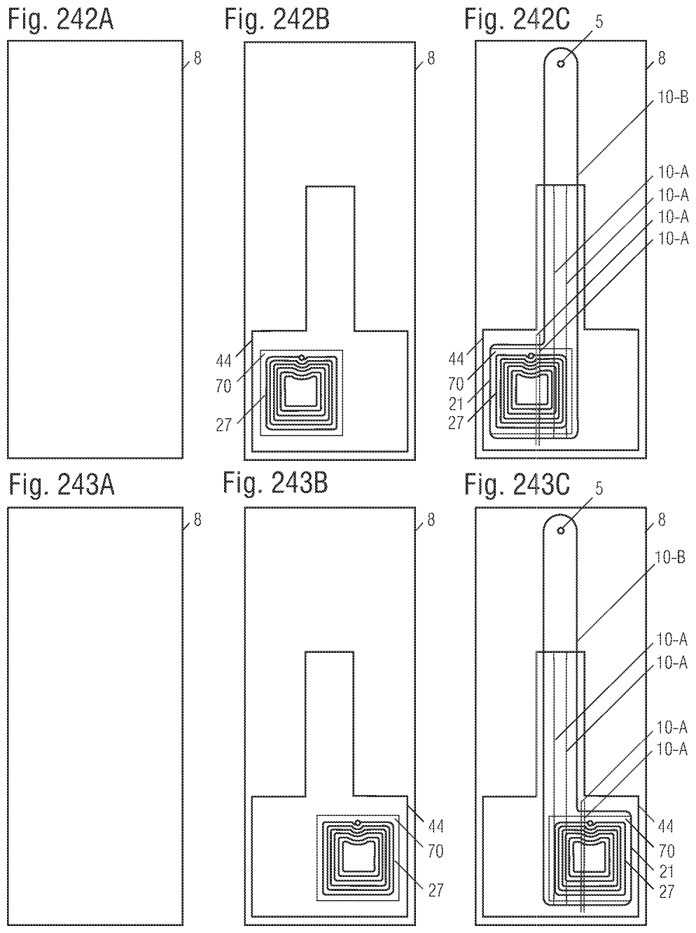

FIGS. 242(a)-(c) show top views of material layers in sequence for combining to form a laminated unit to be die-cut, laser-cut or kiss-cut as well as the attachment of a RF antenna, tag, module or microchip and ferrite layer in between said RF antenna, tag, module or microchip;

FIGS. 243(a)-(c) show another sequence of top views of material layers and attachments as shown in FIGS. 242(a)-(c);

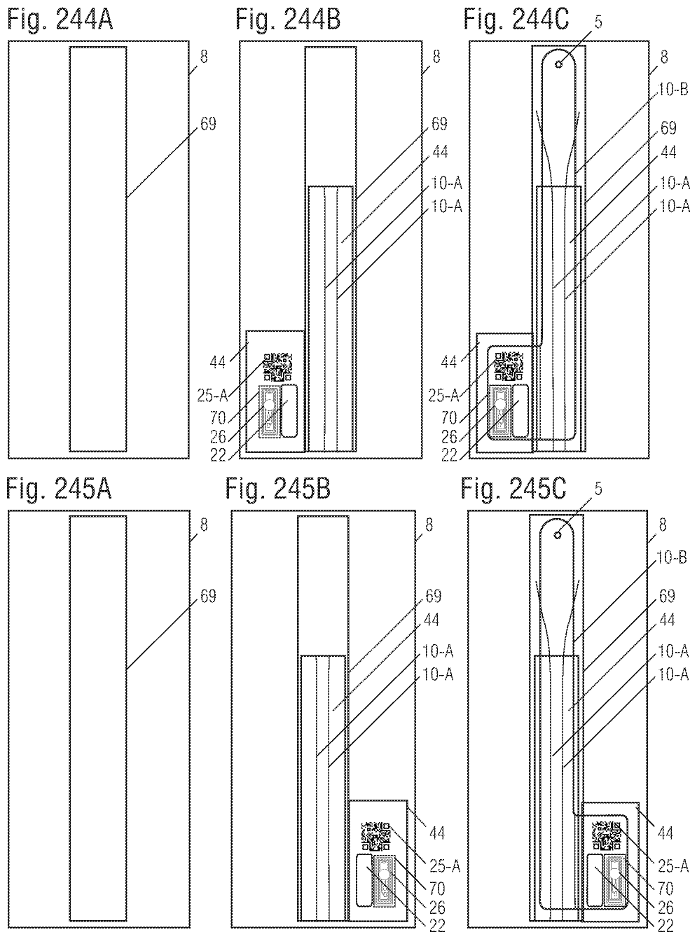

FIGS. 244(a)-(c) show another sequence of top views of material layers and attachments as shown in FIGS. 242(a)-(c) as one means of manufacturing an adaptor according to the invention and having a scannable code, RF antenna, tag, module or microchip as well as an adhesive, micro-suction or nano tape pad;

FIGS. 245(a)-(c) show more examples similar to those shown in FIGS. 244(a)-(c);

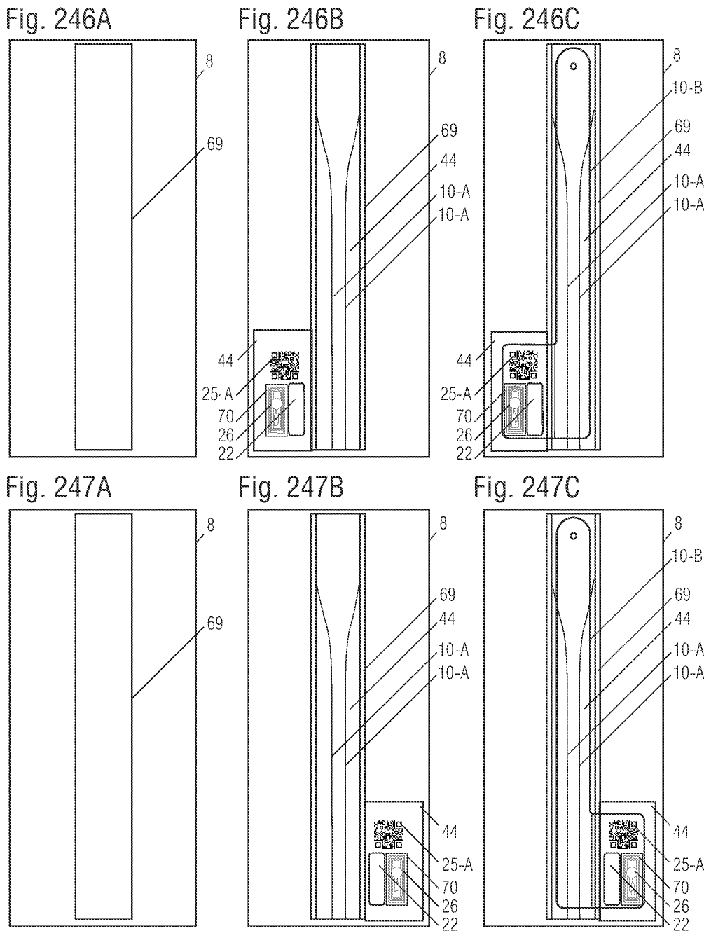

FIGS. 246(a)-(c) show more examples similar to those shown in FIGS. 244(a)-(c) but with the addition of a conductive strip added to the first substrate;

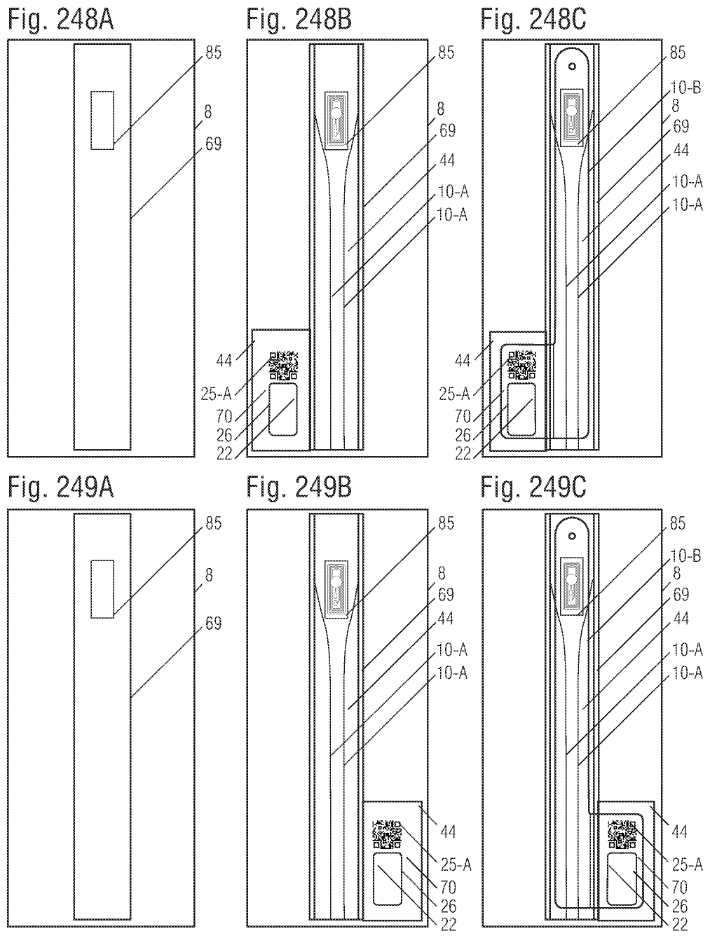

FIGS. 247(a)-(c) show more examples similar to those shown in FIGS. 245(a)-(c); FIGS. 248(a)-(c) show more examples similar to those shown in FIGS. 246(a)-(b) but with an area void of the material of the conductive strip;

FIGS. 249(a)-(c) show another sequence similar to FIGS. 248(a)-(c) but having a different orientation;

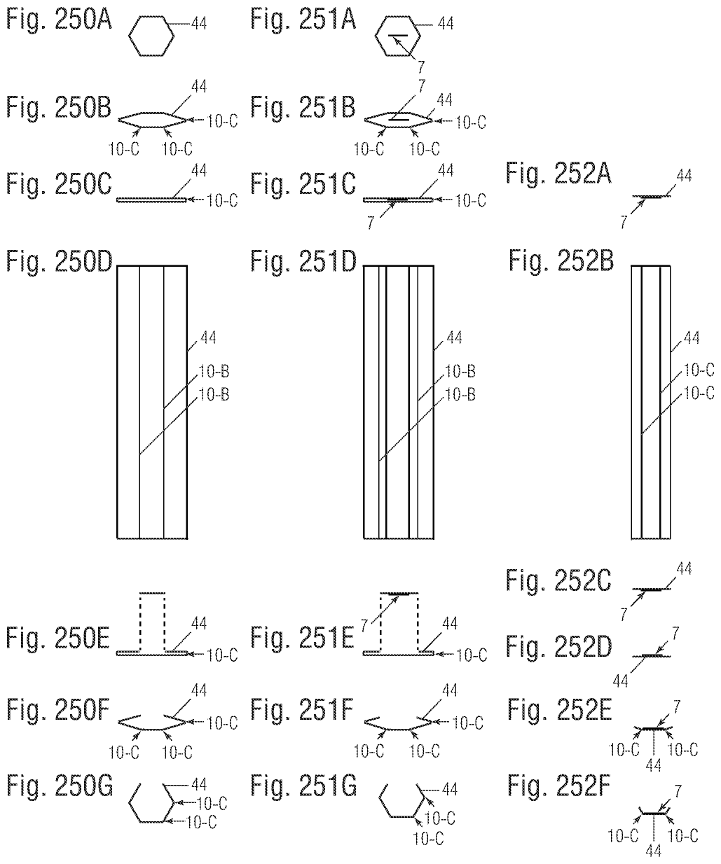

FIG. 250(a) a front view of hexagonal tube stock;

FIG. 250(b) is a front view of the hexagonal tube stock shown in FIG. 250(a) but in a partially compressed state;

FIG. 250(c) is a front view of the hexagonal tube stock shown in FIG. 250(a) but in a fully compressed condition;

FIG. 250(d) is a top view of the compressed tube stock shown in FIG. 250(c);

FIG. 250(e) is a front view of the compressed stock as shown in FIG. 250(c) with a section along its top side removed;

FIGS. 250(f)-(g) show semi-compressed and fully-compressed front views, respectively, as seen in FIGS. 250(b)-(c) but with a strip along the top side removed;

FIGS. 251(a)-(g) show similar views as 250(a)-(g) and having an adhesive strip running through the center of the hexagonal tubing which adheres to the underside of the strip along the top side that is removed;

FIGS. 252(a)-(b) show front and top views of the strip of the hexagonal tube with adhesive attached that was removed as shown in FIG. 251(e)s;

FIG. 252(c) shows the same front view as seen in FIG. 252(a); FIG. 252(d) shows the same front view as seen in FIG. 252(c) but rotated so attached adhesive strip is on top;

FIG. 252(e) shows the same front view as seen in FIG. 252(d) but with the uncovered areas of the strip cut from the hexagonal tube less compressed and no longer flat;

FIG. 252(f) shows the same view as in FIG. 252(e) but with the sides no longer compressed but in their original bent angles as when still part of the hexagonal tubing;

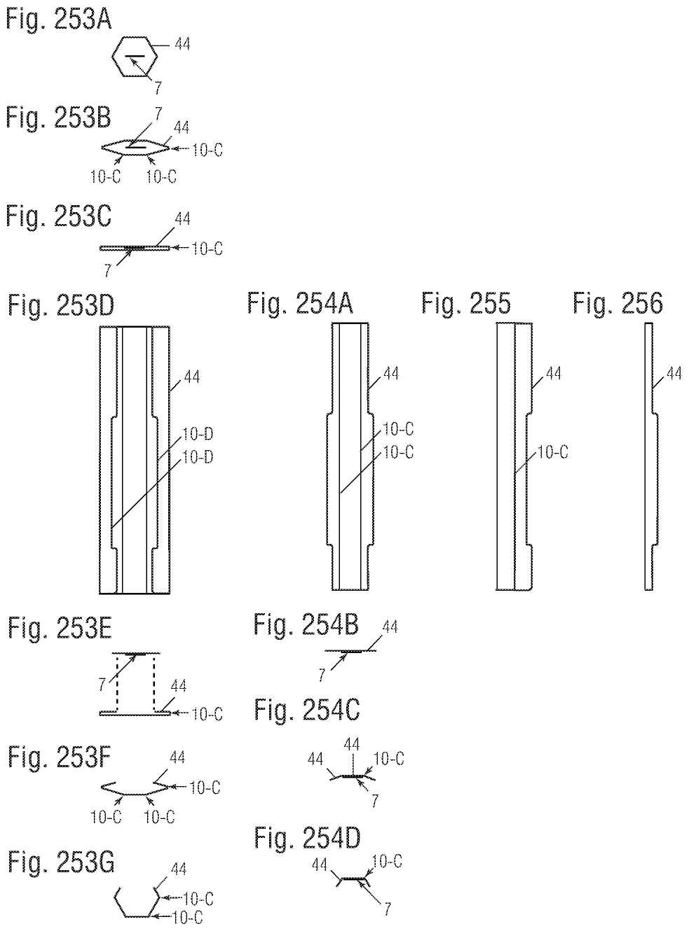

FIGS. 253(a)-(g) show similar views as in FIGS. 251(a)-(g) but with a different shaped strip cut front the length of the top part of the hexagonal tubing;

FIG. 254(a) shows the top piece cut from the hexagonal tubing removed;

FIG. 254(b) shows a front edge view of FIG. 254(a);

FIGS. 254(c)-(d) show the same top piece which was removed in conditions less compressed and fully returned to the original bends of the hexagonal tubing, respectively;

FIGS. 255-256 show side views of the two separate pieces made from the cut of the hexagonal tube as seen in FIG. 253(d);

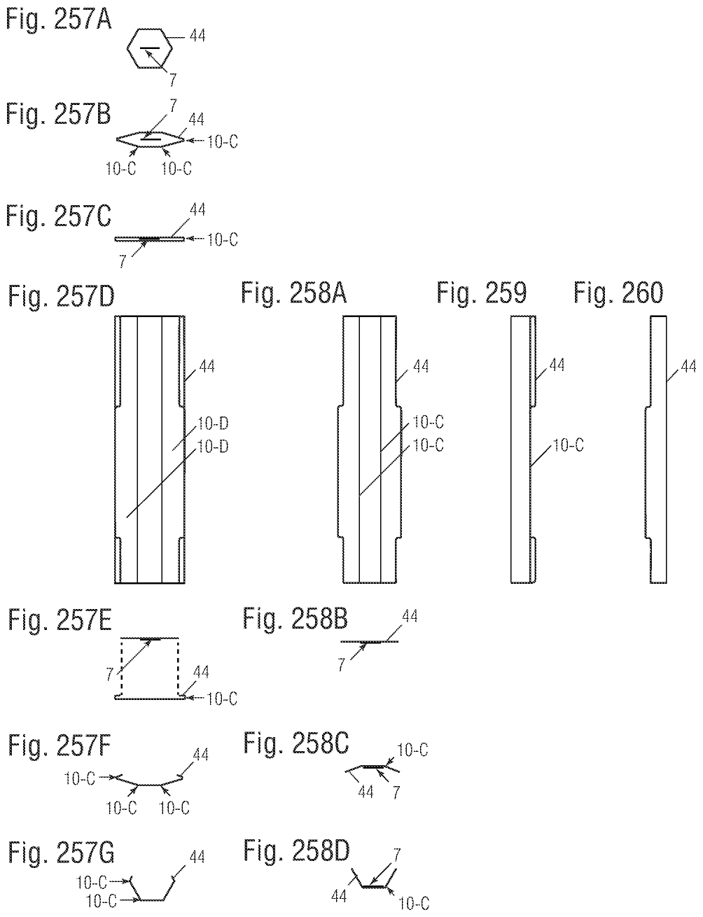

FIGS. 257(a)-260 show similar views as seen in FIGS. 253(a)-256 but having different shapes;

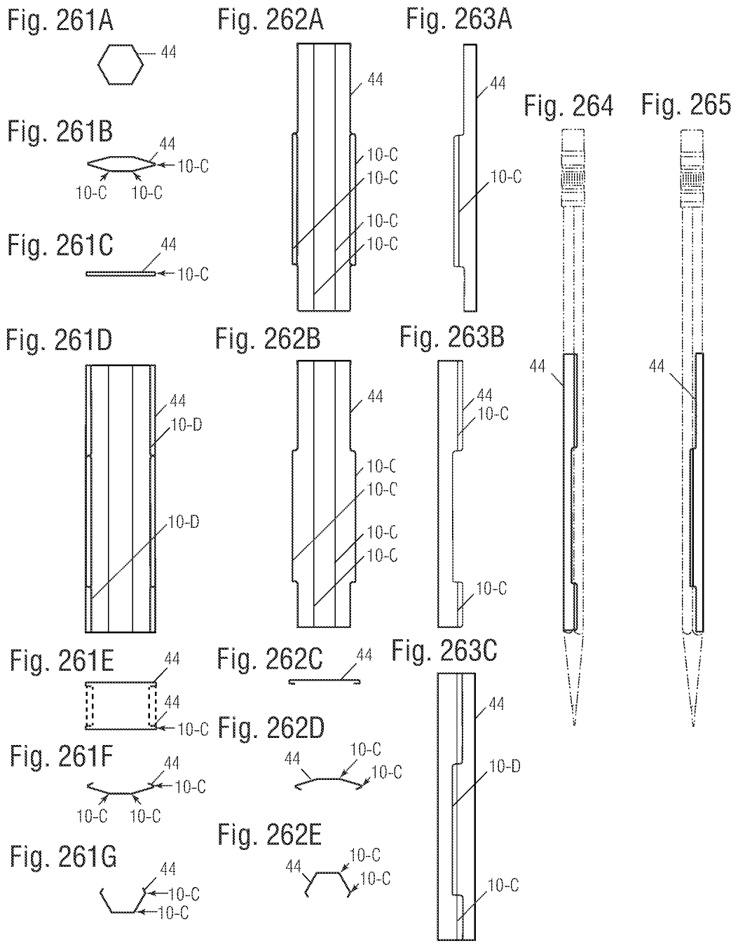

FIGS. 261(a)-265 show similar views as seen in FIGS. 257(a)-260 but having different shapes as well as in attached condition to a writing instrument;

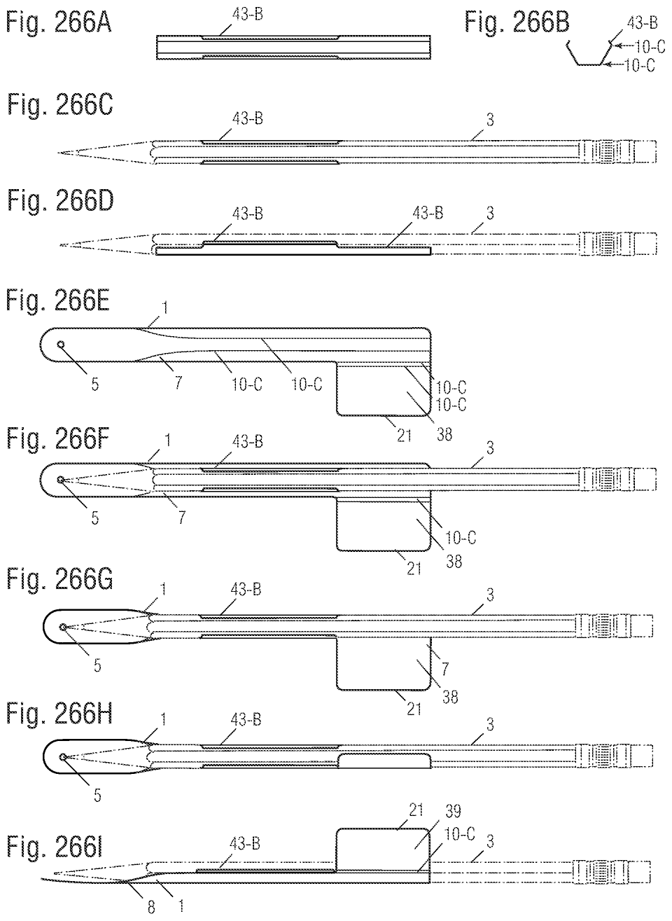

FIG. 266(a) shows a side view as seen in FIG. 265 of the top piece of the cut hexagonal tube in attached condition to a writing instrument;

FIG. 266(b) shows an overhead view of the top piece of the cut hexagonal tubing in compressed condition as seen in the front view shown in FIG.;

FIG. 266(c) shows a top plan view of the adaptor according to the invention having the extension tab;

FIG. 266(d) shows the removed piece from the hexagonal tubing as seen in FIGS. 266(a)-(b) placed on top of the adaptor as seen in FIG. 266(c);

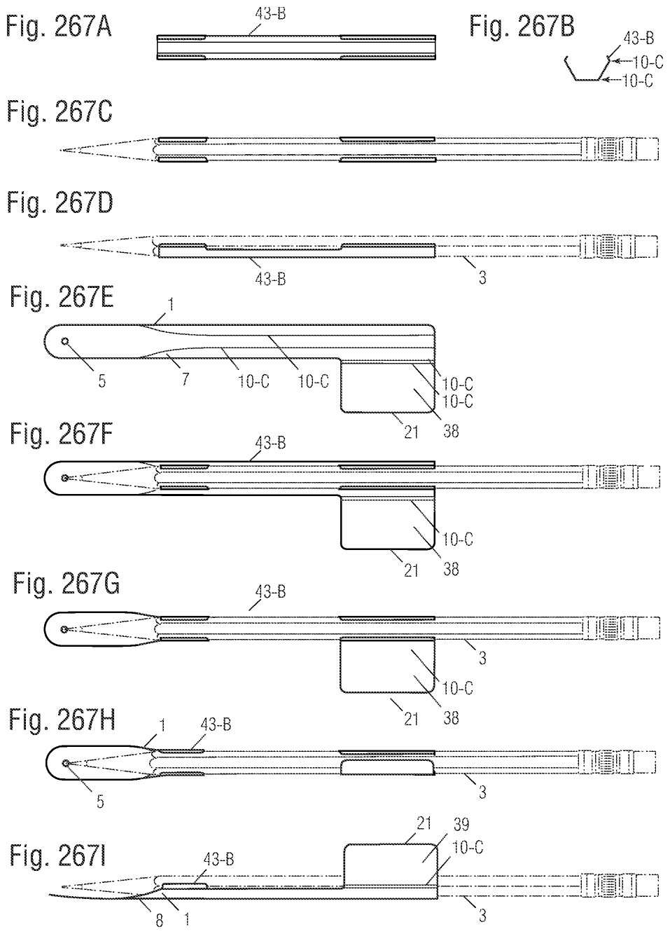

FIGS. 267(a)-(i) is similar to FIGS. 266(a)-(i) but with the other piece made from the cuts to the hexagonal tubing;

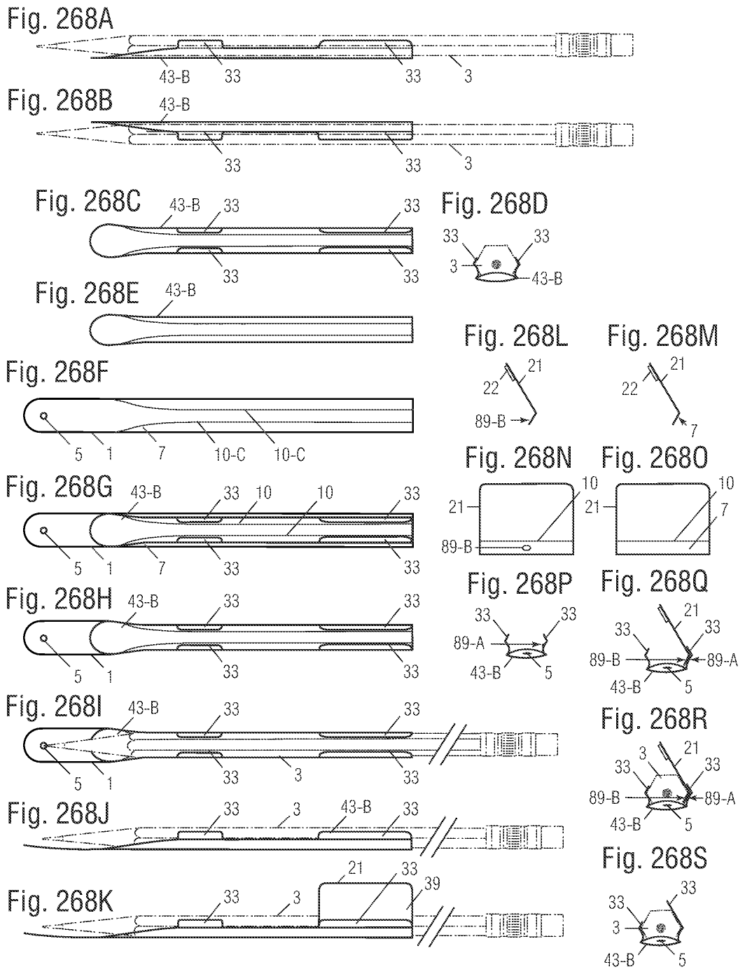

FIGS. 268(a)-(b) show side views and top, front and bottom views, respectively, of an adaptor in attached position to a writing utensil;

FIG. 268(f) shows an adaptor in unattached condition from a top view;

FIGS. 268(g)-(h) shows a top view of the adaptor as shown in FIGS. 268(a)-(e) but in semi-attached and fully attached condition, respectively, to the adaptor shown in FIG. 268(f);

FIGS. 268(i)-(j) show top and side views, respectively, of the adaptors in attached condition to each other as well as the adaptor shown in FIG. 268(c) in attached condition to the writing utensil;

FIG. 268(k) shows a side view similar to FIG. 268(j) but has an extension tab attachment as shown in FIGS. 268(l)-(n);

FIG. 268(l) shows an edge view of the extension tab attachment as seen in FIG. 268(k) and FIGS. 268(m)-(o) and shows the position of the open area to receive a raised area on the adaptor as seen in FIG. 268(p);

FIG. 268(m) is the same view as FIG. 268(l) but illustrates an area having an adhesive, micro-suction or nano tape pad or strip;

FIG. 268(n) shows a side view of one embodiment of an extension tab as seen in FIG. 268(k)-(m) and having an opening to receive a raised area on the adaptor as shown in FIG. 268(p)-(r);

FIG. 268(o) shows a side view of FIG. 268(m) and a view similar to FIG. 268(n) but without a raised area but rather an area having an adhesive, micro-suction or nano tape pad or strip;

FIG. 268(p) shows a front view of the attachments shown in FIG. 268(j) but having a raised area for mating with the opening in the extension tab shown in FIG. 268(n) when positioned between the adaptor and the writing utensil;

FIG. 268(q) shows a front view of the attachments shown in FIG. 268(j) and FIG. 268(p) as well as the extension tab shown in FIG. 268(l) in attached condition;

FIG. 268(r) is the same view as shown in FIG. 268(q) but in attached condition to a writing utensil;

FIG. 268(s) shows a front view of the attachment shown in FIGS. 268(a)-(e) but with one of the clips extended higher past the height of the top plane of the writing utensil so as to aid in its removal;

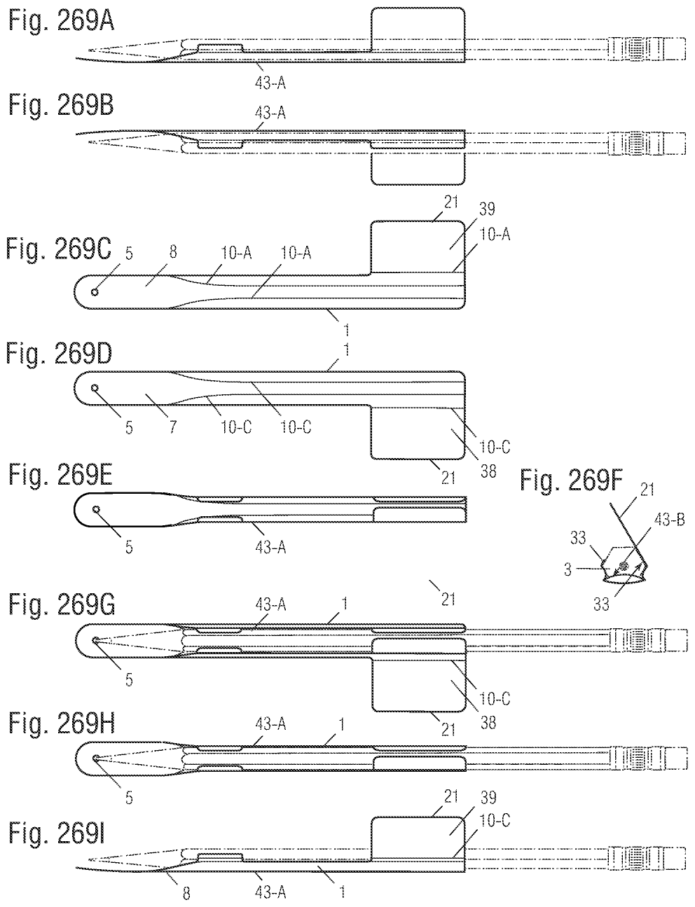

FIGS. 269(a)-(i) show similar views as illustrated in FIGS. 268(a)-(i) but having different adaptors connecting to each other and with the adaptor which is shown in FIGS. 269(a)-(b) in attached condition to the writing utensil;

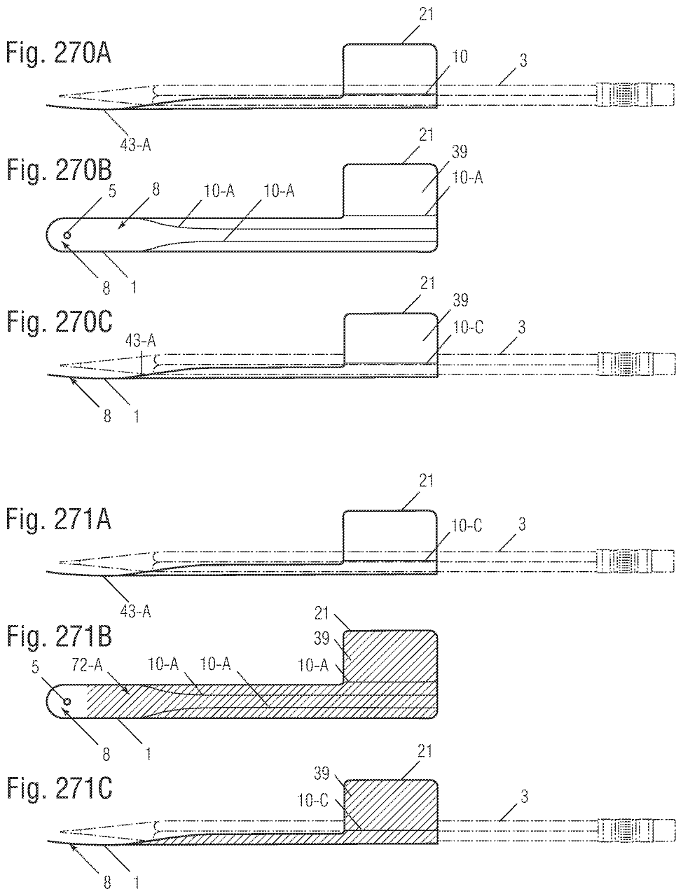

FIG. 270(a) show a transparent adaptor in attached condition to a writing instrument;

FIG. 270(b) shows a transparent adaptor in unattached condition to a writing instrument;

FIG. 270(c) shows the two adaptors as seen in FIG. 270(a) and FIG. 270(b), respectively, in an attached condition to a writing utensil;

FIG. 271(a) is the same as FIG. 270(a);

FIG. 271(b) is similar to the adaptor in FIG. 270(b) but is only transparent near the end that has the opening and opaque elsewhere;

FIG. 271(c) is a side view of the adaptors in FIGS. 271(a)-(b) combined and in attached condition to a writing utensil;

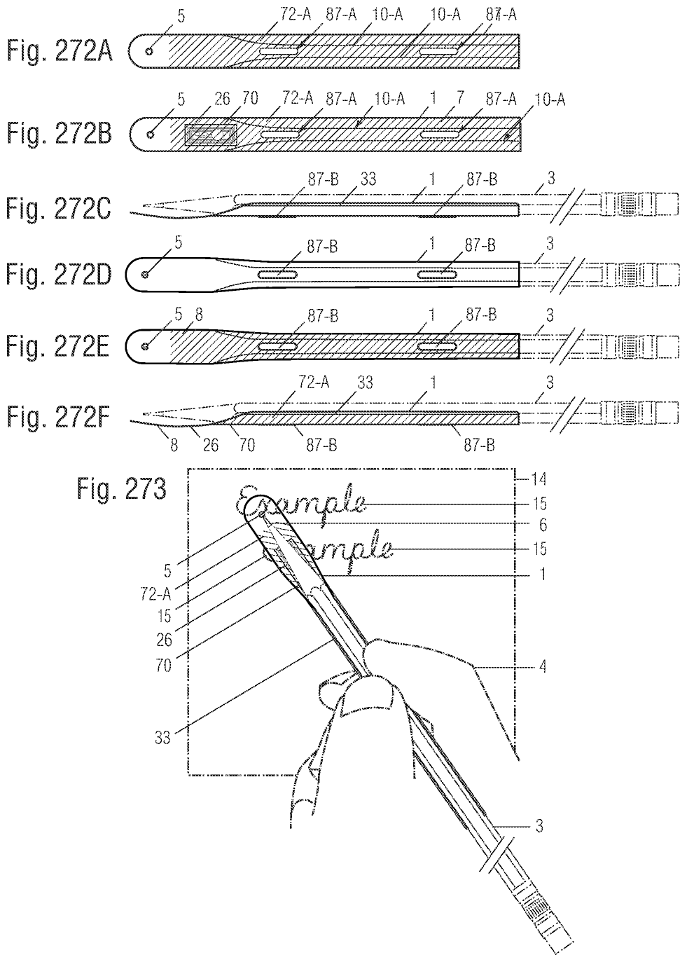

FIG. 272(a) is a bottom view of one embodiment of the adaptor having a transparent end and opaque body and two addition openings;

FIG. 272(b) is a similar view of FIG. 272(a) but also showing the position of RF antenna, module, tag or microchip;

FIG. 272(c) shows a side view of an adaptor similar to an adaptor as shown in FIGS. 115-118 but having two raised areas that fit inside the openings as shown in FIGS. 272(a)-(b) and in attached condition to a writing utensil;

FIG. 272(d) shows a side view of the adaptors shown in FIG. 272(b)-(c) combined and in attached condition to a writing utensil;

FIG. 273 is an overhead view of the adaptor in attached condition to a writing utensil as shown in FIG. 272(d) and being held by a user's hand and said writing utensil making a mark on a piece of paper which can be seen through the transparent end of said adaptor and part of another mark having been made by said writing utensil unable to be seen because of the opaque part of said adaptor;

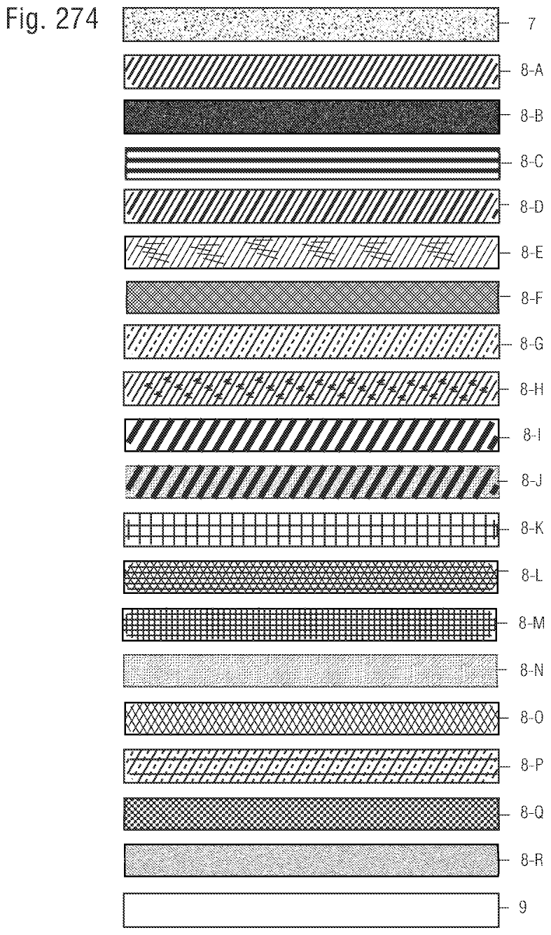

FIG. 274 shows cross sections of various material substrates used to make the adaptor according to the invention;

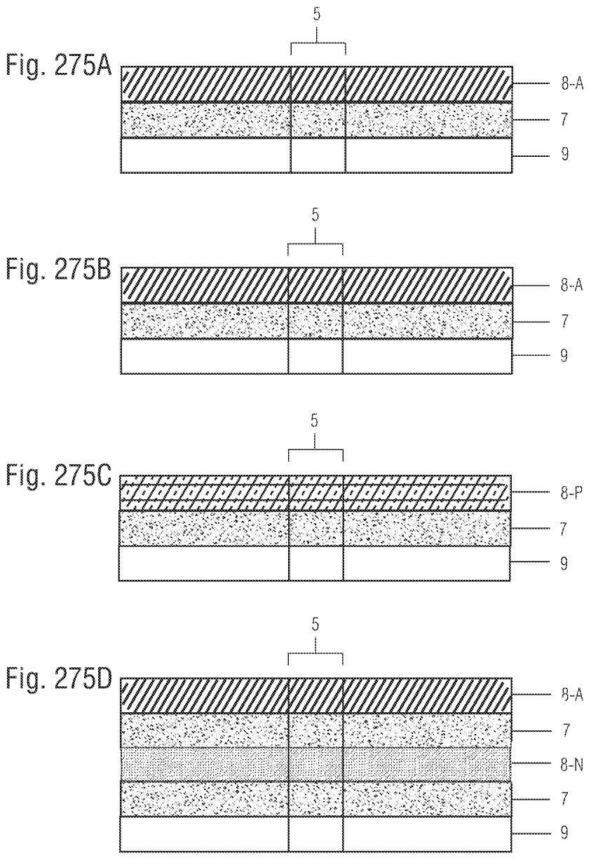

FIG. 275(a)-(d) shows various cross sections as seen in FIG. 274 but as laminated layers and having an open area which penetrates all layers;

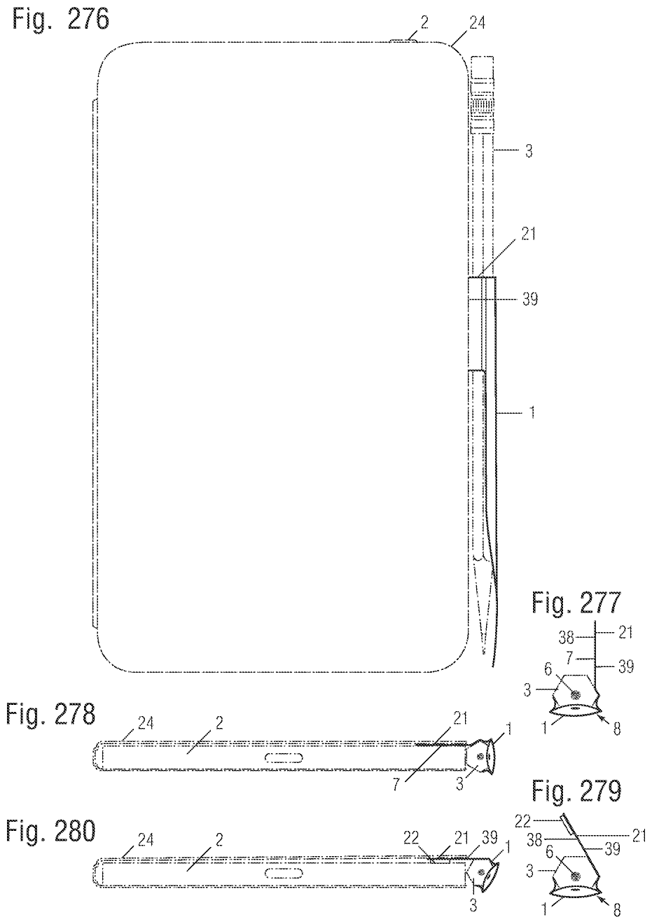

FIG. 276 shows an overhead view of a touch screen device which has an attached cover and an adaptor in attached condition to a writing utensil with said adaptor attached to said touch screen device;

FIG. 277 shows an enlarged front view of the adaptor as seen in FIG. 276 having a extension tab perpendicularly to the bottom plane of a writing instrument attached to said adaptor;

FIG. 278 shows a front view of the adaptor as seen in FIG. 277 in attached condition to a touch screen device with said adaptor's extension tab in between the cover of said touch screen device and said device;

FIGS. 279-280 are similar to views seen in FIGS. 277-278 but with the position of the extension tab of the adaptor bent in a different orientation to a writing utensil and having an adhesive, micro-suction or nano tape pad attached to said extension tab and in attached condition to a touch screen device and underneath the cover of said device;

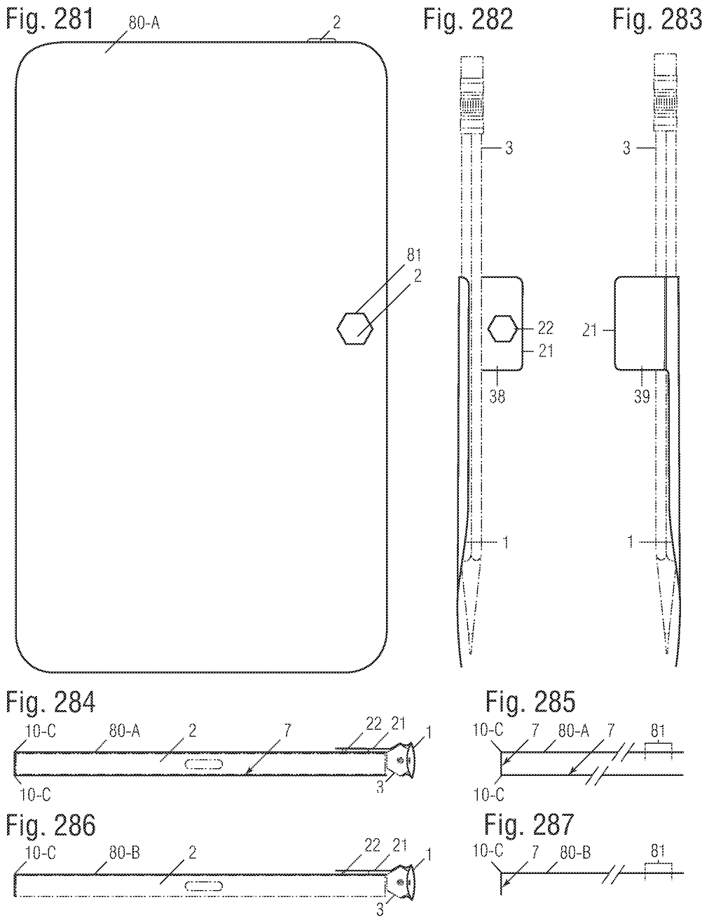

FIG. 281 shows a cover over a touch screen device and having a different variation of an opening near the side of one end;

FIG. 282 shows a side view of an adaptor in attached condition to a writing utensil as seen in FIG. 77 and having an adhesive, micro-suction or nano tape pad or strip of a shape that fits inside the opening as seen in FIG. 281;

FIG. 283 shows the opposite side view of the adaptor as seen in FIG. 282;

FIG. 284 shows a front view of the adaptor as seen in FIGS. 282-283 in attached condition to a touch screen device which has a cover over it and held closed by said attached stylus having an adhesive, micro-suction, nano tape pad which goes through the opening in said touch screen cover as seen in FIG. 281;

FIG. 285 shows a front view of said touch screen cover and its three sides and the position of the opening shown in FIG. 281;

FIG. 286-287 show similar views to FIGS. 284-285 but with the touch screen cover only having two sides;

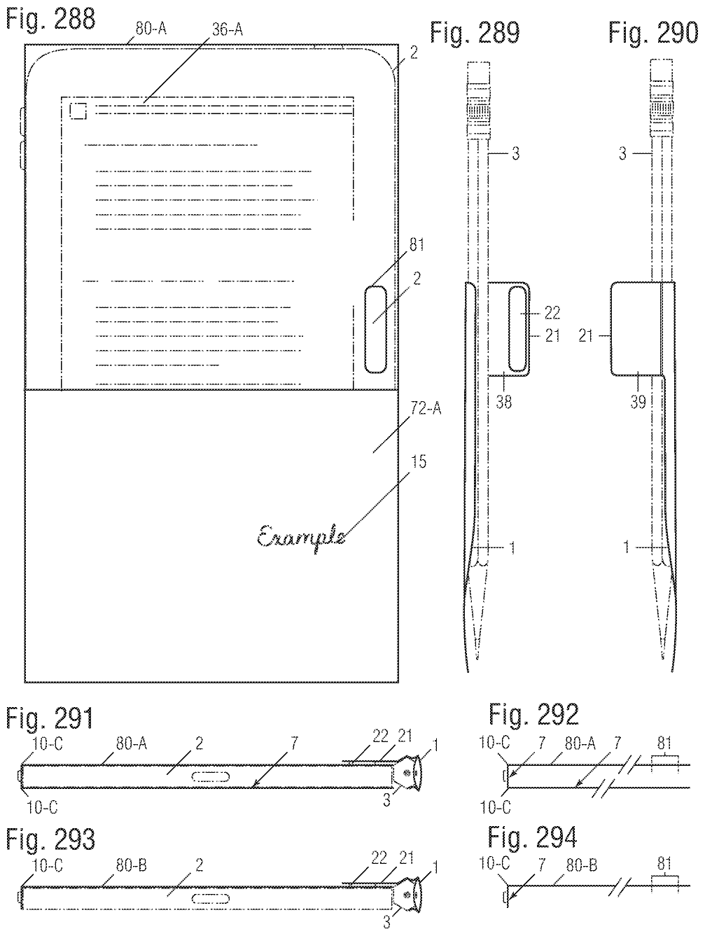

FIG. 288-294 show similar views to FIGS. 281-287 but with the cover of the touch screen having a transparent upper part which allows the touch screen below its surface to still operate when using the adaptor according to the invention and it also has an opaque lower part that has an insulator coating or substrate and a surface that will accept marks made from a writing instrument but will not allow operation of the touch screen below it;

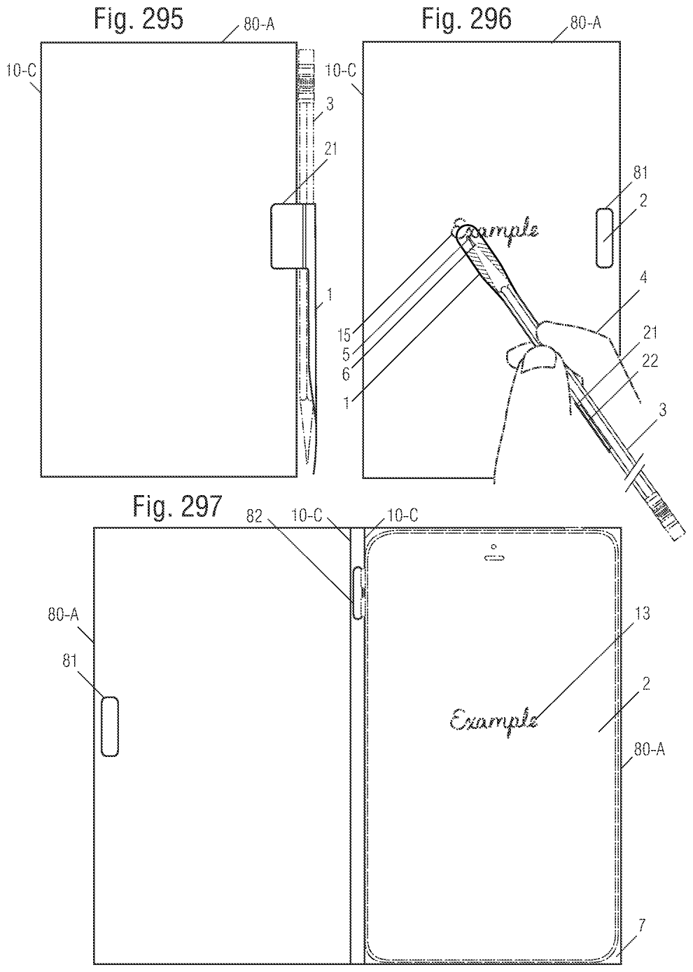

FIG. 295 shows an overhead view of a touch screen device cover as seen in FIG. 281 and an adaptor according to the invention in attached condition to a writing instrument;

FIG. 296 shows an overhead view of a touch screen device cover as seen in FIG. 281 and FIG. 295 but with the adaptor according to the invention in attached condition to a writing utensil, a user's hand holding said adaptor in attached condition to a writing instrument and said writing instrument making a mark on said touch screen cover;

FIG. 297 shows an overhead view of the touch screen cover as in FIG. 295 and FIG. 296 but in an open condition and a touch screen device having an identical but digital marking made by the adaptor seen in FIG. 296;

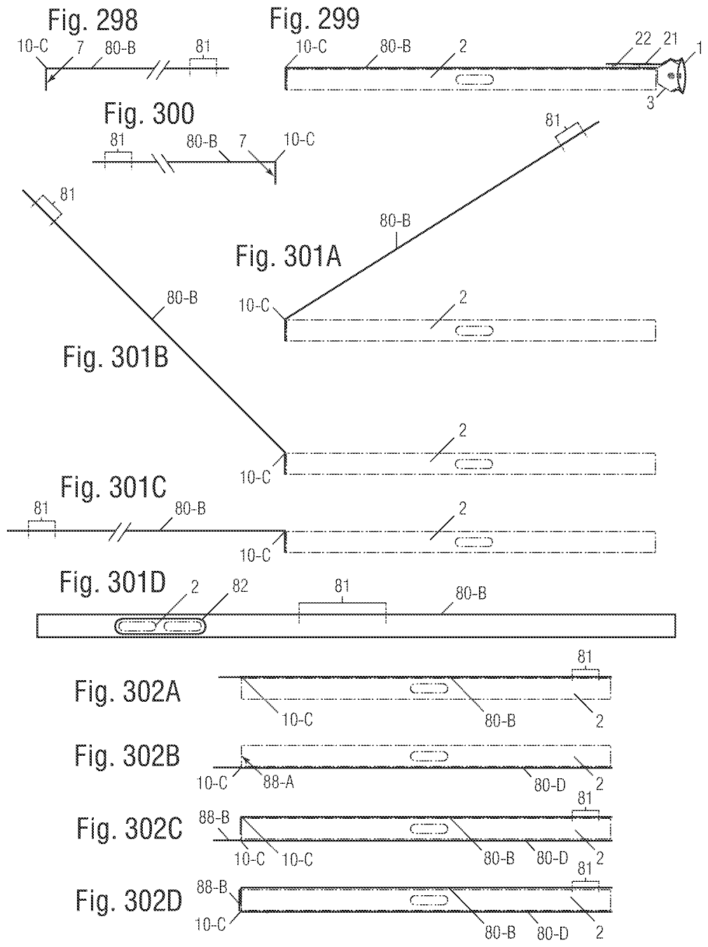

FIG. 298 shows a front view of a touch screen cover in unattached condition;

FIG. 299 shows a front view of the touch screen cover shown in FIG. 298 but in attached condition to a touch screen device and having an adaptor according to the invention in attached condition to a writing utensil and a touch screen device;

FIG. 300 shows the opposite view of FIG. 298;

FIGS. 301(a)-(c) show a sequence of front views of the touch screen cover shown in FIGS. 295-297 in different open positions;

FIG. 301(d) shows a side view of the device cover in attached condition to a touch screen device as seen in FIGS. 301(a)-(c) and shows an opening in the side to allow access to said device's buttons;

FIG. 302(a) shows an edge view of the touch screen device with a top cover positioned on top and extending past the edge of said device;

FIG. 302(b) shows an edge view of the touch screen device with a bottom cover positioned underneath;

FIG. 302(c) shows the top cover as seen in FIG. 302(a) but with a bend at one end enabling the edge of said cover to lay flat against an edge of a touch screen device and it shows a bottom cover extending past the edge of said device as shown in FIG. 302(b);

FIG. 302(d) show a similar view as shown in FIG. 302(c) but with the end of the bottom cover having a bend so as to allow the trapping of the edge of the top cover between itself and the edge of the touch screen device;

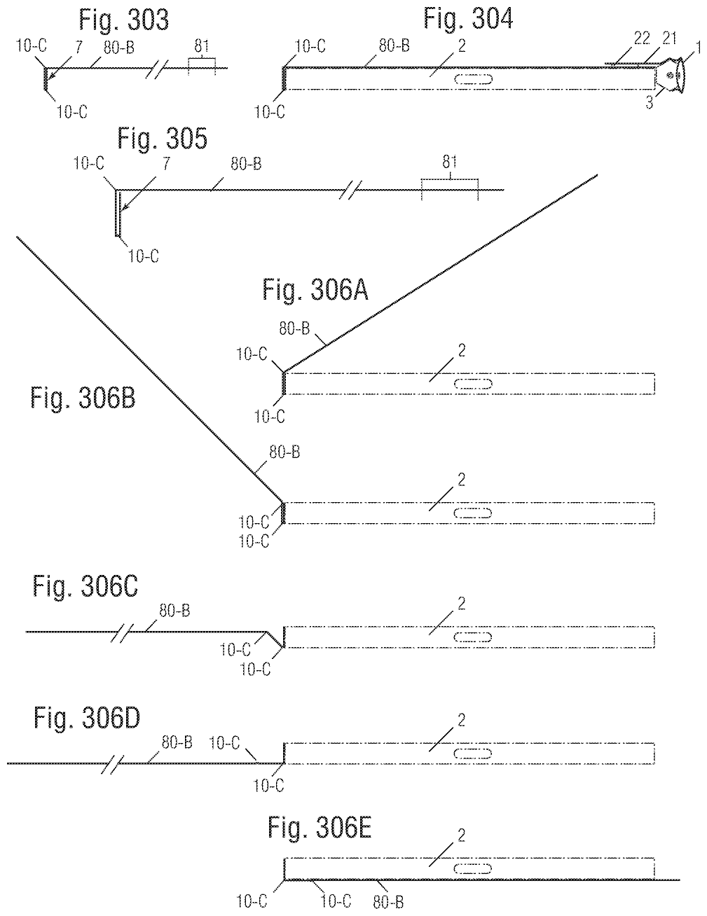

FIGS. 303-304 show similar views as seen in FIGS. 298-299 but having an additional material and a fold as seen in the enlarged view of FIG. 305;

FIG. 305 is an enlarged front view of the device cover as seen in FIGS. 303-304;

FIGS. 306(a)-(d) show the cover in varying open conditions;

FIG. 306(e) show a front view of the cover in attached condition to the touch screen device as seen in FIGS. 306(a)-(d) but in a fully open condition and folded under said touch screen device;

FIGS. 307(a)-(c) show side back and front views, respectively, of an attachment with the same size and shape of the adaptor extension tab as seen in FIGS. 307(d)-(e) and having multiple peel-off sticky-notes;

FIGS. 307(d)-(e) show front and side views, respectively, of the adaptor in attached position to a writing utensil and having the attachment shown in FIGS. 307(a)-(d) in attached condition to said adaptor extension tab;

FIGS. 308(a)-(e) show similar views as in FIGS. 307(a)-(e) but with attachment made of printed peel-off calendars;

FIGS. 309(a)-(e) show similar views as in FIGS. 307(a)-(e) but with attachment made of multiple sets of transparent sticky-notes with each set having areas at top with different colors;

FIGS. 310(a)-(e) are similar views seen in FIGS. 307(a)-(e) but with attachment to the extension tab of the adaptor made of multiple peel-off layers each showing a conjugated verb;

FIGS. 311(a)-(e) are similar views as seen in FIGS. 308(a)-(e) but with the attachment to the extension tab of the adaptor made of multiple peel-off layers each showing a word and its pronunciation and definition;

FIGS. 312(a)-(e) are similar views as seen in FIGS. 307(a)-(e) but with the attachment to the extension tab of the adaptor made of one or more writable layers;

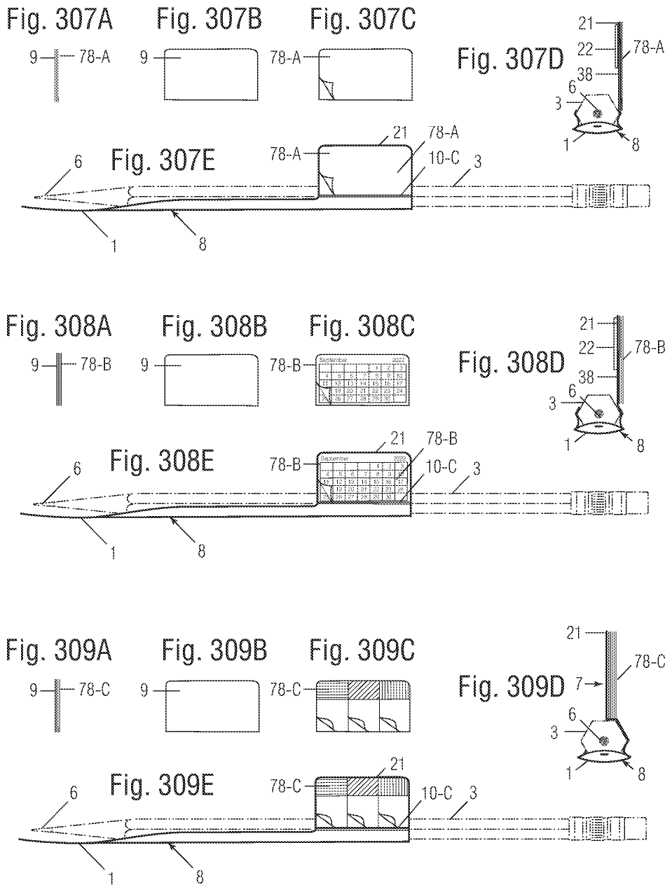

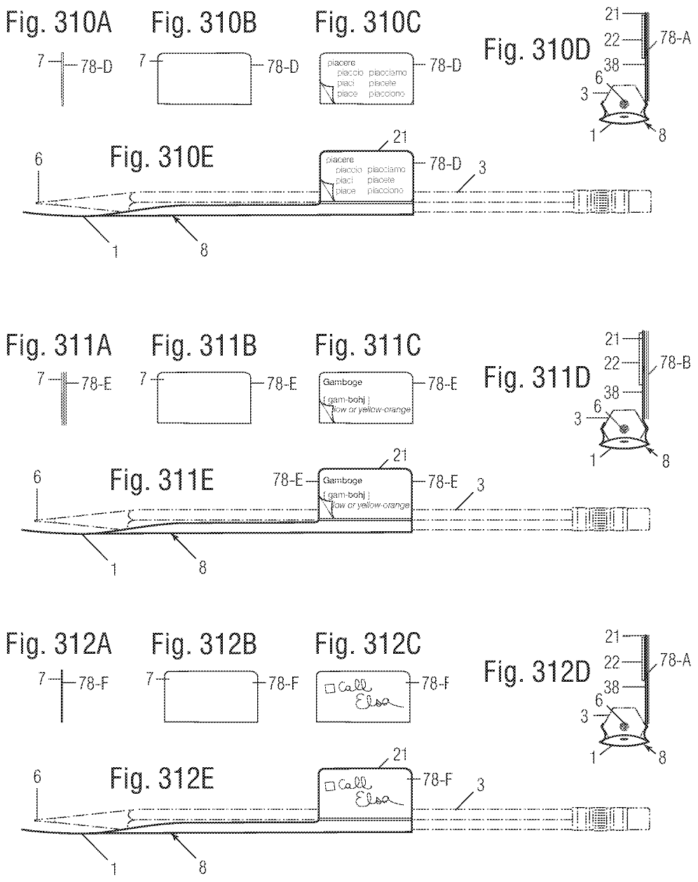

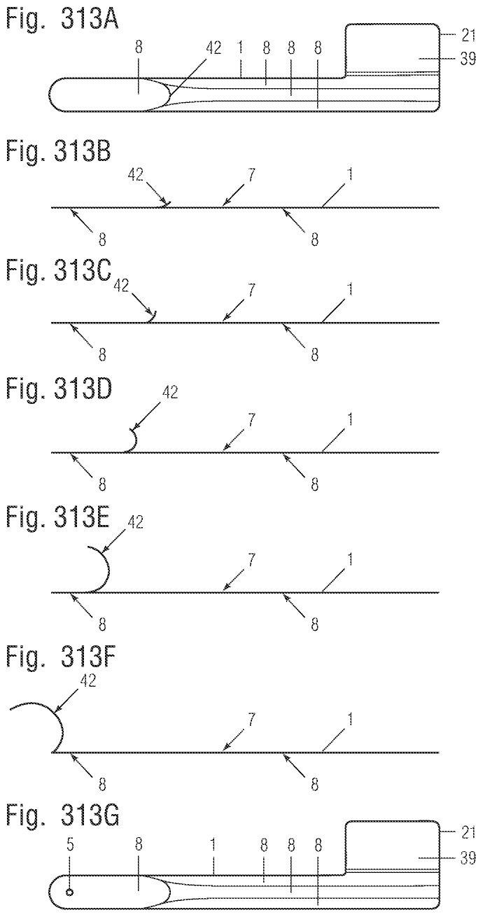

FIG. 313(a) shows a bottom view of an adaptor having a layer toward the end near the opening and having an additional kiss-cut allowing a part of the outermost layer to be peeled away;

FIGS. 313(b)-(f) show a sequence of side views of the adaptor shown in FIG. 313(a) as a part of the outermost layer at the end is removed;

FIG. 313(g) shows a similar view as shown in FIG. 313(a) but with the part of the outermost layer completely removed and exposing the opening near the end;

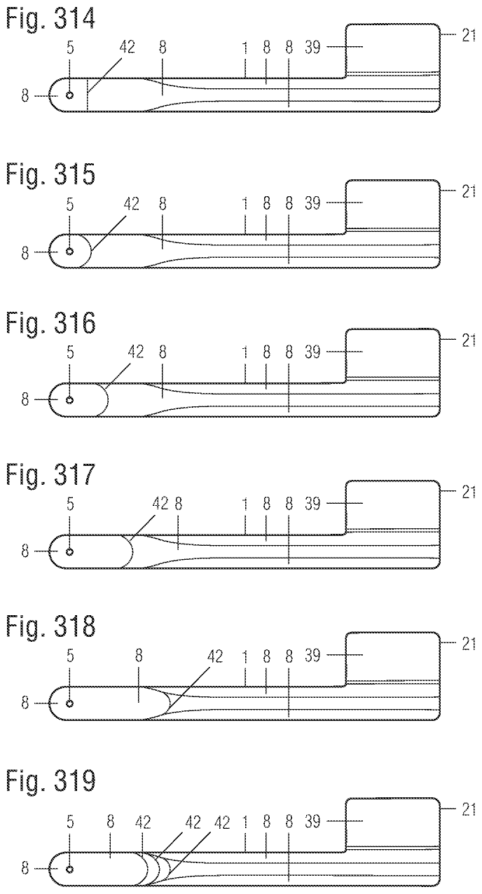

FIGS. 314-318 show bottom views of different iterations of the adaptor shown in FIG. 313(a);

FIG. 319 shows an adaptor similar to FIG. 318 but having multiple peel-away layers;

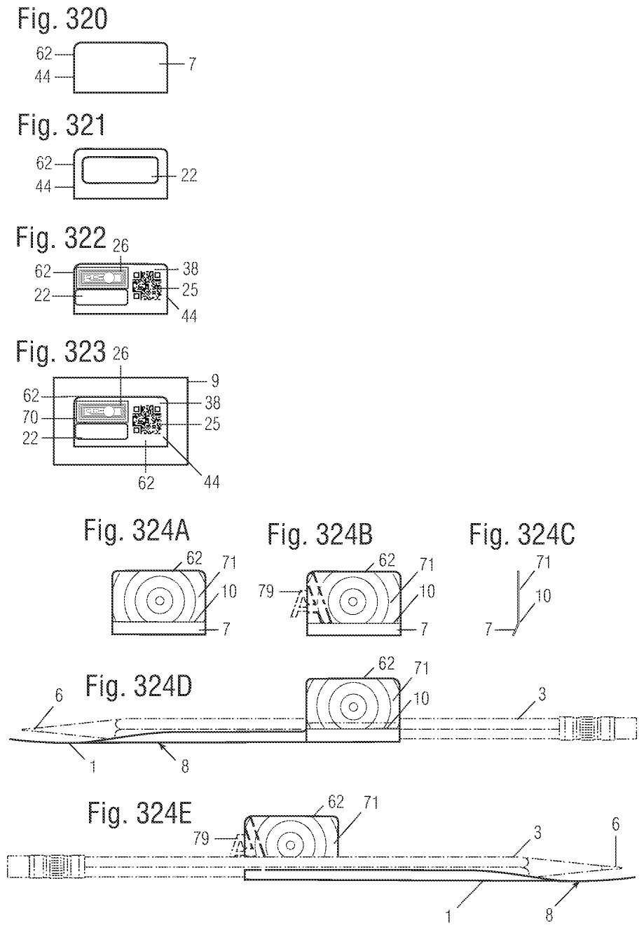

FIGS. 320-321 show front and back views, respectively, of an attachment of same size and shape of the extension tab of the adaptor according to the invention with the back view showing an adhesive, micro-suction, nano tape pad for attaching to a touch screen device or similarly flat surface;

FIG. 322 shows a front view of an attachment similar to FIG. 320 and FIG. 321 but having a NFC tag or other RF antenna, tag, module or microchip, a ferrite layer, scannable code as well as an adhesive, micro-suction or nano tape pad;

FIG. 323 shows the attachment as shown in FIG. 323 but attached to a protective backer;

FIGS. 324(a)-(c) show an attachment having a bend at one end and is of a material capable of magnifying a view;

FIGS. 324(d)-(e) show side views of the attachment shown in FIGS. 324(a)-(c) in attached condition to an adaptor in attached condition to a writing utensil;

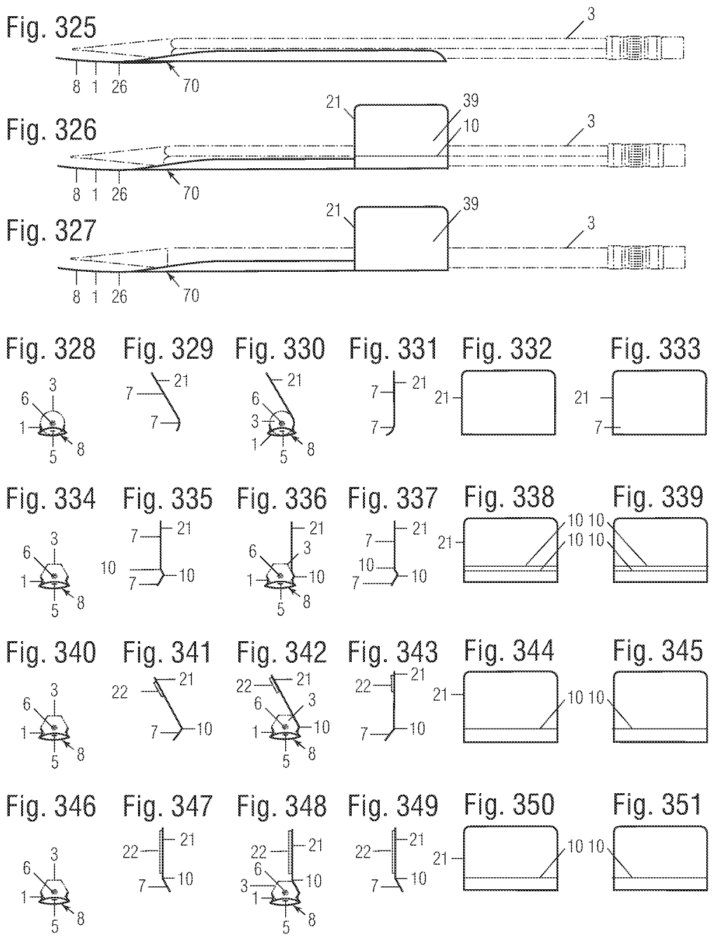

FIG. 325 shows a side view of an iteration of an adaptor according to the invention in attached condition to a writing utensil;

FIG. 326 shows the same view as shown in FIG. 325 but having an attachment as seen in FIGS. 343-345;

FIG. 327 shows a similar view as shown in FIG. 326 but with a different shaped writing utensil as seen in FIG. 328 and FIG. 330 and having an attachment as seen in FIGS. 329-333;

FIG. 328 is a front view of an adaptor in attached condition to a writing instrument;

FIG. 329 is a front view of an attachment as seen in FIG. 330-333;

FIG. 334 is a front view of an adaptor in attached condition to a writing utensil and as seen in FIG. 325;

FIG. 335 is a front view of an attachment as seen in FIG. 337-339;

FIG. 336 is the attachment in FIG. 335 in attached condition to the adaptor shown in FIG. 334;

FIG. 337 is the same view as shown in FIG. 335;

FIG. 338-339 are front and back views, respectively, of the attachment shown in FIG. 337;

FIG. 340 is a front view of the adaptor in attached condition to a writing utensil as seen in FIG. 325; FIG. 341 is a front view of an attachment as seen in FIG. 344-345;

FIG. 342 is a front view of the attachment as seen in FIG. 341 but in attached condition to the adaptor as seen in FIG. 340;

FIG. 343 is a rotated view of the attachment shown in FIG. 341;

FIGS. 344-345 are front and back views, respectively, of the attachment as seen in FIG. 326 and FIGS. 341-343;

FIG. 346 is a repeat of FIG. 334 and FIG. 346;

FIG. 347 is a front view of an attachment as seen in FIGS. 349-351;

FIG. 348 is a front view of the attachment shown in FIG. 347 and FIGS. 349-351 but in attached condition to an adaptor as seen in FIG. 346;

FIG. 349 is a repeat of FIG. 347;

FIGS. 350-351 are front and back views respectively of the attachment shown in FIGS. 347-349;

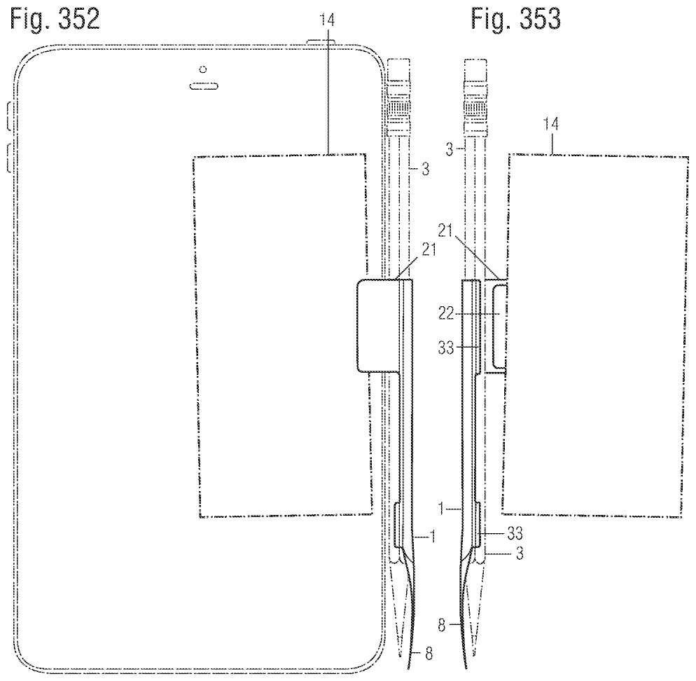

FIG. 352 shows an overhead view of a touch screen device with a piece of paper being held to said device by an adaptor according to the invention which is in attached condition to a writing instrument;

FIG. 353 shows the opposite view of said adaptor with said piece of paper in attached condition to the adaptor;

FIG. 354 shows a front view of an adaptor in attached condition to a writing utensil;

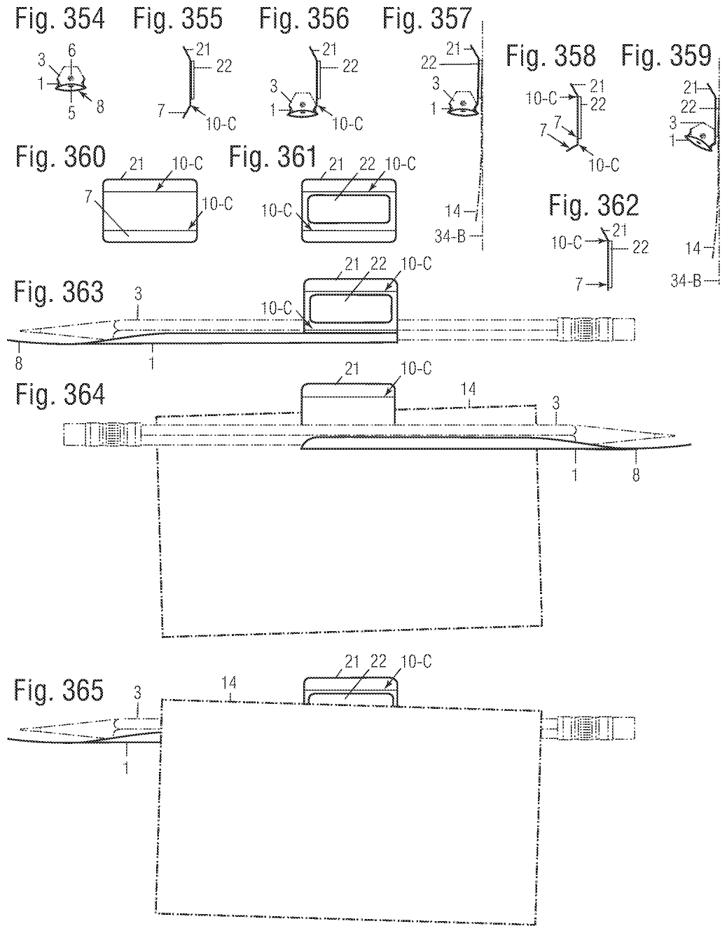

FIG. 355 shows a side view of an attachment having two bent ends and an adhesive, micro-suction, nano tape pad;

FIG. 356 shows the attachment in FIG. 355 in attached condition to the adaptor shown in FIG. 354;

FIG. 357 shows the same view as FIG. 356 and a piece of paper and a flat vertical surface such as a wall;

FIG. 358 show an attachment similar to the one shown in FIG. 355 but with a more extreme lower bend;

FIG. 359 shows the attachment in FIG. 358 but in attached condition to an adaptor that is in attached condition to a writing utensil and a side view of a piece of paper and a flat vertical surface such as a wall;

FIGS. 360-361 are front and back views of the attachment shown in FIG. 355;

FIG. 362 is a side view of an attachment similar to that shown in FIG. 355 and FIG. 358 but with only one bend and a larger adhesive, micro-suction or nano tape pad;

FIG. 363 is a side view of the adaptor shown in FIGS. 360-361 but in attached condition to an adaptor which is in attached condition to a writing utensil;

FIG. 364 shows the opposite side view of FIG. 363 but with a piece of paper in attached condition to the attachment shown in FIG. 360-361;

FIG. 365 shows the opposite side view of FIG. 364;

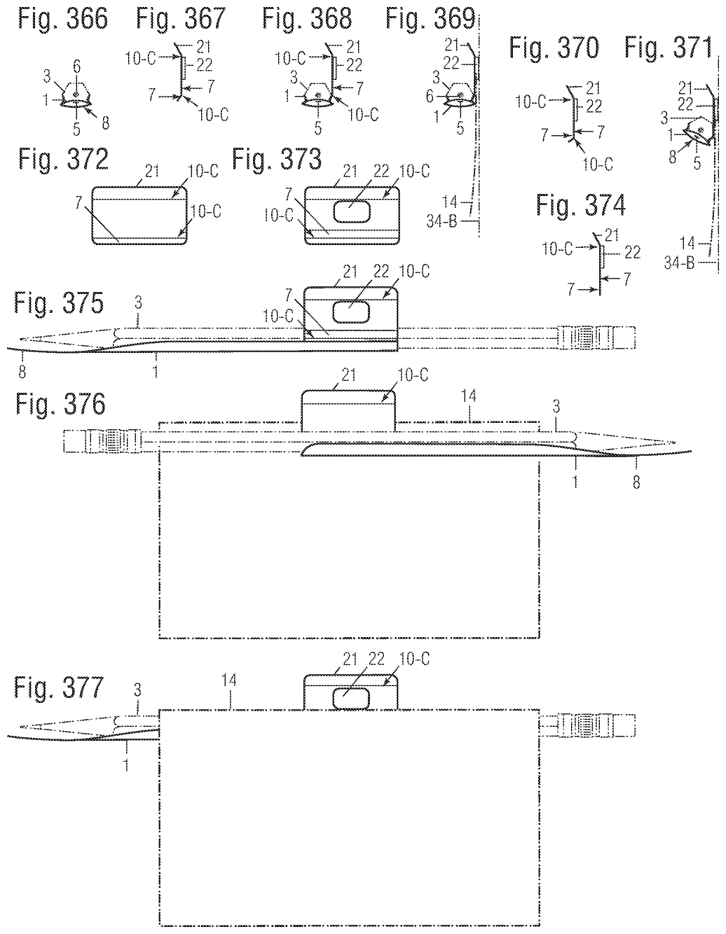

FIGS. 366-377 show similar views to FIGS. 354-365 but with an additional adhesive, micro-suction, nano tape strip or pad;

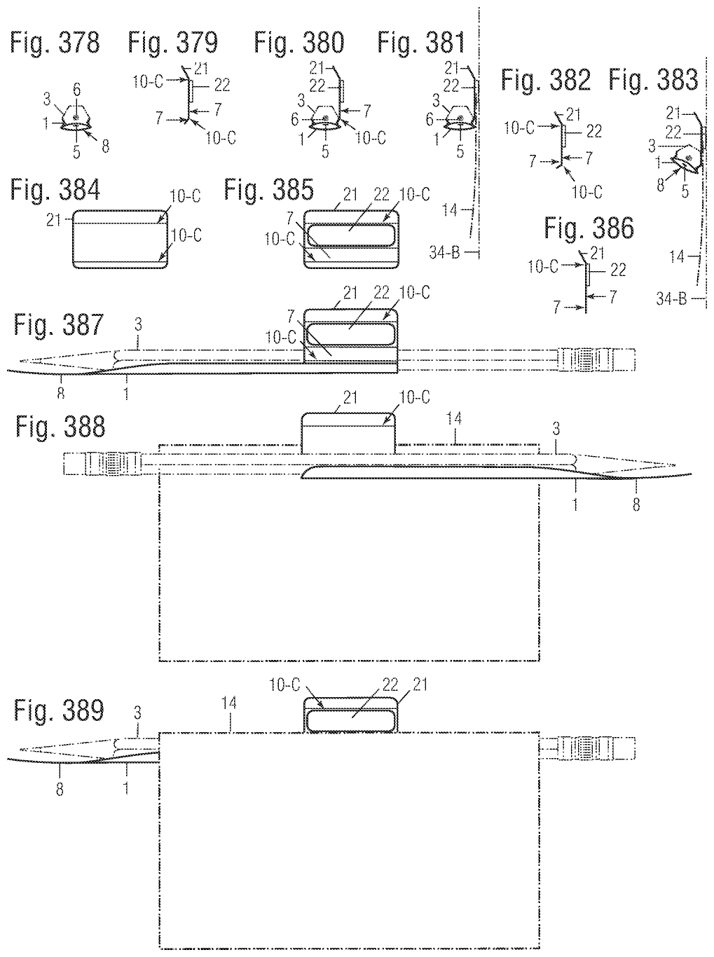

FIGS. 378-389 show similar views to FIGS. 366-377 but with different sized adhesive, micro-suction, nano tape pads or strips;

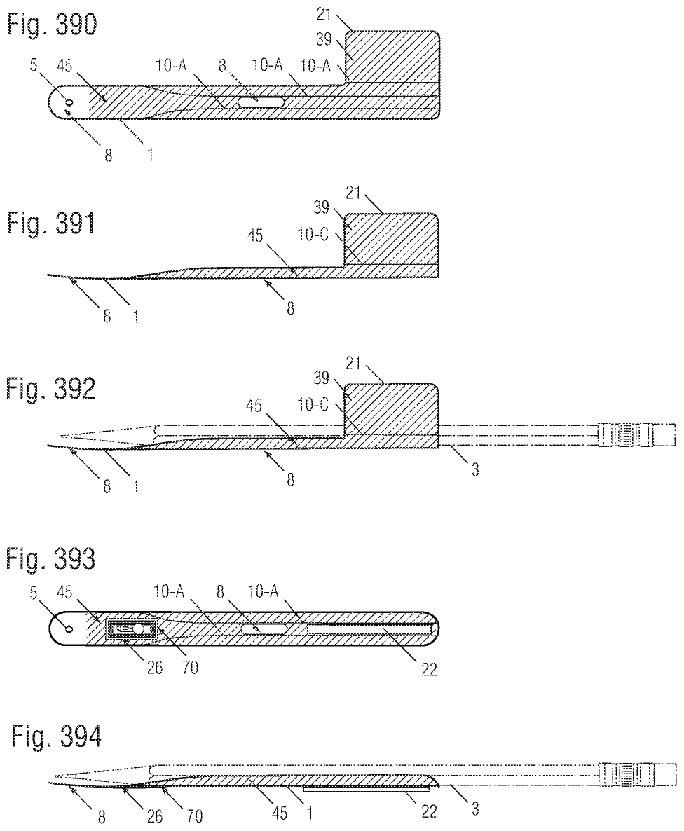

FIG. 390 shows a bottom plan view of an adaptor according to the invention and having a transparent end and a coating or layer that is an insulator and an area near the middle of said insulator that is of the same conductive material as at the adaptor end and along its length;

FIG. 391 shows a side view of the adaptor shown in FIG. 390 but in the formed shape as if attached to a writing utensil;

FIG. 392 shows the adaptor as seen in FIGS. 390-391 but in attached condition to a writing utensil;

FIG. 393 show a bottom plan view of an adaptor as seen in FIG. 390 but without the extension tab and with a NFC tag, ferrite layer and an adhesive, micro-suction, or nano tape pad or strip;

FIG. 394 is a side view of the adaptor shown in FIG. 393 but in attached condition to a writing utensil;

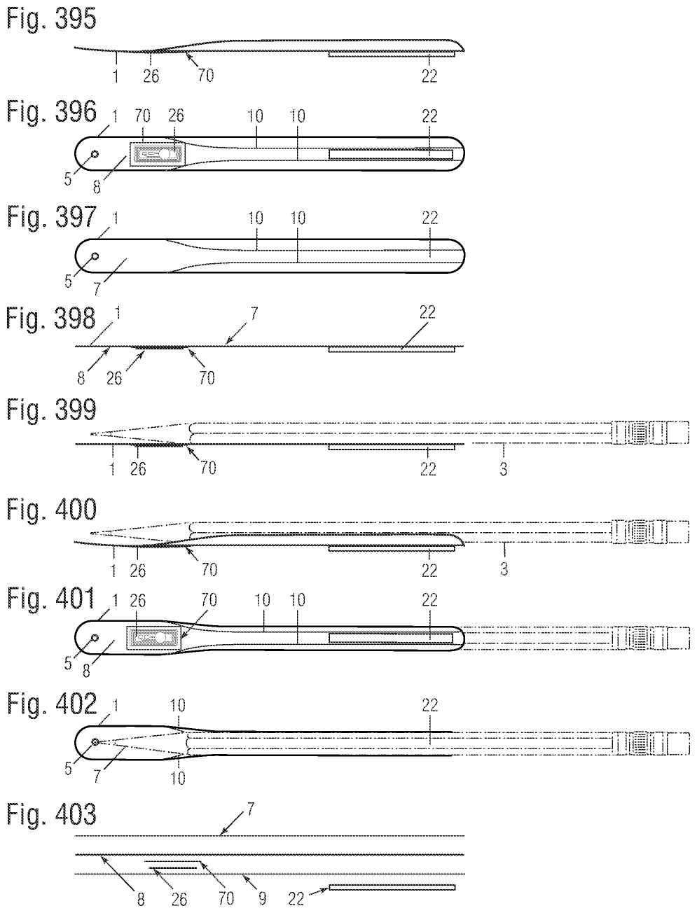

FIG. 395-403 are similar views as shown in FIG. 6-14 but with the addition of an adhesive, micro-suction or nano tape pad or strip;

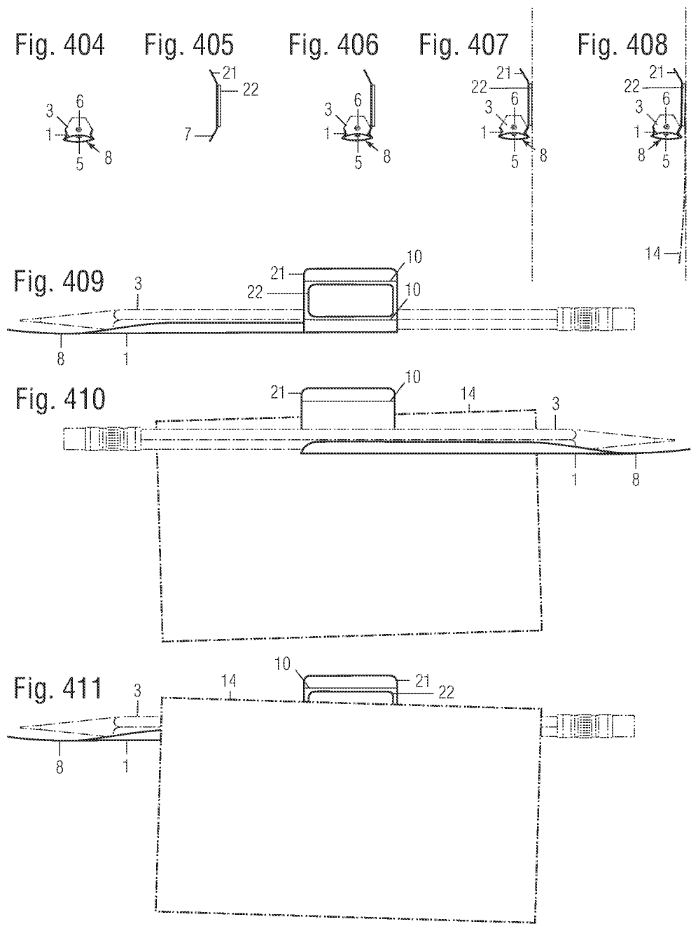

FIGS. 404-411 are similar views as seen in FIGS. 354-365 but having a larger adhesive, micro-suction or nano tape pad or strip and with an attachment in attached condition to the exposed outer side of an adaptor instead of between said adaptor and an attached writing utensil;

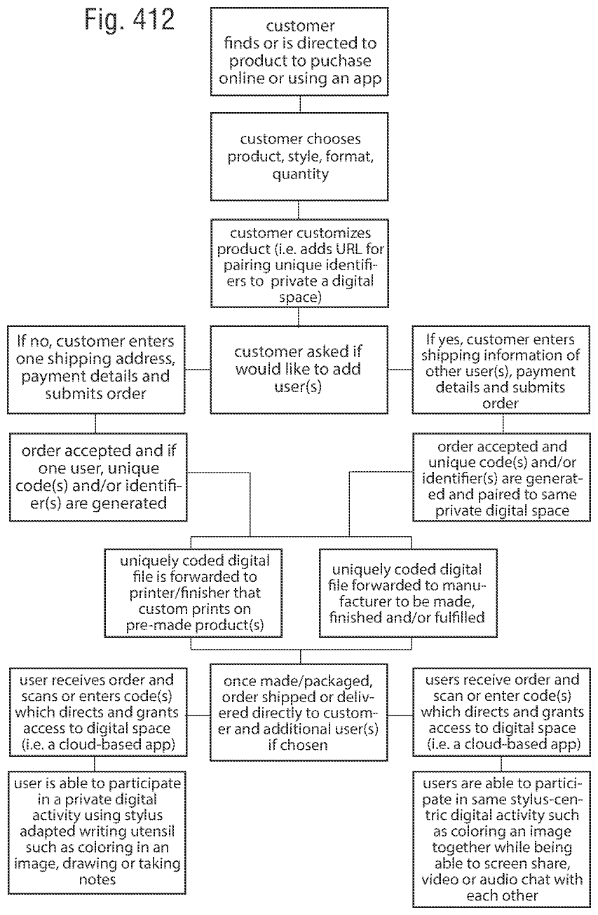

FIG. 412 is a flow chart of the process of ordering, customizing and fulfilling an order for an adaptor according to the invention;

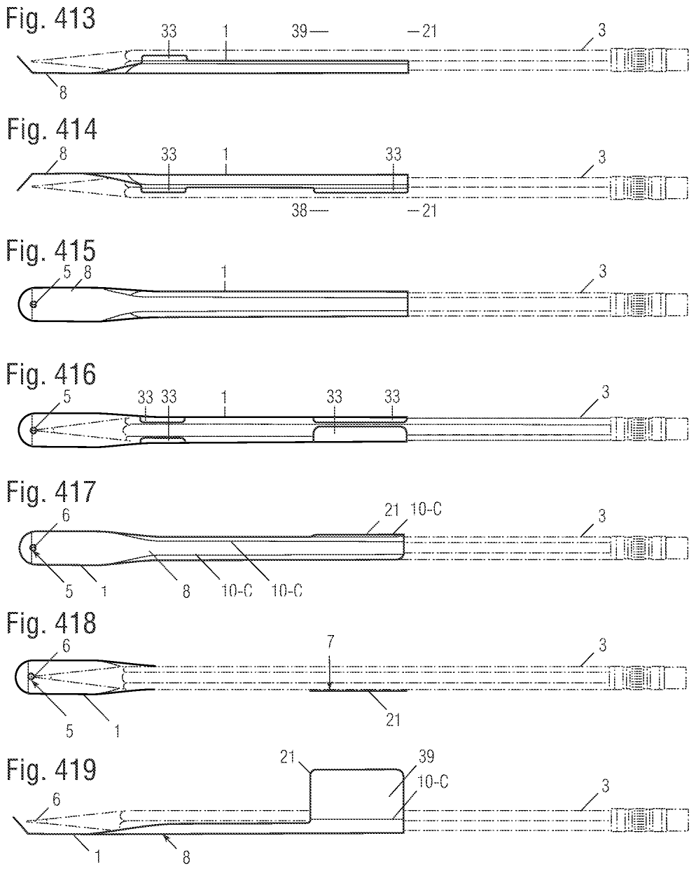

FIGS. 413-419 show various side, top and bottom views of different adaptors according to the invention and having a bent end at or near the opening at one end of the adaptor;

FIGS. 420-425 show a work surface or other hard flat surface and an adaptor as seen in FIG. 413 in an attached condition to a writing utensil with the bent end of the adaptor protecting the point of said writing utensil from accidentally hitting a hard surface (i.e., when dropped);

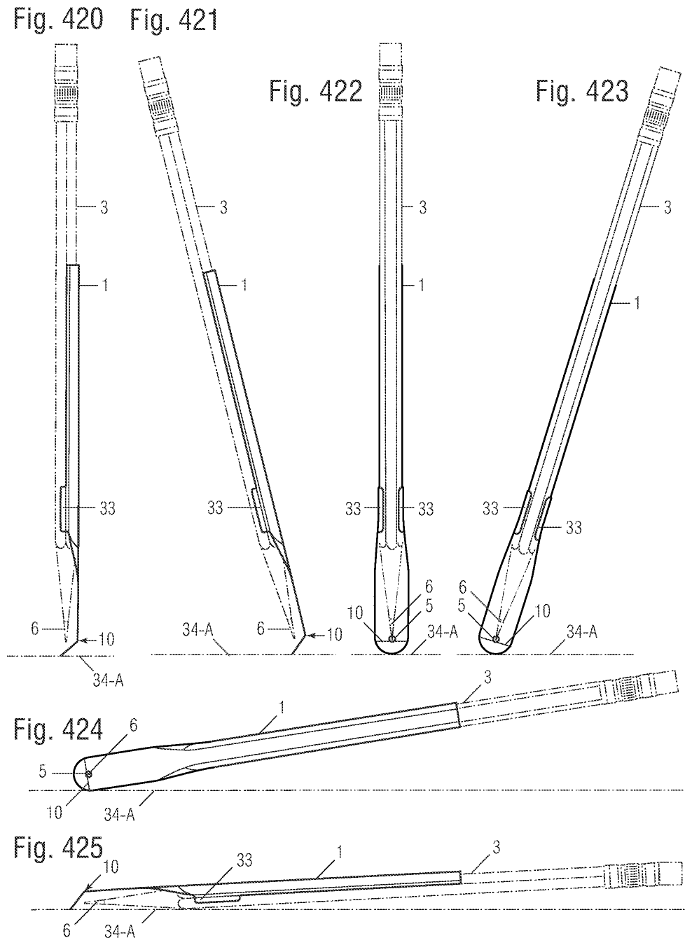

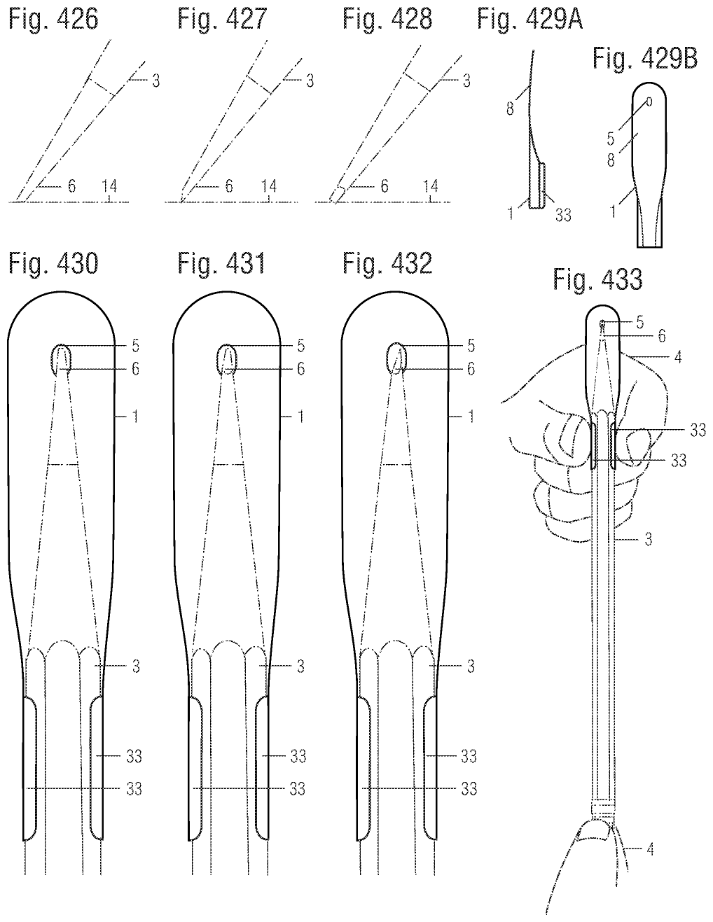

FIGS. 426-428 show enlarged views of a pencil point in different conditions of wear when said pencil is rotated after being worn when used on paper;

FIGS. 430-432 show an enlarged view of an adaptor in attached condition to a pencil and the different conditions of wear of the point of said pencil as shown in FIGS. 426-428 and when said pencil is rotated in said adaptor;

FIG. 433 shows an overhead view of an adaptor as shown in FIGS. 429(a)-(b) and FIGS. 430-432 with a user's hands holding said adaptor so as to rotate the attached pencil in said adaptor to expose a more sharp edge of the pencil point of said pencil;

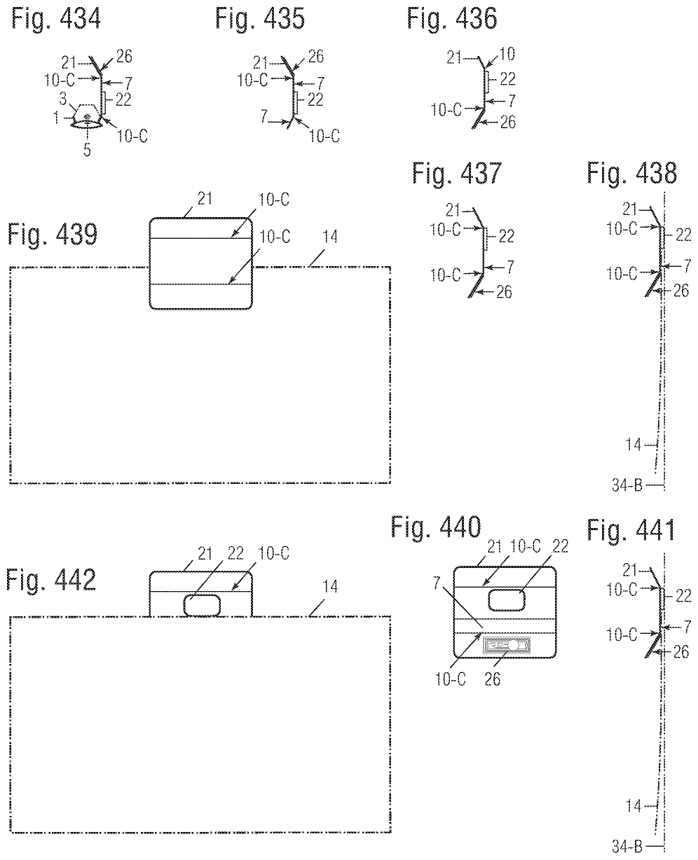

FIG. 434 shows a front view of an adaptor in attached condition to a writing utensil and having an attachment as seen in FIG. 435;

FIG. 435 shows a front view of an attachment having two bent ends, an adhesive, micro-suction or nano tape pad or strip, at least one other area having an adhesive, micro-suction or nano tape pad or strip, and a NFC tag or other type of RF antenna, module, tag or microchip;

FIG. 436 shows a similar view as seen in FIG. 435 but with said adhesive, micro-suction or nano tape pad or strip in a different position as well as the NFC tag or other type of RF antenna, module, tag or microchip in a different position;

FIG. 437 shows a front view similar to the one shown in FIG. 436 but with the material above the top bend extended to a longer length;

FIG. 438 shows an attachment as seen in FIG. 437 with a piece of paper in attached condition to said attachment and said attachment in attached condition to a wall or other flat surface;

FIG. 439 shows a side view of the attachment shown in FIGS. 437-438 and a note cord in attached condition to said attachment;

FIG. 440 shows the opposite side view of the attachment shown in FIG. 439 in unattached condition to a piece of paper or note card and showing a position of a NFC tag or other type of RF antenna, tag, module or microchip, an adhesive, micro-suction, nano tape pad or strip as well as another adhesive, micro-suction, nano tape pad or strip;

FIG. 441 shows a similar view as seen in FIG. 438;

FIG. 442 shows the opposite view as shown in FIG. 439;

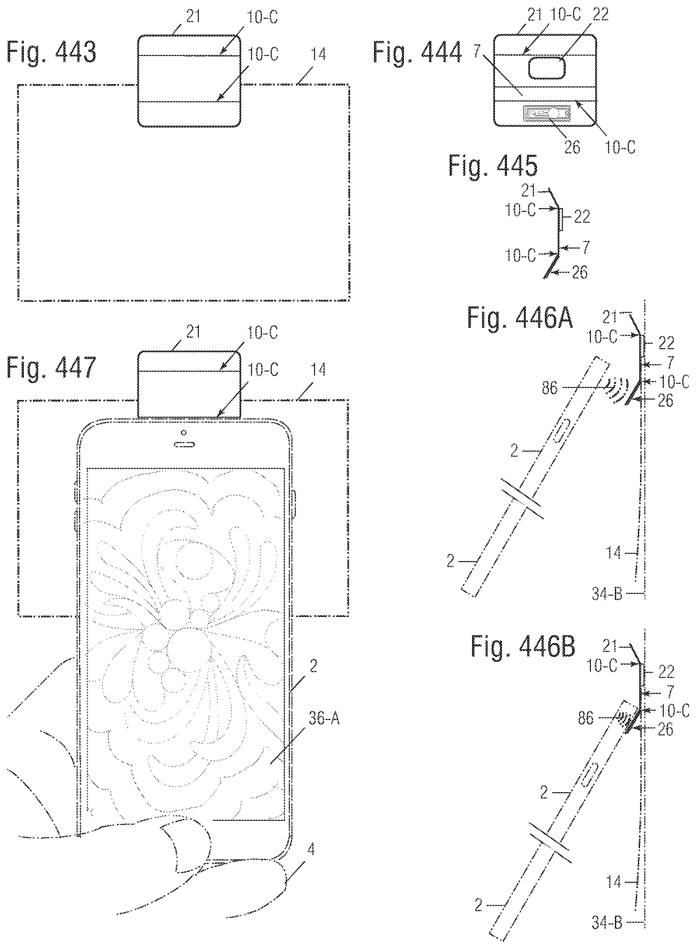

FIG. 443 is a similar view as shown in FIG. 439;

FIG. 444 is a similar view as shown in FIG. 440;

FIG. 445 is a similar view as shown in FIG. 437;

FIG. 446 show the side view of a touch screen device having RF capabilities and in position to detect a NFC tag or other RF tag, module, antenna or microchip that is on an attachment shown in FIG. 445 and in attached condition to a piece of paper and a smooth vertical surface such as a wall;

FIG. 447 shows a front view of what is shown in FIG. 446 with a user's hand holding the touch screen device up to the RF enabled attachment which is in attached condition to a piece of paper and a digital activity displayed on the touch screen device;

FIGS. 448-451 are similar views as shown in FIGS. 443-447 but with the attachment shown in FIG. 449 having an adhesive, micro-suction, nano tape pad or strip area divided into multiple said strips or pads;

FIG. 452 shows a view similar to that shown in FIG. 446 but with a user's hand holding the touch screen device and activating said the wireless RF capability of said device to detect a RF antenna, tag, module or microchip on the attachment having said RF antenna, tag, module or microchip;

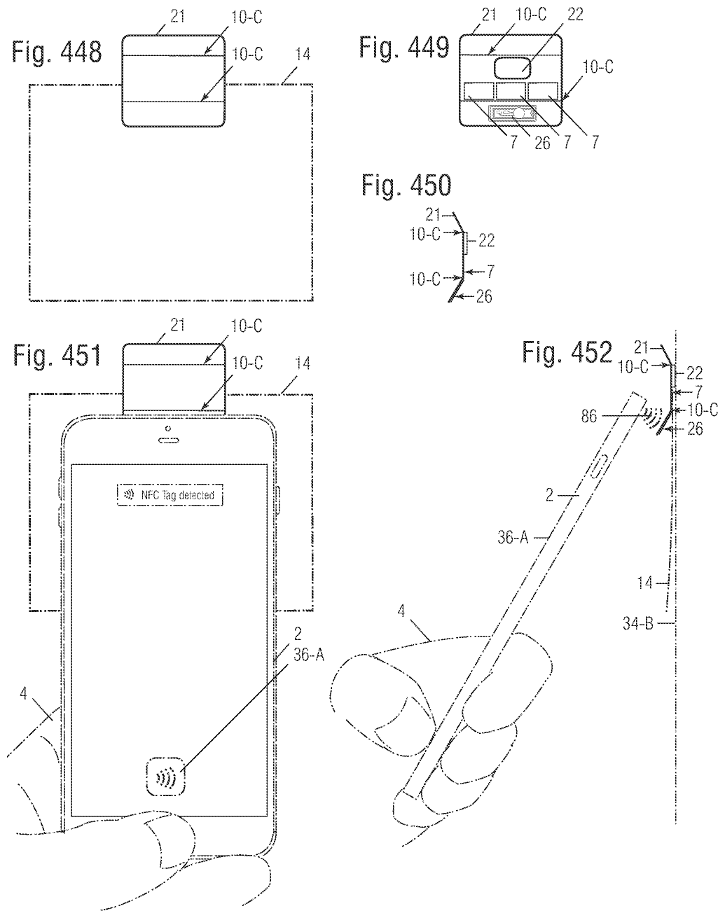

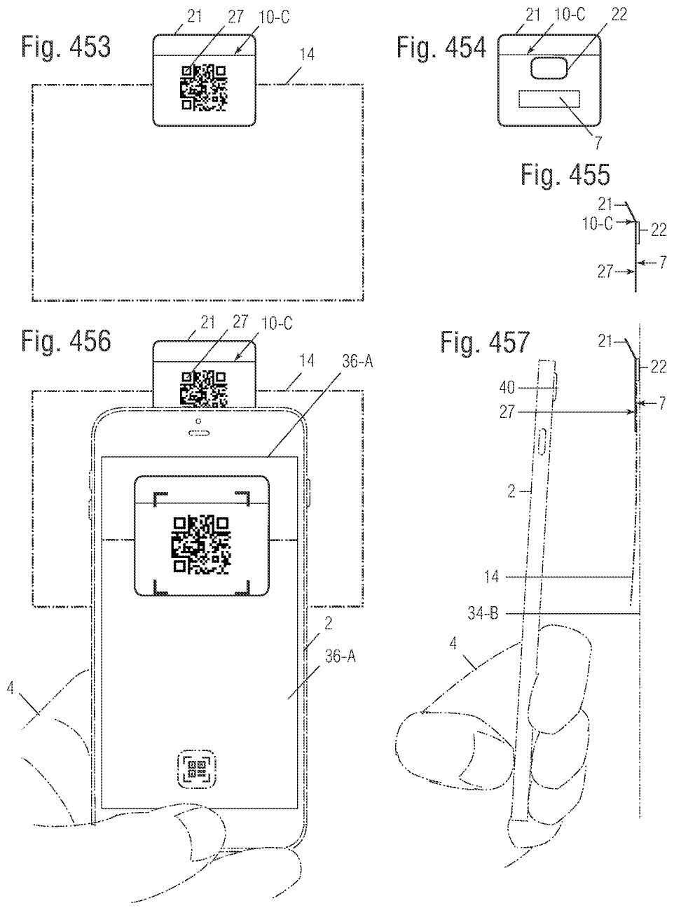

FIG. 453 shows a similar view as shown in FIG. 448 with the adaptor in attached condition to a piece of paper and said attachment having one bend and at least one scannable code printed, etched, stuck or stamped on it;

FIG. 454 shows the opposite side of FIG. 453 and having two areas of adhesive, micro-suction, nano tape pads or strips;

FIG. 455 is a side view of FIG. 455;

FIG. 456 is a front view of a touch screen device having a capability of scanning codes such as a QR code or barcode and being held by a user's hand and in a position to scan said code on an attachment which is in attached condition to a piece of paper;

FIG. 457 shows a side view of FIG. 456 with the attachment in attached condition to both a piece of paper and a wall;

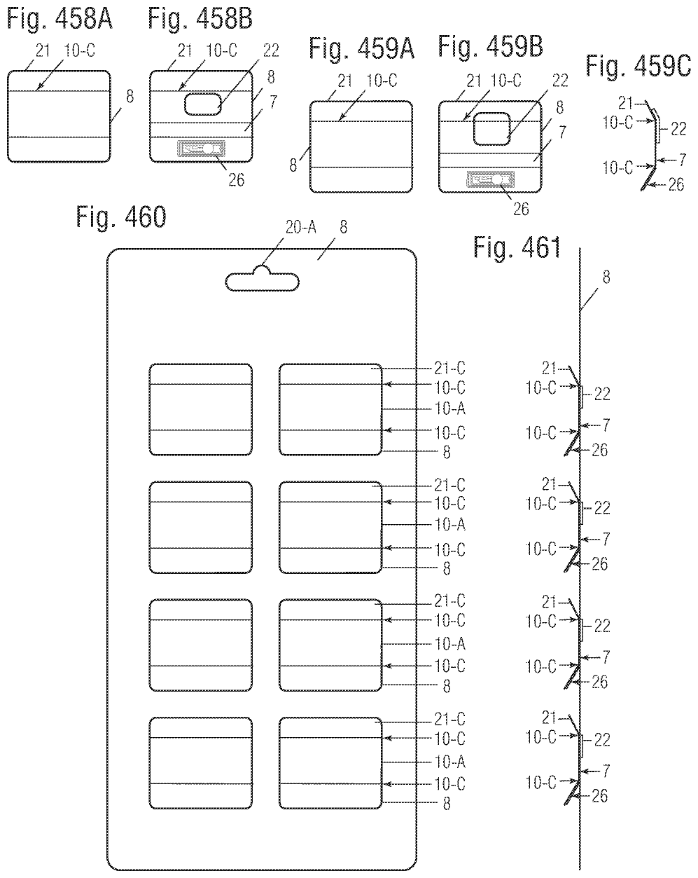

FIGS. 458(a)-(b) show front and back views, respectively, of an attachment as shown in FIGS. 443-444;

FIGS. 459(a)-(b) show similar views as seen in FIGS. 458(a)-(b) but with the adhesive, micro-suction or nano tape pad or strip in position over a bend in the attachment;

FIG. 459(c) is a side view of the attachment shown in FIGS. 459(a)-(b);

FIG. 460 shows a front view of a retail package holding several attachments as seen in FIGS. 458(a)-(b);

FIG. 461 shows a side view of FIG. 460;

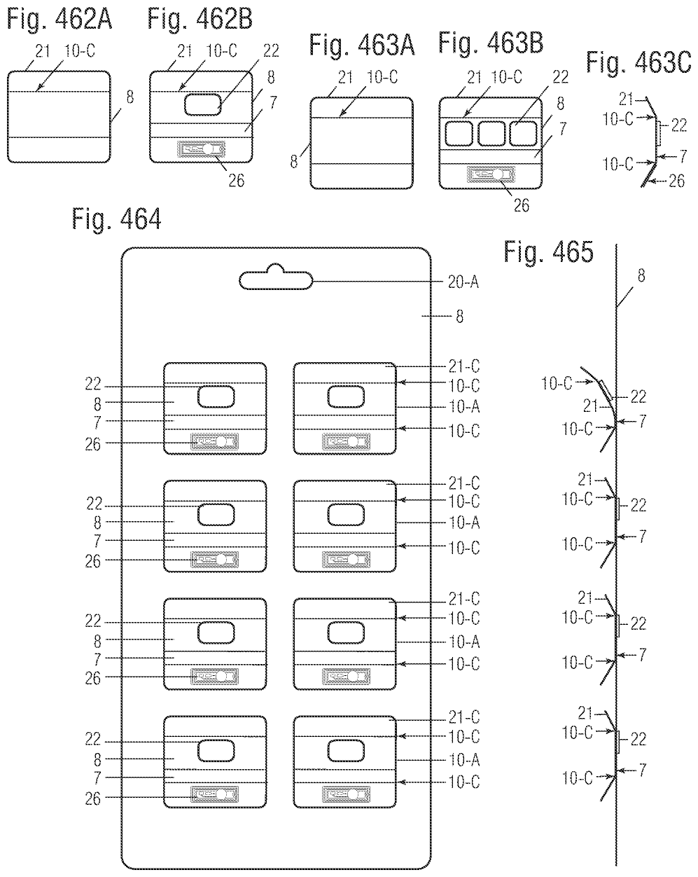

FIG. 462(a)-(b) show the same view as in FIG. 458(a)-(b);

FIGS. 463(a)-(b) show front and back views as shown in FIGS. 462(a)-(b) but with the back of the attachment having multiple adhesive, micro-suction or nano tape strips or pads below the top bend and another below said pads or strips;

FIG. 463(c) is a side view of the adaptor shown in FIGS. 463(a)-(b);

FIG. 464 is the opposite side view as shown in FIG. 460 which shows multiple attachments as shown in FIGS. 462(a)-(b);

FIG. 465 shows a side view of FIG. 464 but only one column of attachments as seen in FIG. 463(c) and with the top attachment in a partly peeled away condition to the surrounding material holding it and the other attachments in place;

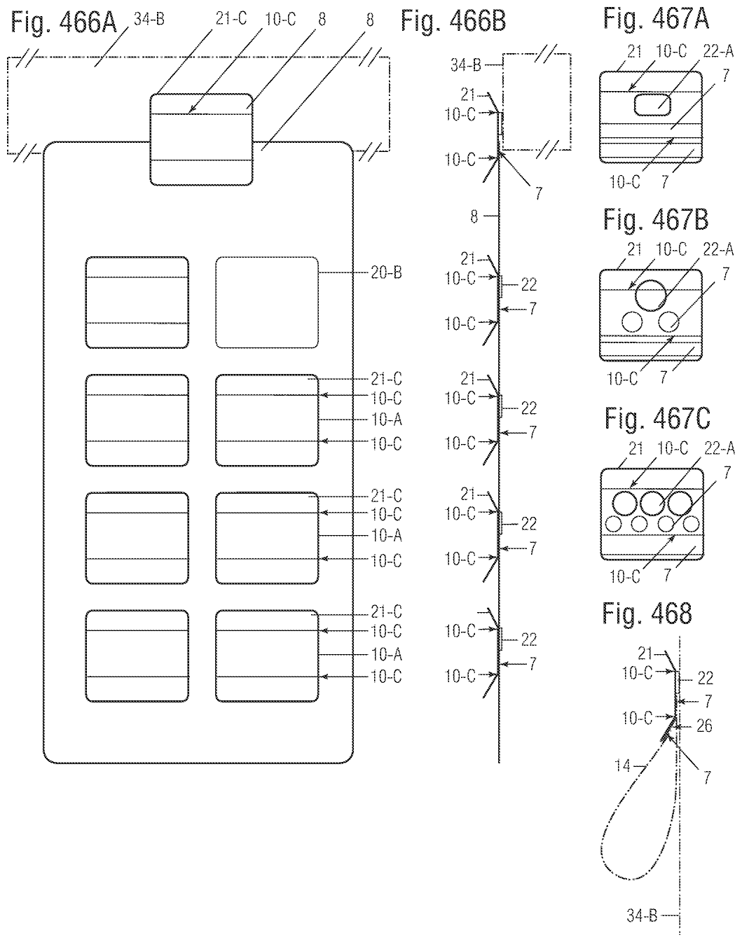

FIGS. 466(a)-(b) show front and side views as seen in FIG. 460 and FIG. 461, respectfully, but with one attachment removed from its original position on the sheet and instead in attached condition at the top of a sheet which is holding the remaining attachments and in attached condition to a smooth surface such as a countertop edge;

FIG. 467(a) shows one variation of the back view of the attachment seen at the top of FIG. 466;

FIG. 467(b) shows another variation of the back side of the attachment as seen in FIG. 466 but with one of the adhesive, micro-suction or nano tape pads overlapping the bend at the top and also shows two additional adhesive, micro-suction or nano tape pads as well as an adhesive, micro-suction, nano tape pad or strip below the bend near the bottom of said attachment;

FIG. 467(c) shows another variation of the back of the attachment seen in FIG. 466 but having multiple adhesive, micro-suction or nano tape pads or strips as well as an adhesive, micro-suction, nano tape pad or strip near the bottom edge;

FIG. 468 shows a side view of FIG. 467 and in attached condition to a flat surface such as a wall or edge of a countertop or work surface and also in attached condition to the top edge of a piece of paper as well as being in attached condition to the bottom edge of said paper by means of an adhesive, micro-suction or nano tape strip or pad on the angled part of the attachment;

FIG. 469 shows a front view of a retail package holding three attachments as shown in FIG. 462(a) or FIG. 467;

FIG. 470 shows a side view of FIG. 469;

FIG. 471 shows a front view of a retail package holding one attachment as shown in FIG. 473(a)-(b);

FIG. 473(a)-(b) show front and back views, respectively, of an attachment similar to one shown in FIG. 382 but with a NFC tag or other RF antenna, module, tag or microchip positioned above the top bend in said attachment;

FIG. 474 shows a front view of a retail package having an opening for a receiving a retail display hook or peg and holding three attachments as shown in FIG. 473(a) as well as an adaptor and a note card sized to fit the surface of a touch screen device;

FIG. 475(a) shows a front view of an adaptor in attached condition to a writing utensil and having an adaptor as shown in FIG. 473(a)-(b) and in a rotated condition as seen in FIG. 475(b);

FIG. 475(b) shows a user's hand holding the adaptor in attached condition to a writing utensil and attachment as shown in FIG. 475(a) and a side view of a touch screen device resting on a flat work surface and the NFC tag of said attachment positioned under said touch screen device in a area of said device that can detect said tag or other type of RF antenna, module, tag or microchip;

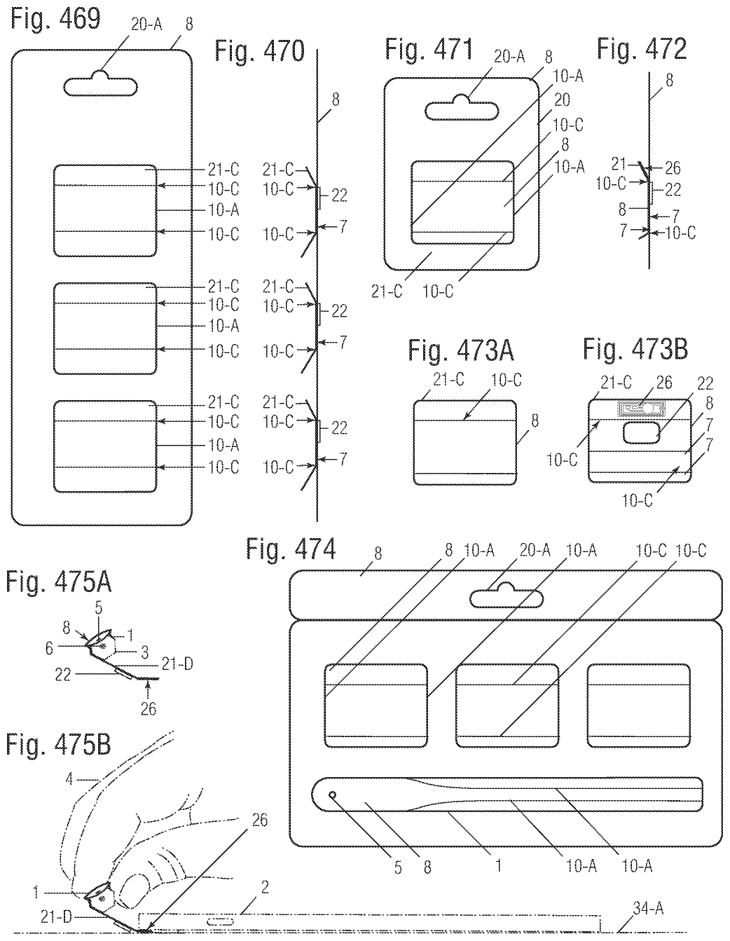

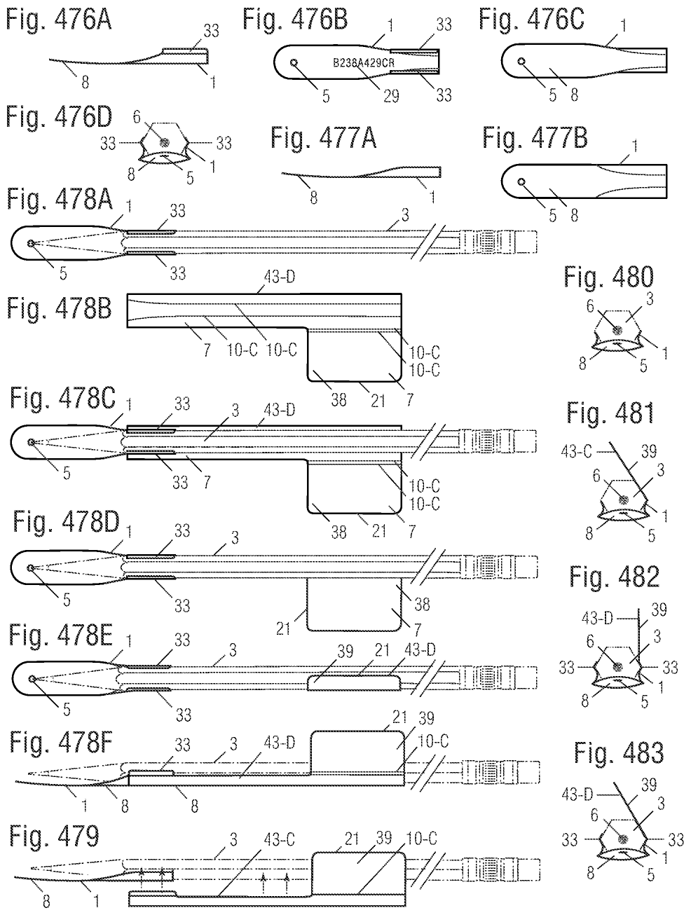

FIG. 476(a)-(d) shows side, top, bottom and front views, respectively, of one embodiment of a pre-formed adaptor having a clip-on attachment for attachment to a writing utensil;

FIG. 477(a) shows a side view of an alternative embodiment of a pre-formed adaptor;

FIG. 477(b) shows a bottom view of an alternative embodiment of an adaptor before it has been formed when attached to a writing utensil;

FIG. 478(a) shows the adaptor as seen in FIGS. 476(a)-(d) in attached condition to a writing utensil;

FIG. 478(b) shows a top view of an adaptor having an extension tab;

FIG. 478(c) shows a top view of the adaptor in attached condition to a writing utensil as seen in FIG. 478(a) positioned on top of the adaptor as seen in FIG. 478(b);

FIG. 478(d) shows a similar view as seen in FIG. 478(c) but in semi-attached condition to a writing utensil;

FIG. 478(e) shows a similar view as seen in FIGS. 478(c)-(d) but with both adaptors in fully attached condition to the writing instrument;

FIG. 479 shows another embodiment of the adaptor seen in FIG. 478(b) having been pre-formed in its final shape for attachment over an adaptor as seen in FIGS. 477(a)-(b) and a writing utensil;

FIG. 480 is a front view of the adaptor shown in FIGS. 477(a)-(b) when in attached condition to a writing utensil;

FIG. 481 shows a similar view as shown in FIG. 480 but also having an adaptor as shown in FIG. 478(b) in attached condition to a writing utensil;

FIG. 482 shows a front view of FIGS. 478(e)-(f) but with the extension tab perpendicular to the top plane of the attached writing instrument;

FIG. 483 is a similar view to FIG. 482 but with the extension tab in a different final position and is also a front view of FIG. 479 when the adaptors are attached condition to a writing utensil;

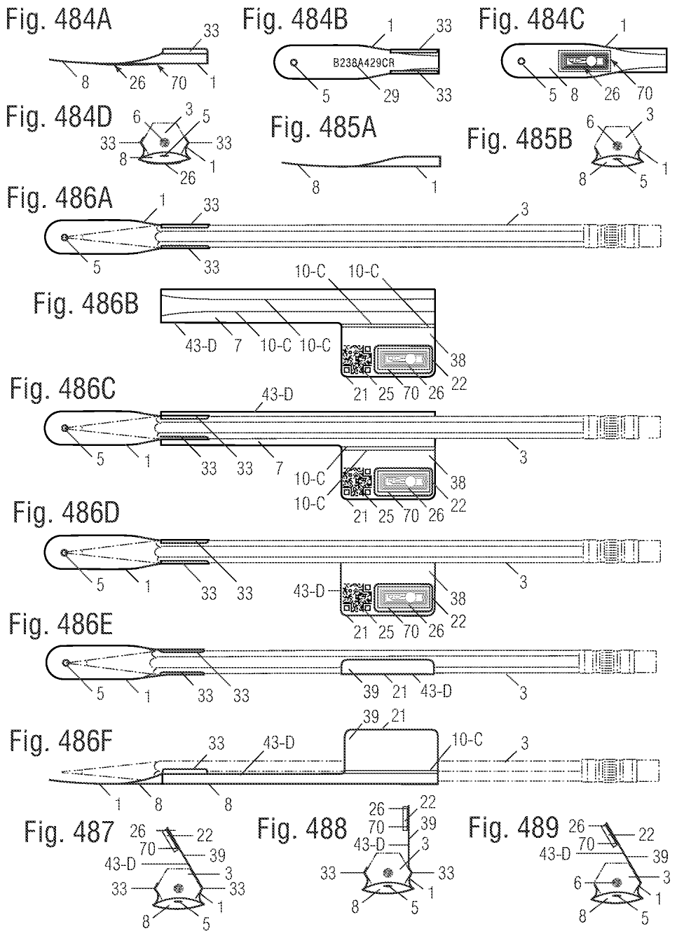

FIG. 484(a) is a similar view as FIG. 476(a) but shows an adaptor having a RF antenna, tag, module or microchip;

FIG. 484(b) is a similar view to FIG. 476(b) and is a top view to FIG. 484(a);

FIG. 484(c) is similar to the view shown in FIG. 476(c) but also has a RF antenna, tag, module or microchip;

FIG. 484(d) shows the front view of FIGS. 484(a)-(c) but in attached condition to a writing utensil;

FIG. 485(a) is the same view as shown in FIG. 477(a);

FIG. 485(b) shows the front view of FIG. 485(a) but in attached condition to a writing utensil;

FIGS. 486(a)-(f) are similar views seen in FIGS. 478(a)-(f) but show one embodiment of the extension tab of the adaptor having a scannable code, RF antenna, tag, module or microchip under an adhesive, micro-suction or nano tape pad or strip;

FIG. 487 through FIG. 489 show front views similar to those shown in FIGS. 481-483 but having an adhesive, micro-suction or nano tape pad or strip as well as a RF antenna, tag, module or microchip;

What is claimed is:

1. Writing utensil stylus adaptor comprising a radio frequency tag, module or microchip.

2. Writing utensil stylus adaptor comprising a means to attach itself and attached said writing instrument to the surface of a touchscreen device or other flat, smooth surface.

3. Writing instrument stylus adaptor as described in claim 1 and claim 2 which combines both claims.

4. A writing utensil adaptor comprising a snap or slide on mechanism that allows for a set position of an attached pencil allowing the pencil tip to wear in a consistent way when working on paper and in a manner that allows for the repositioning of the point of a pencil by turning in the adaptor to access a sharpened edge.

5. A writing utensil radio frequency enabled holder comprising a cup or holder, a radio frequency reader/receiver and writer/transmitter with built in antenna that detects and remembers when a radio frequency tagged writing utensil is placed or removed from the cup and then sends instructions to a smart touchscreen device having radio frequency read and write capabilities.

6. A writing utensil holder as described in claim 6 wherein said reader/receiver and writer/transmitter can detect and remember multiple radio frequency tagged writing utensil and instruct a smart touchscreen in defined ways based on the tagged writing instrument removed from the cup or holder.

7. A writing utensil adaptor as described in claim 6 that has material extending beyond point of the writing instrument to protect it when dropped.

8. A writing instrument adaptor that has an extension having an adhesive, micro suction or nano tape at one end to hold itself and attached writing utensil elevated above a work surface.

9. A writing instrument adaptor comprising material extending under and beyond the point of the writing instrument to steady it and reduce unwanted shakiness when writing or drawing.
